(19) United States
(12) Patent Application Publication
(10) Pub. No.: US 2006/0051812 A1
(43) Pub. Date: Mar. 9, 2006

(54) Novel carbohydrate compositions and a process of preparing same

(75) Inventors: Jari Helin, Vantaa (FI); Jari Natunen, Vantaa (FI); Reko Lehtila, Turku (FI); Mattias Roslund, Turku (FI); Reko Leino, Piispanristi (FI)

Correspondence Address: BIRCH STEWART KOLASCH & BIRCH, PO BOX 747, FALLS CHURCH, VA, 22040-0747, US

(73) Assignee: Glykos Finland OY, Helsinki (FI)

(21) Appl. No.: 10/530,126

(22) PCT Filed: Oct. 6, 2003
(86) PCT No.: PCT/FI03/00734

§ 371 Date: Sep. 9, 2005

(30) Foreign Application Priority Data
Oct. 4, 2002 (FI) 20021772

(51) Int. Cl. C40B 40/12

(52) U.S. Cl. 435/7.1; 530/322; 536/53; 536/55.3

(57) ABSTRACT

The present invention is directed to novel methods to produce carbohydrate polymers and oligomers especially for pharmaceutical and food industries. The invention is directed to methods to remodel monosaccharides, and/or oligosaccharides and/or polysaccharides by a different monosaccharide, oligosaccharide or polysaccharide and optionally by further alcohol substances, under condensing conditions, preferably in acid catalysed reactions.

The present invention is directed to novel methods to produce carbohydrate polymers and oligomers especially for pharmaceutical and food industries. The invention is directed to methods to remodel monosaccharides, and/or oligosaccharides and/or polysaccharides by a different monosaccharide, oligosaccharide or polysaccharide and optionally by further alcohol substances, under condensing conditions, preferably in acid catalysed reactions. The present invention is also directed to the effective production of non-reducing oligosaccharides especially glucose oligomer or polymer. In a specific embodiment the novel methods aim at the production of polydextrose type products, especially derivatized polydextroses, and related oligosaccharides and compositions. Furthermore, the present invention is directed to the production of novel carbohydrate compositions comprising biologically tolerable and useful salts and metal ions. The present invention is also directed to the cost effective parallel synthesis of oligosaccharides and glycoconjugates and isolation of specific functional oligosaccharides or glycoconjugates from reaction mixtures. The present invention is further directed to the reducing end derivatives of compositions obtained by the method of the invention. Preferred reducing end derivatization groups include various aglycons such as lipids, spacers, solid phases, cross-linking chemicals and/or biotin. The present invention is also directed to the use of the novel carbohydrate compositions for screening of biological activities especially in human and animal gastrointestinal tracts. The novel methods aim at the effective production of polydextrose type products and compositions.

### BACKGROUND OF THE INVENTION

Production of Carbohydrate Mixtures

It is known in the art that several monosaccharides can react to form homopolymers consisting of that monosaccharide unit. The prior art describes making polymers and sometimes shorter polymers or oligomers of monosaccharide units often called “simple sugars” as described by Pacsu and Mora, 1950 and even suggesting mixtures thereof as also in WO9841545. These simple sugars usually refer to hexose monosaccharide glucose, pentose monosaccharide xylose and disaccharide maltose or cellobiose. Under specific condensation in solution it is claimed that “a saccharide from 1 to 10 saccharide units” could be polymerised. The list of reacting saccharides include some protected monosaccharide derivatives, without showing products. Further, monosaccharide glucosamine has been claimed as a substrate in U.S. Pat. No. 2,719,179. However, the prior art does not describe the synthesis of specific novel homooligosaccharides described in the present invention. It has been noted that the synthesis of polymers from single monosaccharides gives different results depending on the reaction conditions. The present invention describes specific reaction conditions useful for synthesis of special homooligosaccharides comprising single type of monosaccharides. Special lower temperature conditions are preferred.

Part of the prior art is concentrating on the synthesis of mixtures of specific protected monosaccharide residues under conditions used by regular organic chemistry as described in WO9606102. This method describes substition of core oligosaccharide by identical substituents. The present method creates various oligomeric mixed substituted and single substrate oligomer substituted products. The present invention is mainly directed to the use of non-protected carbohydrates, such as monosaccharides, oligosaccharides and polysaccharides. The use of non-protected carbohydrates makes the process much more cost-effective and gives high variability in the carbohydrate libraries to be produced. Some methods for producing oligosaccharide libraries by enzymatic synthesis, especially by glycosyltransferases, has been suggested, WO0049412, such libraries depend on the specificities of enzymes and in general the amount of variability to be obtained is much less than shown by the present invention, and the methods of the present invention or the specific products have not been described. The carbohydrate libraries according to the present invention are especially aimed at the screening of biological activities of components of the mixtures or submixtures produced. The present invention differs clearly from the previously described oligosaccharide library approach in that all substrates can serve as acceptors (cores) and/or donors in the reaction, and the donors can react with a donor monosaccharide reacted on a core saccharide, so that products are formed in which varying substituting monosaccharides are linked to in most cases also varying monosaccharide acceptors. Several single core oligosaccharide libraries are formed simultaneously and the products have varying degree of polymerisation in linear chain from non-reducing end to reducing end. In the previous library approach of WO9606102 the size of the oligosaccharide product varied only by the number of identical branches on the core.

Some reports state that mixtures of certain “simple sugars” could be used, but no results or examples of reaction conditions, products or and especially oligosaccharide products are usually shown. WO9841545 list glucose, other “simple sugars”, hydrolysed starch and mixtures thereof, to be reacted with polyol in present of acid catalyst for production of edible polysaccharides. U.S. Pat. No. 2,436,967 contemplates the polymerisation of any sugar, possibly referring to the older works. Listed examples include alpha anhydrous dextrose, dehydrated hydrate dextrose, maltose, levulose and xylose. Pacsu and Mora, 1950 lists simple monosaccharides such as D-glucose, D-mannose, D-fructose, L-arabinose, maltose and cellobiose and even suggesting mixtures thereof. If the reactions were really performed under a certain conditions, the authors do not describe what kind of chemical structures are present in products. U.S. Pat. No. 4,965,354 describes reactions in which some mixtures of Glc, Man, Gal, Ara and xylose are heated under melting conditions, however, products were not charactrerized chemically and usefulness of mixed reactions for more complicated monosaccharides from other monosaccharide groups according to the invention were not indicated. Mora et al. (1960) describes reactions of galactose, mannose, 2-deoxy-D-glucose, L-arabinose, D-xylose, D-ribose, L-rhamnose and maltose in single component reactions showing large variability in reactivities. However, acid is mixed to the solution as liquid.

The present invention shows that different monosaccharides and oligosaccharides have varying reactivities, and only certain monosaccharides are really useful to produce most desired oligomeric and polymeric products and for production of mixed polymer products. The present invention is specifically directed to the use of monosaccharide residues preferred according to the invention and preferably considered not to be “simple” sugars. Also different reaction conditions affect the types of products formed, preferred reaction conditions are described for mixed reactions between different monosaccharides. The present invention is also directed to methods to produce mixtures or compositions comprising various mixtures of oligosaccharide and/polysaccharide reaction products according to the present invention. The present invention is specifically directed to the production of mixtures comprising oligosaccharides, which contain all combinations of the monosaccharides of the starting material. In another embodiment the invention aims at a product mixture comprising at least mixed disaccharides or dimers of the starting materials and disaccharides or dimers comprising only single type of the starting materials, more preferably all dimers comprising single or mixed starting material carbohydrates are used. In a specific embodiment at least one of the starting materials is oligosaccharide or polysaccharide and the products comprise at least mixed disaccharides of the monosaccharide residues of starting materials and disaccharides comprising only single type monosaccharide residues of the starting materials, more preferably all disaccharides comprise single or mixed starting material monosaccharides. In a specific embodiment the present invention is aimed at the production of all possible linkage types and combination between the monosaccharide residues in the oligosaccharides or glycoconjugates produced. The possible linkages types indicate that not all monosaccharides react randomly.

The invention is especially directed to the use of monosaccharide units present most preferably in human or mammalian biological system. The preferred monosaccharide residues in carbohydrates according to the present invention include common biological monosaccharide residues of animals such as Gal, GalNAc, Glc, GlcNAc, GlcA, Man, Fuc, Xyl and sialic acids. In more larger embodiment the desired monosaccharide residues comprise also other plant or microbial monosaccharides which are present in foods or in normal flora or pathogenic bacteria such as for example Rha, GalA, or arabinose. In the broadest embodiment the desired monosaccharides include all epimers of the desired monosaccharide types including
A. aldomonosaccharides, preferably pentoses or hexoses
B. deoxymonosaccharides especially 6-deoxymonosaccharides such as fucose or rhamnose.

C. N-acetylhexosamines, preferably regular N-acetylhexosamines such as GalNAc and GlcNAc
D. sialic acids, such as N-acetylneuraminic acids
E. hexuronic acids, such as galacturonic and glucuronic acids
F. oligosaccharides containing a monosaccharide or monosaccharides from any of the groups A-E
G. polysaccharides containing a monosaccharide or monosaccharides from any of the groups A-E.

The term “aldomonosaccharides” refers herein to simple aldomonosaccharides having formula (CH₂O)ₙ, wherein n=5 for pentoses and n=6 for hexoses.

Production of Oligosaccharides and Polysaccharides Under Novel Conditions

The prior art of the above cited documents describes usually acid catalysed polymerisations reaction of monosaccharides in high temperatures. The reaction products has been claimed to be mainly 1-6 linked oligo- and polysaccharides. Oligosaccharides and polysaccharides are here called collectively as saccharides or saccharide chains. In general temperatures, commonly between 140-180 degrees of Celsius allowing melting of glucose or other substrates are used in the prior art. In some documents possibility for reaction in lower temperatures is considered but reaction conditions as decribed by the present invention are not used. Temperatures even higher than 1000 degrees of Celsius have been suggested. Simultaneuosly it is noted that the high temperatures cause formation of undesired side products such as anhydro forms of glucose which may cause bitter taste or undesired colour for the product.

The prior art about polymerisations or oligomerisation of monosaccharides at room temperature describes specific synthesis of 1-6-linked GalNAc or GlcNAc oligomer in reactions catalyzed by hydrogen fluoride (specific β6-linkages, Defaye and Gadelle, 1980s) or hydrochloric acid (Poster and Horton, 1958; Blumberg et al, 1982). The present invention is especially directed to the reaction of non-homotypic HexNAc molecules which react under low temperature condition differently forming random oligomer and/or polymers. In a specific embodiment the invention is directed to low cost bulk production without using potentially harmful hydrogen fluoride. Hydrogen fluoride is difficult to handle, it can dissolve even glass and it is a highly corrosive and toxic gas. The present invention can be carried out using several non-harmful inorganic acids or even salts. A preferred inorganic acid to be used according to the present invention is hydrochloric acid.

The prior art also describes polymerisation reactions in lower, for example below 110 degrees of Celsius, temperatures using water and other solutions of certain simple carbohydrates, usually in one component reactions. The present invention is directed to the polymerisation or oligomerization of specific carbohydrates, preferably when solid or semisolid mixtures of carbohydrates are used. Furthermore the present invention describes methods useful for production of oligosaccharide mixtures such as liquid premixing of different carbohydrates and use of slower reactive components in excess.

The polymer synthesis disclosed in the references cited above aim at the production of non-digestable polysaccharides, and soluble or even non-soluble polymeric products are preferred. It is claimed that the size of the polydextrose type saccharides should be more than molecular weigth 1500 to prevent degradation in gastrointestinal tract. The present invention is directed to different types of methods and compositions. For manipulation of interactions between host and pathogen, or host and normal flora bacteria oligosaccharides are preferred. Normally, the bioactive epitopes in animal glycoconjugates are terminal or possibly terminals of branches of larger conjugates. The present invention is directed to methods to produce more slowly degradatable oligosaccharides. The present invention is also specifically directed to reaction conditions for producing such oligosaccharides. In general oligosaccharides are easier to produce at lower temperartures described by the invention. The present invention is also directed to restricting the reaction times, temperatures and/or catalysis conditions considering the properties and quantities of substrate saccharides so that preferably oligosaccharide products are formed. The present invention is specifically directed to conditions which produce disaccharides as a major oligosaccharide product. In another preferred embodiments reaction conditions are optimised so that trisaccharides are major reaction products and in yet another conditions tetrasaccharides are preferred products. The present invention is as a preferred embodiment also directed to production of monosaccharide glycosides, disaccharide glycosides, trisaccharide glycosides, and tetrasaccharide glycosides. In a more preferred embodiment alkylglycoside such as methylglycoside or ethylglycoside or polyol glycoside of a reducing monosaccharide is produced, in another embodiment the present invention is directed to the production of oligosaccharide glycosides preferably disaccharide, trisaccharide and tetrasacchride glycosides, more preferably trisaccharide and disaccharide glycosides and most preferably disaccharide glycosides.

### BRIEF DESCRIPTION OF THE DRAWINGS

FIG. 1. MALDI-TOF mass spectra of hydrogen chloride reversion products of xylose (A) and arabinose (B). Oligosaccharides with degree-of-polymerization up to 18 are detected. Representative species are labeled in the figure for clarity. All signals represent [M+Na]⁺ ions. Xyl, xylose; Ara, arabinose.

FIG. 2. MALDI-TOF mass spectra of hydrogen chloride reversion products of mannose (A), galactose (B) and galacturonic acid (C). Representative species are labeled in the figure for clarity. In panel C, each galacturonic acid oligomer is detected in multiple ionic forms, due to sodium salt formation in galacturonic acid carboxyl group. Man, mannose; Gal, galactose; GalA, galacturonic acid.

FIG. 3. MALDI-TOF mass spectra of hydrogen chloride reversion products of fucose (A), rhamnose (B) and N-acetylneuraminic acid (C). Representative species are labeled in the figure for clarity. In panel C, each N-acetylneuraminic oligomer is detected in multiple ionic forms, due to sodium salt formation in the carboxyl group. Fuc, fucose; Rha, rhamnose; Neu5Ac, N-acetylneuraminic acid.

FIG. 4. MALDI-TOF mass spectra of hydrogen chloride reversion products: (A), fructose, method A 3 days; (B), fructose, method B 45 min; (C) fructose plus sorbitol, method B 20 h. Fru, fructose; Glc-ol, sorbitol.

FIG. 5. MALDI-TOF mass spectra of acid reversion products of N-acetylglucosamine (A) and galactose (B) reacted in anhydrous methanolic hydrogen chloride. Both α- and β-methyl glycosides of N-acetylglucosamine were isolated from the GlcNAc reversion mixture as verified by NMR analyses. GlcNAc, N-acetylglucosamine; Gal, galactose; Me, methyl.

FIG. 6. MALDI-TOF mass spectra of hydrogen chloride reversion products of lactose (A), mannose (B) and sucrose (C). Representative species are labeled in the figure for clarity. The mass spectrum in (A) represents an oligosaccharide fraction of lactose reversion isolated by gel permeation chromatography. Each oligosaccharide species in (A) are present both as [M+Na]⁺ and [M+K]⁺ ions, which are separated by 16 Da. Hex, hexose; Glc, glucose.

FIG. 7. MALDI-TOF mass spectra of two-component reversion products. (A), glucose+xylitol, 8:1 molar ratio; (B) mannose+sorbitol, 1:3 molar ratio; (C) glucose+sorbitol, equimolar amounts. Representative species are labeled. Glc, glucose; Xyl-ol, xylitol; Man, mannose; Glc-ol, sorbitol.

FIG. 8. MALDI-TOF mass spectra of two component reversion products. (A) xylose and galactose; (B) galactose and N-acetylglucosamine. In (A), the reacting components were mixed as powder prior to reversion. In (B), the reaction mixture was dissolved in water, dried, and then subjected to reversion. X, xylose; G, galactose; GN, N-acetylglucosamine.

FIG. 9. MALDI-TOF mass spectra of two component reversion products. (A) starch plus xylitol; (B) starch plus fucose; (C) starch plus chitin. All reactions were performed using method C. Glc, glucose; Xyl-ol, xylitol; Fuc, fucose; GN, N-acetylglucosamine.

FIG. 10. MALDI-TOF mass spectra of reversion products. (A) N-acetylneuraminic acid and galactose; (B) N-acetylneuraminic acid, lactose and fucose. The reacting monosaccharides were dissolved in water, dried, and then subjected to reversion with method B. NA, N-acetylneuraminic acid; G, galactose; Hex, hexose; F, fucose.

FIG. 11. MALDI-TOF mass spectra of products obtained by reversion of a mixture of α-cyclodextrin and fucose. (A) A 24 h reversion with method A. (B) A 16 h reversion with method B. βCD, β-cyclodextrin; Fuc, fucose.

FIG. 12. MALDI-TOF mass spectrum showing a part of tetrasaccharides produced by hydrogen chloride reversion of an equimolar mixture of fucose, galactose and N-acetylglucosamine. Major species are labeled: F, fucose; G, galactose; GN, N-acetylglucosamine.

FIG. 13. MALDI-TOF mass spectrum showing a part of pentasaccharides produced by hydrogen chloride reversion of an equimolar mixture of xylose, fucose, galactose and N-acetylglucosamine. Representative species are labeled: X, xylose; F, fucose; G, galactose; GN, N-acetylglucosamine.

FIG. 14. Scheme 4: Self-condensation reaction of activated monosaccharide containing a silyl leaving group on position 6. The product is a linear 1-6-linked oligomer of n monosaccharide residues. R1-R5 are protecting groups stable at glycosidation conditions. Scheme 5: Self-condensed general polymer when one of the groups R1-R4 or the same corresponding groups R1′-R4′ is the leaving group. On the terminal non-reducing end monosaccharide the R′ group being the leaving group is the leaving group or is hydrolysed to form a hydroxyl group. In the middle of the chain the R or R′ group being in the position of the leaving group is part of the glycosidic linkage to neigboring monosaccharide on the non-reducing end side. n means that there is a several monosaccharides in linear and/or branched chain. Scheme 6: Polymerization of a non-protected activated monosaccharide in self-condensation reaction catalysed by a Lewis acid. n means that there are several monosaccharides in linear chain. Example showing a preferred 1-6-linkages. The left side monosaccharide is linked to another monosaccharide through 1-6-linkage and the non-reducing end terminal monosaccharide has free 6-hydroxyl. Scheme 7: A general polymer from a monosaccharide of Scheme 6. n means that there a several monosaccharides in linear and/or branched chain. In the middle of the chain at least one hydroxyl of the left side monosaccharide is in the glycosidic linkage with the anomeric carbon of the next monosaccharide.

### DETAILED DESCRIPTION OF THE INVENTION

General Reaction

Use of Non-Protected Carbohydrates

The present invention is specifically directed to the reactions of non-protected carbohydrates, the monosaccharides and other saccharides to be subjected to the reaction according to the invention are non-protected carbohydrates unless otherwise indicated. The non-protected means that no chemical protecting groups such as acetyl groups, benzyl groups, acetal groups or phtalimido groups are used to protect (or temporarily protect) a specific hydroxyl group.

The present invention describes condensing reactions between different types of non-protected carbohydrates so that not more than one of the carbohydrates is “a simple sugar”. The carbohydrates to be reacted are preferably reducing aldose carbohydrates, sialic acids, or ketose fructose. In a separate embodiment the carbohydrates can be hydrolysed to reducing monosaccharides during the condensing reaction. The carbohydrates are preferably selected from the following groups of monosaccharides, oligosaccharides and polysaccharides. The preferred reaction products comprise glycosidically linked intact monosaccharide residues. In a preferred embodiment at least two carbohydrates are selected from at least two of groups A-G.
A. aldomonosaccharides, preferably pentoses or hexoses
B. deoxymonosaccharides especially 6-deoxymonosaccharides such as fucose or rhamnose
C. N-acetylhexosamines, preferably regular N-acetylhexosamines such as GalNAc and GlcNAc
D. Sialic acids, such as N-acetylneuraminic acids or ketodeoxyoctusulonic acids (KDO)
E. Hexuronic acids, such as galacturonic and glucuronic acids
F. Oligosaccharides containing a monosaccharide or monosaccharides from any of the groups A-E
G. Polysaccharides containing a monosaccharide or monosaccharides from any of the groups A-E

Optionally, the reaction mixtures according to the present invention also comprise an alcohol substance. In a preferred embodiment the carbohydrates are reacted with polyol or one of the carbohydrates are replaced with a polyol (a reduced monosaccharide for example xylitol or sorbitol). The polyols were found to react only to the reducing end of carbohydrates.

In a preferred embodiment the group B contains only 6-deoxy monosaccharide Fucose, which is present in animals and plants in L-form and in some bacteria as D-fucose, more preferably the fucose is in L-fucose form as in many bioactive human, animal and plant molecules. The L-galactose formed 6-deoxy monosaccharide is different from the other monosaccharide types, including acid lability on oligosaccharides and can be surprisingly used according to the invention. In yet another embodiment the 6-deoxysaccharides are included in group A.

In a preferred embodiment the carbohydrates are selected from groups A-G so that at least one glycosidic bond is made between two different monosaccharide structures defined in at least two of groups A-E. In another preferred embodiment the said linkage is formed between preferred monosaccharide structures according to the invention.

In a preferred embodiment the monosaccharides A-E are included as monosaccharide units in oligosaccharides F or polysaccharide G and are reacted according to the invention to form differently linked oligomers or polymers according to the invention.

The invention is directed to a condensation reaction of at least two different carbohydrates to form carbohydrates different from the substrates, the products comprising glycosidically linked carbohydrates. Thus, the products comprise glycosidically linked carbohydrates formed from at least two different substrate carbohydrates.

Preferably, the products of the reaction comprise a mixture or library of oligosaccharides or polysaccharides including carbohydrates comprising different substrate carbohydrates that are glycosidically linked to each other and/or, when the substrate carbohydrate(s) is/are oligosaccharide(s) or polysaccharide(s), monosaccharide residues from the different substrates are glycosidically linked to each other. More preferably the products of the reaction comprise a mixture or library of oligosaccharides or polysaccharides including carbohydrates comprising monosaccharide residues from all the different substrates and said monosaccharide residues are glycosidically linked to each other.

In a preferred embodiment products of the reaction comprise a mixture or library of oligosaccharides or polysaccharides including following carbohydrates: different substrate carbohydrates, which are glycosidically linked to each other, and/or, when substrate carbohydrate(s) is/are oligosaccharide(s) or polysaccharide(s), monosaccharide residues from the different substrates are glycosidically linked to each other, and/or homotypic glycosidically linked oligomers or polymers of one or several of the substrate carbohydrates, and/or glycosidically linked oligomers or polymers of the monosaccharides from the substrate(s).

The preferred oligosaccharides and polysaccharides contain monomers in varying ratio at specific degree of polymerisation so that when the degree of polymerisation is same or larger than the number of the reacting monosaccharide units there are different oligosaccharides at a specific degree of polymerisation wherein the number of specific monosaccharide unit is larger than the number of any other specific monosaccharide unit in the molecule and at the same time at the same degree of polymerisation there are several different oligosaccharides wherein the number of the specific monosaccharide units is lower than the number of any other specific monosaccharide unit in the molecule and several different oligosaccharides wherein the number of all constituent monosaccharide units is the same.

In a preferred embodiment products of the reaction comprise a mixture or library of oligosaccharides or polysaccharides including following carbohydrates: different substrate carbohydrates that are glycosidically linked to each other and/or, when substrate carbohydrate(s) is/are oligosaccharide(s) or polysaccharide(s), monosaccharide residues from the different substrates are glycosidically linked to each other, and/or homotypic glycosidically linked oligomers or polymers of all of the substrate carbohydrates, and/or glycosidically linked homotypic oligomers or polymers of the monosaccharides from all of the substrate carbohydrates.

In a preferred embodiment the products of the reaction comprise a mixture or library of oligosaccharides or polysaccharides including carbohydrates comprising mixed monosaccharide residues from the different substrates glycosidically linked to each other and glycosidically linked homotypic oligomers or polymers of the monosaccharides from the substrate carbohydrates.

The homotypic oligomer is a oligomer or polymer of single type of carbohydrate, preferably a monosaccharide or an oligosaccharide.

In a separate embodiment at least one of the reacted carbohydrates is a conjugate or derivative of a monosaccharide or saccharide, preferably a reducing end derivative or conjugate. Preferred conjugates of monosaccharides or saccharides include reducing end glycosidic conjugates of the carbohydrates such as methylglycosides. Preferred reducing end derivatives include glycosylhalides, such as glycosylfluorides and other activated derivatives such as thiooxazolidine.

For example, reaction of two carbohydrates (Carb) Carb1+Carb2→Mixture of carbohydrates comprising glycosidically inked monosaccharides Carb1 and Carb2.

The mixture comprises, for example, mixed type disaccharides or dimers Carb1-Carb2, Carb2-Carb1, and homotypic disaccharides or dimers Carb2-Carb2, and Carb1-Carb1 and isomeric forms and other larger analogous oligosaccharides. The line indicates glycosidic linkage between the molecules.

Carb1 and Carb2 are different carbohydrates selected from the group consisting of monosaccharides, oligosaccharides or polysaccharides from groups A-G above. Optionally the reaction mixture also comprises an alcohol substance.

Preferably, the products of the reaction comprise a mixture or library of oligosaccharides or polysaccharides including carbohydrates wherein Carb1 and Carb2 are glycosidically linked to each other and/or when Carb1 and/or Carb2 is/are oligosaccharide(s) or polysaccharide(s), monosaccharide residues from Carb1 and/or Carb2 are glycosidically linked to each other.

Preferably, the product oligosaccharides or polysaccharides comprise structures, wherein carbohydrates Carb1 and Carb2 are glycosidically linked to each other. In another preferred embodiment the products comprise oligosaccharide structures wherein monosaccharide residues from Carb1 and/or Carb2 are glycosidically linked to each other, when Carb1 and/or Carb2 is/are oligosaccharide(s) or polysaccharide(s).

The products of the reaction may also comprise saccharides wherein at least two Carb1s are glycosidically linked to each other and/or, when Carb1 is oligosaccharide or polysaccharide at least two monosaccharide residues from Carb1 are glycosidically linked to each other, and/or the products of the reaction comprises saccharides wherein at least two carbohydrates Carb2 are glycosidically linked to each other and/or, when Carb2 is oligosaccharide or polysaccharide, at least two monosaccharide residues derived from Carb2 are glycosidically linked to each other.

Preferably, the products of the reaction comprise a mixture or library of oligosaccharides or polysaccharides including carbohydrates wherein Carb1 and Carb2 are glycosidically linked to each other and/or, when Carb1 and/or Carb2 is/are oligosaccharide(s) or polysaccharide(s), monosaccharide residues from Carb1 and/or Carb2 are glycosidically linked to each other, and the products of the reaction comprise saccharides wherein at least three carbohydrates Carb1 are glycosidically linked to each other and/or when Carb1 is oligosaccharide or polysaccharide at least two monosaccharide residues from Carb1 are glycosidically linked to each other and/or the products of the reaction comprise saccharides wherein at least three carbohydrates Carb2 are glycosidically linked to each other and/or, when Carb2 is oligosaccharide or polysaccharide, at least two monosaccharide residues from Carb2 are glycosidically linked to each other.

In a preferred embodiment the products of the reaction comprise a mixture or library of oligosaccharides or polysaccharides including carbohydrates wherein Carb1 and Carb2 are glycosidically linked to each other and/or, when Carb1 and/or Carb2 is/are oligosaccharide(s) or polysaccharide(s), monosaccharide residues from Carb1 and/or Carb2 are glycosidically linked to each other. The products of the reaction may further comprise saccharides wherein at least two carbohydrates Carb1 are glycosidically linked to each other and/or, when Carb1 is an oligosaccharide or polysaccharide, at least two monosaccharide residues from Carb1 are glycosidically linked to each other, and the products of the reaction may further comprise saccharides wherein at least two carbohydrates Carb2 are glycosidically linked to each other and/or, when Carb2 is an oligosaccharide or polysaccharide, at least two monosaccharide residues from Carb2 are glycosidically linked to each other.

Similarily, the reaction mixtures may comprise Carb1 and Carb2 and Carb3 or Carb1 and Carb2 and Carb3 and Carb4 or Carb1-Carbₙ, wherein n is an integer preferably under 20, more preferably under 10 and most preferably under 6.

The invention is also directed to reactions with at least 5-10 different substrate carbohydrates present in reaction mixtures in at least amounts of 0.5% (in weight %) or at least 5-10 different substrates in least amounts of 0.5% (in mole %). The invention is further directed to reaction wherein the major substrates may be present at least with concentration 5% (mole or mass) and more preferably at least 3% (mole or mass). It is realized that also very complex natural and synthetic carbohydrate mixtures comprising isomeric variation and/or different glycoform of different degrees of polymerization can be used as starting materials, in such cases n can be more than 20, even more than 1000 or more than million. The carbohydrate material can comprise non-relevant microheterogenuity. Most preferred numbers of major carbohydrates, or carbohydrate types such as polymers with different degree of polymerisation, as starting material include reactions of two, three and four different carbohydrates or carbohydrate types in a reaction. In separate preferred embodiments three or four major carbohydrates or carbohydrate types are reacted.

Isolation of Various Reaction Products

In a preferred embodiment the product oligosaccharide mixtures are isolated or purified from the reaction mixtures. Depending on the reaction conditions the product oligosaccharides are isolated or purified from possible catalysts including acids or salts, and/or alcohol substances including potential polyols and/or from monosaccharide residues and/or degradation products depending on the reaction conditions.

Oligosaccharide fractions of preferred sizes or compositions can be purified or isolated from the reaction mixtures. The isolation or purification of a oligosaccharide fraction preferably involves separation of the oligosaccharides from monosaccharides and/or from molecules with size of monosaccharide and isolating the oligosaccharides from saccharides having larger molecular weight than any desired range of oligosaccharides. The purification of the desired range of oligosaccharides may also include separation of the oligosaccharides from smaller oligosaccharides and/or monosaccharides. In a preferred embodiment the present invention is directed to the separation of an oligosaccharide fraction of monosaccharides and disaccharides.

The present invention is directed to the isolation of specific carbohydrate fractions from reaction products by affinity chromatography using different carbohydrate binding molecules such as organic carbohydrate binding molecules including organic resins, preferably comprising aromatic structures, and/or using carbohydrate binding biomolecules such as molecules selected from the group consisting of other carbohydrates, carbohydrate binding lipids, and carbohydrate binding proteins or peptides including lectins, enzymes and antibodies. The affinity chromatography can be done by any method known in the art, preferably in column in which the carbohydrate binding molecule is immobilized. Preferred methods for isolating oligosaccharides or oligosaccharide fractions also includes specific absorbtion of reducing carbohydrates or carbohydrates of specific size or composition from the reaction mixtures. The methods include the use of matrixes specifically absorbing reducing carbohydrates. Reducing carbohydrates are known to be absorbed effectively for example carbon comprising matrixes used in the HPAEC-chromatography (high pH anion exchange chromatography). As a specific embodiment the present invention is directed to absorbtion of reducing carbohydrates from reaction mixtures by reacting the reducing end of the carbohydrate by an aldehyde reactive molecule. The aldehyde reactive molecule preferred by the invention include for example thiazolidine forming molecules, aminooxy-molecules, amine-molecules, and hydrazine molecules.

Specific Absorbtion of Reducing Carbohydrates by Chemical Modification

The invention is as a separate embodiment directed to isolation and/or purification of carbohydrates by chemical modification when aldehyde reactive molecule is reacted with the reducing end of the reducing carbohydrates. The aldehyde reactive group may comprise a tag which can be specifically absorbed to an affinity column. Numerous chemical tags which can be absorbed to specific matrices have been described, for example oligomeric histidine comprising-tags can be absorbed on specific metal chelate columns, biotin tags can be absorbed on avidin or strepavidin columns, and even simpler chemical tags can be used when the composition of the mixtures do not prevent the method, for example charged tags can be absorbed to ion exhange matrixes when there is not ionic molecules interfering the purification process. Alternatively, the aldehyde reactive group is incorporated on an affinity matrix and the reducing carbohydrate is absorbed to the matrix. The present invention is directed to isolation of both reducing aldose and ketose comprising carbohydrates. More preferably reducing aldose residue comprising carbohydrates are isolated or purified.

As a separate embodiment the present invention is directed to purification of non-carbohydrate aldehydes or ketone, preferably aldehydes from different compositions. The present invention is also directed to the purification of the other non-carbohydrate aldehydes, e.g., from food processes as formaldehyde or acetaldehyde or glyceraldehyde may spoil quality of food, or from pharmaceutical or consumer product material. Moreover the method may be applied to the purification or neutralization of potentially toxic and evaporating aldehydes such as formaldehyde from materials such as glues and and paints by adding the aldehydereactive molecules. The present invention is specifically directed to isolation of any reducing carbohydrate or carbohydrate mixture from complex mixtures, when the mixtures do not comprise other major molecules reactive with the aldehyde reactive molecules so that these could interfere the purification or isolation process.

The methods are directed to removal of the reducing carbohydrates or in separate embodiment other aldehydes or ketones from reaction mixtures and isolating non-reducing carbohydrates or other components. In another embodiment the reducing carbohydrate molecule is released from the aldehyde reactive molecule and isolated. Methods to isolate the reducing carbohydrate involves reacting the aldehyde reactive molecule with the carbohydrate, purification of the complex by the use of affinity matrix and release of the aldehyde reactive molecule from reducing end of the carbohydrates. The release of the carbohydrate from aldehyde binding molecule may involve release by mild treatment of acid or base. In a preferred embodiment the carbohydrate is released from a preferred aldehyde binding molecule by treatment with mild acid. Mild acid release treatment from amino-oxy substance may involve treatment of carbohydrate conjugate in an acetic acid buffer overnight at pH about 3-4. As an example of a purification method neutral carbohydrate mixture comprising both reducing and non-reducing carbohydates is treated with amino-oxy acetic in aqueous solution as described in examples. The reducing carbohydrate is modified by the aminooxy acetic acid and isolated by anion exhange chromatography. The reducing carbohydrate can be released from the aminooxy acetic acid by mild acid treatment.

Method of Tagged Substrates for Purification of Specific Oligosaccharide Products

As a separate embodiment the present invention is directed to a method to purify specific reaction products from chemical synthesis, preferably synthesis of oligosaccharides when both or each of the reaction substrates are labelled with specific tag molecule. In a specific embodiment the reducing end of monosaccharide substrate A is stably labelled with tag 1 and donor monosaccharide B is stably labelled with tag 2. Mixed type oligosaccharides are isolated by two different affinity matrixes specifically recognizing tag 1 and tag 2. Tags 1 and 2 may be separable also by number of the tags in the molecule, for example when charge tags are used, ion exhange chromatography with a gradient or stepwise elution can be used. Similarily many affinity chromatography methods are known to separate molecules with one or two binding epitopes. When acid and/or heating based methods according to the present invention are used the linking of the tags is planned to be stable under the reaction conditions. The stable linkages include ethers and amides. When the monosaccharide residues are aimed to be released from the tags, these should be linked by acid stable but releasable structures or spacers, for example by benzyl structures releasable by reduction. For example galactose which is linked from reducing end by amide to biotin is reacted with a glucosamine modified by a carboxylic acid containing tag linked to amine group. GlcNcarboxyl-galactosyl-N-biotin is purified by streptavidin affinity chromatography and anion exchange, in a preferred embodiment the both affinity matrixes are in the same chromatography column. Preferably, the method comprises the steps of:
a) tagging at least one carbohydrate substrate with a tag molecule;
b) reacting at least one tagged carbohydrate substrate with at least one non-tagged or differentially tagged carbohydrate substrate;
c) contacting tagged reaction products with immobilised matrix having affinity for the tag molecule(s).

More preferably, the carbohydrate substrate to be tagged is tagged to the reducing end or to an amine group. The carbohydrate substrate can be tagged with a tag molecule having an aminooxy group linked to the tag structure. In a specific embodiment, all carbohydrate substrates can be tagged.

Production of Mixed Polymers or Oligomers of Monosaccharides

The present invention is specifically directed to production of mixed oligomers from free non-protected monosaccharides by condensation reactions. Different types of monosaccharides are used according to the invention in general reaction as described by the invention. The preferred condensation catalysts are described elsewhere in the specification. In a preferred embodiment monosaccharides are condensed by acid or metal catalysis. The present invention is especially directed to reactions catalysed by small amount of inorganic acid such as HCl, H₂SO₄ or phosphoric acid, preferably the reactions are performed under conditions preferred in the present invention.

The method of the invention comprises producing a saccharide or glycoconjugate from a free non-protected reducing monosaccharide involving condensation polymerisation or oligomerization of a monosaccharide selected from the group consisting of:
A. aldomonosaccharides, preferably pentoses or hexoses
B. deoxymonosaccharides especially 6-deoxymonosaccharides such as fucose or rhamnose
C. N-acetylhexosamines, preferably regular N-acetylhexosamines such as GalNAc and GlcNAc
D. sialic acids, such as N-acetylneuraminic acids or ketodeoxyoctusulonic acids (KDO)
E. hexuronic acids, such as galacturonic and glucuronic acids
   with the provision that mixtures of at least two different monosaccharides from different groups are used.

In a preferred embodiment the present invention is directed to the use of at least three different monosaccharides from at least two of groups A-E, and more preferably from at least three groups of groups A-E. In a preferred embodiment four different monosaccharides from groups A-E are used from at least two of said groups, more preferably from three of said groups and most preferably from four different groups of groups A-E.

The reaction mixture optionally contains an alcohol substance.

A preferred group of monosaccharide products from groups A-C and E are presented by a monosaccharide composition, the formula from a binary reaction is represented by formula
[(d)ₘ₁Hex1(A)ₒ₁(NAc)ₚ₁]ₙ₁[(d)ₘ₂Hex2(A)ₒ₂(NAc)ₚ₂]ₙ₂
wherein Hex1 and Hex2 indicates hexoses, d indicates a deoxymonosaccharide unit/residue, preferably 6-deoxymonosaccharide unit/residue, A indicate an uronic acid unit/residue, and NAc indicates presence of N-acetyl (acetamido/acetylamino)-group on a monosaccharide unit/residue, preferably on position 2 wherein m1, o1, p1 are 0 or 1, and m2, o2, p2 are 0 or 1 and n1 and n2 are integers with values 0 or larger, so that at least one varible m1, o1, p1 is different from corresponding variable m2, o2, p2, and n1 and n2 have several values, in a preferred embodiment all, corresponding to a random mixture of oligosaccharides according to the invention. In a specific embodiments the observable values of n1 and n2 are from at least 0 and 2, from 0 to 4, and from about 2 to 6 or preferred values corresponding to preferred oligosacchasaccharide sizes/lengths.

The highest value of n1 and n2 depends on the level of reaction.

Preferably, variables m1, o1, p1 are either 0 or one of these is 1 and m2, o2, p2 are either 0 or one of these is 1. Analogously formulas with additional monosaccharide units [(d)ₘ₃Hex3(A)ₒ₃ (NAc)ₚ₃]ₙ₃ up to monosaccharide unit number Y, wherein Y can be preferably 4 or integers to 6 or in another embodiment integers to 10 corresponding to 10 [(d)_{mY}HexY(A)_{oY}(NAc)_{pY}]_{nY} when at least two of the monosaccharides have different variable mY, oY or pY.

Scheme 1 shows an example of part of the disaccharide and trisaccharide products formed from three different monosaccharides.

Scheme 1:

M1+M2+M3→M1−M1, M2−M2, M3−M3, M2−M3, M3−M2, M1−M3, M3−M1, M1−M2, M2−M1, M1−M1−M1, M2−M1−M1, M1−M1−M2, M1−M1−M3, M1−M2−M1, M1−M2−M2, M1−M2−M3, M1−M3−M2, M1−M3−M3, M1−M3−M1, M2−M1−M1, M2−M1−M2, M2−M1−M3, M2−M2−M1, M2−M2−M2, M2−M2−M3, M2−M3−M2, M2−M3−M3, M2−M3−M1, M3−M1−M1, M3−M1−M2, M3−M1−M3, M3−M2−M1, M3−M2−M2, M3−M2−M3, M3−M3−M2, M3−M3−M3, M3−M3−M1, and other isomeric branched and linear oligosaccharides of varying lengths. It is noted that there are several different linkage possibilities between two monosaccharide residues.

M1, M2, and M3 are monosaccharide residues which are different from each other as described above.

The present invention is directed to methods to produce novel mixed carbohydrate oligomers and polymers when at least two different non-protected monosaccharides are used, in a preferred embodiment at least three different monosaccharides are used. The present invention is also directed to production of novel saccharides when at least four different monosaccharides are used. The present invention shows that the specified classes of monosaccharides according to the invention react with each other forming random mixtures.

Preferred natural type monosaccharides in various groups have been described. The monosaccharides are especially preferred in the natural L- or D-form since these are present in human glycoconjugates. Of the common 6-carbon monosaccharides fucose is in L-form in human conjugates and most other monosaccharides are in D-form. The present invention is also directed to the use of rare isomers of the desired monosaccharides, such as different L or D-forms and/or epimeric forms. For example, hexoses allose, altrose, gulose, idose, and talose and analogs thereof comprising 6-deoxy, 6-carboxyl or N-acetyl-structures such as monosaccharides in groups B, C, and E and both L- and D-forms thereof can also be used in the methods according to the invention. A specially preferred monosaccharide residue is L-idouronic acid which is actually present in human and animal glycosaminoglycans. The rare monosaccharides are useful for functional studies of lectin carbohydrate interactions revealing effects of simple epimeric structures and production of test molecules for lectin carbohydrate interactions of bacteria comprising rare monosaccharides. The present invention is also directed to the use of regular pentose monosaccharides such as ribose, arabinose, xylose, or lyxose, and even smaller monosaccharides such as erythrose, and threose and glyceraldehydes and analogs thereof comprising deoxy, carboxyl or N-acetyl-structures such as monosaccharides in groups B, C, and E and both L- and D-forms thereof are also used by the methods according to the invention.

In a preferred embodiment different monosaccharides are selected from groups A-D. It is realized that the results apply also to other aldose-monosaccharides comprising 2-10 monosaccharide residues. In another embodiment the carbohydrates are selected from the groups named as “more bioactive monosaccharide residues”. The more bioactive monosaccharide residues include monosaccharide residues from groups B-E and bioactive hexose and/or pentose isomers from group A. In a preferred embodiment the more bioactive monosaccharide residues are selected from group a) monosaccharides from group X and mannose, b) monosaccharides from group X and galactose, c) monosaccharides from group X and galactose and/or mannose, d) monosaccharides from group X and xylose, or e) monosaccharides from group X and xylose and/or galactose and/or mannose, wherein the group X present in different embodiments monosaccharides from groups B-E, B-D, and B and C. In another preferred embodiment the more bioactive monosaccharide residues are chosen from the groups B-E or B-D or groups B and C. B-B means monosaccharide groups B, C, D, and B, B-D means monosaccharide groups B, C, and D, according to the invention.

Remodelling Oligosaccharides and Polysaccharides

The invention is directed to methods to remodel oligosaccharides and/or polysaccharides by alcohol substances, monosaccharides, oligosaccharides or polysaccharides in acid catalysed reactions. The invention describes methods to achieve the transfer of the monosaccharide and retain the core oligosaccharide or polysaccharide mostly intact, such reactions are carried out preferably in lower temperature ranges according to the present invention. The lower temperature methods also aim to avoid formation of harmful side products of high production temperatures. In a specific embodiment the oligosaccharides or polysaccharides are modified under higher temperatures to obtain more random oligosaccharide or polysaccharide structures.

The invention is directed to condensation reaction of at least two carbohydrates according to the general reaction described by the invention when at least one of the carbohydrates is an oligosaccharide or a polysaccharide. The reactions may optionally comprise an alcohol substance. In a separate embodiment a carbohydrate or carbohydrates comprising a polysaccharide or an oligosaccharide is reacted with a polyol substance according to the invention. Different product mixtures are preferred as described in the general invention.

Reactions of Oligosaccharides

Various oligosaccharide can be reacted with monosaccharides, oligosaccharides or polysaccharides. The present invention is especially directed to the reactions of “non simple sugar” monosaccharides (categories B-F in general reactions) with oligosaccharides. In a preferred embodiment the oligosaccharide is not a starch derived oligosaccharide. A preferred class of oligosaccharide comprises at least trisaccharides.

Premixing of the oligosaccharides in solution with other carbohydrates is a preferred method for preparing carbohydrate mixtures for condensation reactions.

It is realized that to achieve different types of mixtures different relative amounts of the starting material can be used. The invention is directed to the use of an excess of more slowly reacting component, when oligosaccharide product mixtures comprising equal distribution of monosaccharides from both or each starting material is preferred. In preferred embodiments more than three fold excess in moles of monosaccharide residues, and more preferably more than five excess and when the other componets reacts very slowly more than ten fold excess of the slowly reacting component is used.

Reactions of Oligosaccharides with Monosaccharides

The present invention is directed to reactions of monosaccharides with various oligosaccharides. Preferably the monosaccharides from categories B-F in general reactions are used. The invention demonstrates by using cyclodextran as model of an oligosaccharide that the oligosaccharide structure is degraded at 160 degrees of Celsius with HCl catalyst in 15 minutes while the cyclodextran structure is at least partially conserved in similar several day reactions at 80 degrees of Celsius. To achieve modification of the cyclodextrin with fucose an excess of fucose monosaccharide is used.

The present invention is directed to production of monosaccharide modified cyclodextrins by catalysed chemical condensation reactions between cyclodextrins and monosaccharide in categories A-F. The invention is directed substances comprising cyclodextrins linked with monosaccharides of categories B-F, most preferably cyclodextrins modified by deoxymonosaccharides such as 6-deoxymonosaccharides including fucose. As separate embodiments the invention is directed to cyclodextrins with the group of “more bioactive monosaccharide residues” according to the invention.

As separate embodiments the invention is directed to cyclodextrin substance or compositions comprising one or more glycosidically linked xylose, arabinose, mannose, n-acetylhexosamine or sialic acid monosaccharides. The present invention is directed to cyclodextrin based oligosaccharides comprising at least one monosaccharide residue as described by the invention when the monosaccharide is not glucose, galactose or mannose. According to the present invention the monosaccharides are linked to cyclodextrin or cyclodextrins by glycosidic linkages. The present invention is directed to cyclodextrin based oligosaccharides comprising at least one monosaccharide residue as described by the invention when the monosaccharide is selected from the group of more bioactive monosaccharide residues. The present invention is specifically directed to the cyclodextrin based oligosaccharides described above when the oligosaccharide comprises at least two monosaccharide residues linked to the cyclodextrin backbone, and in another preferred embodiments, at least three or at least four monosaccharide residues linked to the cyclodextrin backbone.

As a preferred embodiment monosaccharide-oligosaccharide reactions include reactions between monosaccharides from groups A-E, preferably monosaccharides from groups B-F, with lactose. More preferred monosaccharides to be reacted with lactose include sialic acids, fucose, GalNAc, GlcNAc, and xylose. The present invention is especially directed to produce lactose dimers and lactose oligomers. The present invention is also specifically directed to reactions of lactose with the group of “more bioactive monosaccharide residues” according to the invention.

Reaction of Monosaccharides with Oligosaccharides

Scheme 2:

M1+M2−M3−M4−M5→M1−M2−M3−M4−M5,+ M2−(M1)M3−M4−M5+M2−M3−(M1)M4−M5, M2−M3−M4−(M1)M5, M1−M2−(M1)M3−M4−M5, M1−M2−M3−(M1)M4−M5, M1−M2−M3−M4−(M1)M5 and other oligomeric structures. Is noted that there are several different linkage possibilities between two monosaccharide residues. Part of the oligosaccharide is also likely to be degraded and/or rearranged depending on the reaction conditions and the oligosaccharide structure.

M1 is a non-protected monosaccharide, M2−M3−M4−MS is a non-protected oligosaccharide. M2, M3, M4, M5 may be different monosaccharide residues or only of one type of monosaccharide.

The reactions are carried out under heating or acid or metal salt catalysis with optional heating.

The term non-protected means that the residues have not been modified by protecting groups used in carbohydrate chemistry.

Reactions of Special Oligosaccharide Derivatives or Analogs

The present invention is also directed to condensing of reducing monosaccharides with glycosidically modified mono- or oligosaccharides. The one or several glycosidic linkages between monosaccharide residue or unit in an oligosaccharide are modified by replacing the bond by more stable linkage or spacer and stable linkage. The more stable linkages includes C-glycosidic linkages and amide linkages between the monosaccharide residues. The amide linkage may be between 2-amino position of hexosamine and acid group of an hexuronix acid residue. Amide linked oligosaccharides are especially preferred. The use of more stable oligosaccharide analogs is preferred because it allows preserving the oligosaccharide backbone structure in higher temperatures. More stable oligosaccharide analogs have been described for example by Gruner, S. A. W. et al. Chem. Rev. (2002) 102, 491-514. In a specific embodiment the reducing end of the oligosaccharide or oligosaccharide analog is reduced. The present invention is especially directed to reactions of various monosaccharides and oligosaccharides with reduced oligosaccharides. Examples of the preferred reduced oligosaccharides include lactitol, maltitol, maltotriositol and other reduced maltooligosaccharides, cellobiotol and reduced cellulose oligosaccharides. Use of reduced oligosaccharides, when reducing end monosaccharide unit is different from other monosaccharide units present in a reaction, reduces the number of different reactive monosaccharide units under conditions hydrolysing oligosaccharides. For example, when lactitol is used as reduced oligosaccharide, the glucose unit is no longer reactive. The present invention is especially directed to the reactions of monosaccharides with lactitol. Preferred monosaccharides include Glc, Gal, Man, Xyl, Ara, Fuc, Rha, GlcNAc, GalNAc and sialic acid. In a preferred embodiment lactitol is reacted with Gal, Fuc, GlcNAc, GalNAc and sialic acid to form a library of human type bioactive glycoconjugate analogs, and more preferably with galactose or fucose. Moreover, the present invention is directed to reactions between reduced oligosaccharides comprising before reduction a residue or unit from groups B-E or two different monosaccharide units. The invention is also directed to self-condensation of reduced oligosaccharides, e.g. two different oligosaccharides or disaccharides. In a preferred embodiment the present invention is directed to the self-condensation reaction of lactitol structures under conditions at least partially hydrolysing glycosidic linkage in the structure. Preferred reaction conditions include lower melting temperatures.

Reactions Between Oligosaccharides.

The present invention is directed to reactions between different oligosaccharides, preferably between oligosaccharides comprising different types of monosaccharide residues as described by the invention for other carbohydrates. In a preferred embodiment the reactions are performed to produce more random type mixed and homotypic oligosaccharides comprising monosaccharides from the oligosaccharide substrates. In another embodiment reaction conditions preserving oligosaccharide structures are preferred.

As a separate embodiment the present invention is directed to reactions between lactose molecules to produce novel oligosaccharides, comprising more random galactose and glucose residues.

Other Preferred Oligosaccharide Reactions According to the Invention

It is realized that when glucose is reacted with oligosaccharides from starch the products are probably not so interesting as from a reaction with carbohydrates comprising structures present regularity on human and animal cell and tissue surfaces. The present invention is in its preferred embodiment directed to reactions of oligosaccharides which are not oligosaccharides from starch. In a preferred embodiment starch oligosaccharides are reacted with the group of “more bioactive monosaccharide residues” according to the invention.

To produce functional saccharides the oligosaccharide is preferably a heterooligosaccharide comprising at least one monosaccharide residue different from glucose. In a preferred embodiment the oligosaccharide comprises a monosaccharide residue from groups B-E. The present invention is in its specific embodiment directed to reactions to modify the disaccharide lactose under the chemical condensation conditions according to the present invention. The disaccharide lactose is preferably reacted with “the more bioactive monosaccharide residues” according to the invention.

Preferred oligosaccharides include separately glucose oligosaccharides and other oligosaccharides. The glucose oligosaccharides include preferably reducing non-starch oligosaccharides and non-cellulose oligosaccharides. Preferred glucose oligosaccharides include laminarioligosaccharides, isomaltooligosaccharides, cyclo-glucoses including cyclodextrins, β3-glucan oligosaccharides, β3/4glucan oligosaccharides and β6-glucans oligosaccharides. In a preferred embodiment the oligosaccharides to be used as substrates for synthesis according to the invention comprise at least one monosaccharide unit from groups B-E and more preferably from groups B,C and B. The preferred oligosaccharides include oligosaccharides released by degradative methods from polysaccharides preferred according to the invention, for example chitin oligosaccharides, GalNAc-oligosaccharides, fucose oligosaccharides, xylose oligosaccharides, mannose oligosaccharides, galactose oligosaccharide and sialyl oligosaccharides. Preferred oligosaccharides include lactose, N-acetyllactosamie and N-acetylactosamine oligosaccharides.

Reactions of Polysaccharides

Polysaccharide-Monosaccharide Reactions

Various polysaccharides can be reacted with monosaccharides in general reaction described by the invention. As examples monosaccharides such as xylose or fucose were reacted with starch, also mixtures of monosaccharides described by the general reaction can be reacted with polysaccharides. The reaction between monosaccharide or monosaccharides and polysaccharide can be performed under conditions where polysaccharide is hydrolysed to oligosaccharides or monosaccharides, the products are various mixed and homotypic oligosaccharides. For example starch can be hydrolysed in a HCl catalysed reaction at 160 degrees of Celsius in 15 minutes. In a specific embodiment the reaction time and temperature are adjusted so that only part of the polysaccharide is hydrolysed and oligosaccharide or polysaccharide structures comprising partially the original polysaccharide structure are formed.

Polysaccharide-Oligosaccharide Reactions

The present invention is also directed to reactions between oligosaccharides and polysaccharides. In a preferred embodiment the reactions are performed to produce more random type mixed and homotypic oligosaccharides comprising monosaccharides from the oligosaccharide and the polysaccharide substrate or substrates. In another embodiment reaction conditions preserving oligosaccharide and polysaccharide structures are preferred.

Mixed Polysaccharide-Polysaccharide Reactions.

In a preferred embodiment when one carbohydrate is a polysaccharide, it is reacted with at least one polysaccharide substance. In a preferred embodiment a glucose comprising polysaccharide is reacted with chitin polysaccharide. Preferred glucose polysaccharides include β-glucans including cellulose, α-glucose polymers such as starch, starch fractions such as amylose or amylopectin, glycogen, dextran and other α-linked glucose polymers. In a preferred embodiment the invention is directed to a reaction between starch and chitin.

Other preferred polysaccharides to be used according to the present invention include galactose comprising polysaccharides such as β-galactans from plant sources or galactose polysaccharides from algae including agarose and carrageenan and similar polysaccharides, fucose comprising polysaccharides from algae such as fucoidans/fucoidins, xylans for example from plant sources, polysialic acids such as bacterial polysialic acids including colomnic acids from E. coli, mannose polysaccharides such as β-linked mannan from plants and various hemicellulose polysaccharides from plants. In a preferred embodiment exopolysaccharides from lactic acid bacteria or other food acceptable bacteria are used. A preferred microbial polysaccharide is a GalNAc comprising polysaccharide. In a preferred embodiment polysaccharides from yeast cell surface are used, preferred polysaccharides from yeasts include mannans, glucans and chitins. Other sources of useful polysaccharides include animal and synthetic polysaccharides. From animal polysaccharides especially non-mammalian polysaccharide sources include polysaccharides from insects, especially chitin type polysaccharides and polysaccharides marine animals, for example polysaccharides from fishes, and marine invertebrates producing large amounst of polysaccharides. The polysaccharides from natural sources such as algae, bacteria, yeasts, animals and plants may be used as crude or partially purified mixtures of polysaccharides.

The Reaction Between Two Different Polysaccharides to Produce Random Oligosaccharides

When production of random type mixtures is aimed at, then relatively high temperatures are preferred. For oligosaccharide production preferred catalyst for condensation is acid, more preferably hydrochloric acid. In a preferred embodiment the temperature is about at least 140 degrees of Celsius, more preferably at least 160 degrees of Celsius. The reactions may be relatively rapid for example reaction with chitin and starch produces oligosaccharides in 15 minutes and in even shorter reaction times when minor amounts of hydrochloric acid is used as catalyst.

Premixing of the polysaccharides in solution is a preferred method for preparing polysaccharides for condensation reactions, when one of the polysaccharides is not or is weakly water soluble, acid solutions may be used.

It is realized that to achieve different types of mixtures different relative amounts of the starting material can be used. The invention is directed to the use of an excess of more slowly reacting or hydrolysing polysaccharide, when oligosaccharide mixtures comprising equal distribution of monosaccharides from both or each starting material is preferred. In preferred embodiments more than three fold excess in moles of monosaccharide residues, and more preferably more than five fold excess and when the other components reacts very slowly more than ten fold excess of the slowly reacting component is used. For example when aiming to produce mixtures comprising mostly glucose comprising oligosaccharides from starch and chitin, equal amounts of both polysaccharides are used as chitin reacts slower. When one or several of the polysaccharides are hydrolysing to oligosaccharides lower reaction temperatures can be adjusted to produce oligosaccharide mixtures.

Production of Remodelled Oligo- and Polysaccharides Under Conditions in which the Core Saccharide Remains Mostly Intact

The present invention is in a specific embodiment directed to acid catalysed reactions in which an oligosaccharide or a polysaccharide is reacted with an alcohol substance, monosaccharide, oligosaccharide or polysaccharide in acid catalysed reactions and the linkage structure between monosaccharide residues in the oligosaccharide or polysaccharide remains intact. The reactions are preferably carried out under preferred temperatures according to the invention and the reaction times are adjusted so that the core oligosaccharide structure remains mostly intact. It is realized that using shorter reaction times almost similar products could be obtained even in higher temperatures, though the core structures are more modified.

Production of Remodelled Oligo- and Polysaccharides Under Conditions Yielding More Randomly Linked Oligo- and Polysaccharide

The present invention is in its specific embodiment directed to acid catalysed reactions in which an oligosaccharide or a polysaccharide is reacted with an alcohol substance, and/or with monosaccharide, oligosaccharide or polysaccharide to produce randomly linked oligosaccharide and polysaccharide compositions. The reactions are preferably carried out under temperatures above 80 degrees of Celsius more preferably above 140 degrees of Celsius.

Oligosaccharides and Polysaccharides Comprising More than One Type of Monosaccharide Residues

The preferred oligosaccharide and polysaccharide compositions can be produced by using monosaccharides, oligosaccharides or polysaccharides as starting materials. For example, for making N-acetylactosamine analogs monosaccharides Gal and GlcNAc or a galactan polysaccharide and chitin could be used.

The present invention is also directed to preferred oligosaccharide compositions produced by the condensation reaction processes described by the invention. In a preferred embodiment the present invention is directed to acid catalysed, preferably hydrochloric acid catalysed and phosphoric acid catalysed, condensations of the starting materials.

The present invention is also directed to condensation reaction methods, when the methods also include isolation of oligosaccharide fraction or fractions comprising preferred oligosaccharide mixtures according to the present invention.

Preferred General Disaccharide Compositions and Oligosaccharides Comprising Binary Combinations of Monosaccharide Residues

The present invention is specifically directed to isolation of disaccharide fraction and an isolated disaccharide fraction comprising disaccharides M1₁M2₁, wherein M1 and M2 are monosaccharide units from two of groups A-E or from other preferred monosaccharide groups as defined above with the provision that M1 is glycosidically linked to M2 or M2 is glycosidicaly linked to M1 and the disaccharide fraction comprises at least four different disaccharides, more preferably at least six different disaccharides and most preferably at least 10 different disaccharides.

In another preferred embodiment the defined disaccharide fraction also comprises disaccharides with at least one alpha and one beta-glycosidic linkage, more preferably at least two alpha and beta glycosidic linkages. In a preferred embodiment the fraction comprises all possible disaccharides so that every possible disaccharide forming hydroxyl-linkage position between monosaccharide units M1 and M2 is used.

In a specific embodiment the disaccharide fraction defined by the invention consist of M1₁M2₁, wherein either M1 is glycosidically linked to M2 or M2 is glycosidicaly linked to M1 and does not contain other monosaccharide residues in essential amounts.

In another preferred embodiment the present invention is directed to oligosaccharide mixture or fraction comprising oligosaccharides according to the Formula 1:
M1ₘM2ₙ
wherein monosaccharide units M1 and M2, selected from at least two of groups A-E, are glycosidically linked in any order and m and n are varying integers for different oligosaccharide components from 0 to 6, preferably 1 to 6, independently, with the provision that the mixture comprises at every degree of oligomerization (which can be presented by m+n) at least a number of isomers according to the formula (2*a)^{(m+n)}−1, wherein a is an integer from 1-8, preferably 2-8, and more preferably a is at least 0, or at least 2 and most preferably at least 3. (2*a) means 2 multiplied by a. The integer a depends on the number of the free hydroxyl groups and types and positions of glycosidic bond formed by different monosaccharide residues. In a preferred embodiment the fraction comprises all possible disaccharides so that every possible disaccharide forming hydroxyl-linkage position between monosaccharide units M1 and M2 in different isomeric oligosaccharides are used. In another embodiment the isomers are present in the mixture so that each oligosaccharide has at least two possible isomerically linked forms in every linkage between monosaccharide residues. In most preferred embodiment the oligosaccharide fraction comprises oligosaccharide with every possible monosaccharide composition of the monosaccharide units M1, and M2.

As a specific embodiment present invention is directed to disaccharide mixtures according to the formula so that the number of isomers is at least 16. In a preferred embodiment the present invention is directed to production of the disaccharides having linkage structure M1α/βxM2 and M2α/βxM1 wherein x is a specific linkage position preferably glycosylated by the reaction and x is not 1.

In another preferred embodiment the present invention is directed to production of the disaccharides having linkage structure M1α/βxM2 and M2α/βxM1 wherein x is any free hydroxyl group position on the monosaccharide residue. In a preferred embodiment the oligosaccharide mixture according to the Formula 1 comprises oligosaccharides wherein m plus n is at least 4 and a is at least 1, preferably at least 2.

In a preferred embodiment m and n are varying integers for different oligosaccharide component from 0 to 3, preferably 1 to 3. In a specific embodiment the invention is directed to a trisaccharide mixtures according to Formula 1 so that m plus n is 3, and integers m and n are between 0 and 3 and all four composition types, preferably all isomer types, of trisaccharides with different values of m and n are present. In a specific embodiment the invention is directed to disaccharide and trisaccharide mixtures according to Formula 1 so that m plus n is 2 or m plus n is 3, and integers m and n are between 0 and 3 and all the composition types, preferably all isomer types, of saccharides with different values of m and n are present. In a preferred embodiment m and n are integers so that that m is 2 and n is 1 and/or m is 1 and n is 2, more preferably the mixture comprises trisaccharides so that both m is 2 and n is 1 and m is 1 and n is 2. In another specific embodiment the present invention is directed to oligosaccharide mixtures according to the Formula 1 when the mixtures comprise tetrasaccharides so that m plus n is 4 and m and n are integers from 0 to 4, preferably from 1 to 4. In a specific embodiment the invention is directed to disaccharide, trisaccharide and tetrasaccharide mixtures according to Formula 1 so that m plus n is 2 or m plus n is 3 or m plus n is 4, and integers m and n are between 0 and 4 and all the composition types, preferably all isomer types, of saccharides with different values of m and n are present.

In a specific embodiment the present invention is directed to polysaccharide fractions or compositions comprising oligosaccharides according to formula 1, when the average degree of polymerisation (m+n) of the oligosaccharide mixture is more than 6, preferably more than 9. In another preferred embodiment the average degree of polymerisation is more than 10 and less than 100.

In a specific embodiment the polysaccharide composition is a subfraction of a condensation reaction according to the present invention. The present invention is also directed to the preferred polysaccharide compositions produced according to the processes according to the present invention.

The present invention is specifically directed to isolation of oligosaccharide and polysaccharide fractions according to the present invention and formula 1.

Preferred Trisaccharides and Polysaccharides or Oligosaccharides Comprising Three Different Monosaccharide Units

The present invention is specifically directed to an isolated trisaccharide fraction comprising trisaccharide compositions M1₁M2₁M3₁, wherein M1 and M2 and M3 are monosaccharide units from at least two of groups A-E or from other preferred monosaccharide groups presented above with the provision that M1, M2 and M3 are glycosidically linked to each other in any order in linear or branched sequence and the trisaccharide fraction comprises at least 6 different trisaccharides, more preferably at least 120 different trisaccharides, more preferably the fraction comprises all possible trisaccharides so that every possible hydroxyl-linkage position forming glycosidic bonds between monosaccharide units M1, M2, and M3 are used. In another preferred embodiment the oligosaccharide in the trisaccharide fraction comprise the trisaccharides with both alpha and beta linkages, more preferably the mixture comprises alpha and beta glycosidic linkages of each monosaccharide residue M1, M2, and M3.

In a specific embodiment the trisaccharide fraction defined by the invention consist of M1₁M2₁M³₁, wherein M1 and M2 and M3 are monosaccharide units from two of groups A-E or from other preferred monosaccharide groups presented above with the provision that M1, M2 and M3 are glycosidically linked to each other in any order in linear or branched sequence and the trisaccharide fraction comprises at least 6 different trisaccharides, more preferably at least 120 different trisaccharides and does not contain other monosaccharide residues in essential amounts.

In another preferred embodiment the present invention is directed to production of the trisaccharides having linkage structure M1α/βM2α/βM3α/βM2, M2α/βM1α/βM3, M2α/βM3α/βM1, M3α/βM2α/βM1, M3α/βM1α/βM2, and branched trisaccharides M2α/β(M3α/β)M1, M3α/β(M2α/β)M1, M3α/β(M1α/β)M2, M1α/β(M3α/β)M2, M2α/β(M1α/β)M3, and M1α/β(M2α/β)M3 wherein every monosaccharide unit can be independently alpha or beta linked. In another embodiment the trisaccharide fraction comprises trisaccharides M1α/βxM2α/βxM3 M1α/βxM3α/βxM2 and M2α/βxM1α/βM3 and M2α/βM3α/βxM1 and M3α/βxM2α/βxM1 and M3α/βxM1α/βxM2 and corresponding branched isomers, wherein every monosaccharide unit can be independently alpha or beta linked, wherein x is any free hydroxyl group position available for glycosidic linkage on the monosaccharide unit.

In another embodiment the present invention is directed to oligosaccharide mixtures comprising oligosaccharides according to Formula 2:
M1ₘM2ₙM3ₒ
wherein M1 and M2 and M3 are monosaccharide units from at least two of groups A-E or from other preferred monosaccharide groups presented above with the provision that M1, M2 and M3 are glycosidically linked to each other in any order in linear or branched sequence and m and n and o are varying integers for different oligosaccharide components from 0 to 6, preferably 1 to 6, independently, with the provision that the mixture comprises at every degree of oligomerization (which can be presented by m+n+o) at least a number of isomers according to the formula (3*a)^{(m+n)}, wherein a is an integer from 1-8, preferably 2-6, and in more preferred embodiments a is at least 1, or at least 2 and most preferably at least 3. The integer a depends on the number of the free hydroxyl groups and types and positions of glycosidic bond formed by different monosaccharide residues. In a preferred embodiment the fraction comprises all possible oligosaccharides so that every possible hydroxyl-linkage position between monosaccharide units M1, M2, and M3 in different isomeric oligosaccharides are used.

In most preferred embodiment the oligosaccharide fraction comprises oligosaccharides of every possible monosaccharide composition of the monosaccharide units M1, M2, and M3.

In a preferred embodiment the oligosaccharide mixture according to the Formula 2 comprises oligosaccharides wherein m plus n plus n is at least 4 and a is at least 1 and more preferably at least 2.

In a preferred embodiment m and n an o are varying integers for different oligosaccharide component from 0 to 3. In a specific embodiment the invention is directed to a trisaccharide mixtures according to Formula 2 so that
m plus n plus o is 3, and integers m and n and o are between 0 and 3 and
all preferred types of trisaccharides with different values of m and n and o are present, in another more preferred embodiment all possible monosaccharide compositions of oligosaccarides by different values of m, n and o are present

In a specific embodiment the invention is directed to disaccharide and trisaccharide mixtures according to Formula 1 so that (m+n+o) is either two or three, and integers m, n and o are between 0 and 3 and all the preferred types of saccharides with different values of m, n, and o are present, in another more preferred embodiment all possible monosaccharide compositions of oligosaccarides by different values of m, n and o are present.

In another specific embodiment the present invention is directed to oligosaccharide mixtures according to the Formula 2 when the mixtures comprise tetrasaccharides so that (m+n+o) is 4 and, m, n and o are integers from 0 to 4, and the preferred types of saccharides with different values of m, n and o are present, in another more preferred embodiment all possible monosaccharide compositions of oligosaccarides by different values of m, n and o are present.

In a specific embodiment the invention is directed to disaccharide, trisaccharide and tetrasaccharide mixtures according to Formula 2 so that (m+n+o) is either two or three or four, and integers m, n, and o are between 0 and 4 and all the preferred types of saccharides with different values of m and n are present, in another more preferred embodiment all possible monosaccharide composition of oligosaccarides by different values of m, n and o are present.

In a specific embodiment the present invention is directed to polysaccharide fractions or compositions comprising oligosaccharides according to formula 2, when the average degree of polymerisation (m+n+o) of the oligosaccharide mixture is more than 6, more preferably more than 9. In a preferred embodiment the average degree of polymerisation is more than 10 and less than 100.

In a specific embodiment the polysaccharide composition is a subfraction of a condensation reaction according to the present invention. The present invention is also directed to the preferred polysaccharide compositions produced according to the processes according to the present invention.

The present invention is specifically directed to isolation of oligosaccharide and polysaccharide fractions according to the present invention and formula 2.

Preferred Tetrasaccharides and Polysaccharides or Oligosaccharides Comprising Four Different Monosaccharide Units

The present invention is specifically directed to isolated trisaccharide fraction comprising tetrasaccharide compositions M1₁M2₁M3₁M4₁, wherein M1, M2, M3, and M4 are monosaccharide units from at least two of groups A-E or from other preferred monosaccharide groups presented above with the provision that M1, M2, M3, and M4 are glycosidically linked to each other in any order in linear or branched sequence and the tetrasaccharide fraction comprises at least 24 different tetrasaccharides, more preferably at least 1680 different tetrasaccharides, more preferably the fraction comprises all possible tetrasaccharides so that every possible hydroxyl-linkage position of monosaccharide units M1, M2, M3, and M4 are used. In another preferred embodiment the oligosaccharide in the tetrasaccharide fraction comprise the tetrasaccharides with both alpha and beta linkages, more preferably the mixture comprises alpha and beta glycosidic linkages of each monosaccharide residue M1, M2, M3, and M4.

In another preferred embodiment the present invention is directed to oligosaccharide mixtures comprising oligosaccharides according to the Formula 3:
M1ₘM2ₙM3ₒM4ₚ
wherein M1, M2, M3, and M4 are monosaccharide units from at least two of groups A-E or from other preferred monosaccharide groups according to the present invention with the provision that M1, M2, M3, and M4 are glycosidically linked to each other in any order in linear or branched sequence and m, n, o, and p are varying integers for different oligosaccharide components from 0 to 6 and in a preferred embodiment preferably 1 to 6, independently, with the provision that the mixture comprises at every degree of oligomerization (which can be presented by m+n+o+p) at least a number of isomers according to the formula (4*a)^{(m+n+o+p)}, wherein a is an integer from 1-8, preferably 2-6, and more preferred embodiments a is at least 1, or at least 2 and most preferably at least 3. The integer a depends on the number of the free hydroxyl groups and types and positions of glycosidic bond formed by different monosaccharide residues. In a preferred embodiment the fraction comprises all possible oligosaccharides so that every possible hydroxyl-linkage position between monosaccharide units M1, M2, M3 and M4 are used in different isomeric oligosaccharides. In most preferred embodiment the oligosaccharide fraction comprises oligosaccharide of every possible monosaccharide composition of the monosaccharide units M1, M2, M3 and M4.

In another specific embodiment the present invention is directed to oligosaccharide mixtures according to the Formula 3 when the mixtures comprise trisaccharides so that (m+n+o+p) is 3, and m, n, o and p are integers from 0 to 3, and all the preferred types of saccharides with different values of m, n, o and p are present, in another more preferred embodiment all possible monosaccharide composition of oligosaccarides by different values of m, n, o, and p are present.

In another specific embodiment the present invention is directed to oligosaccharide mixtures according to the Formula 3 when the mixtures comprise tetrasaccharides so that (m+n+o+p) is 4, and m, n, o and p are integers from 0 to 4, and the preferred types of saccharides with different values of m, n, o and p are present, in another more preferred embodiment all possible monosaccharide composition of oligosaccarides by different values of m, n, o, and p are present.

In a specific embodiment the invention is directed to disaccharide, trisaccharide and tetrasaccharide mixtures according to Formula 3 so that (m+n+o+p) is either two or three or four, and the integers m, n, o, and p are between 0 and 4 and the preferred types of saccharides with different values of m and n and p are present, in another more preferred embodiment all possible monosaccharide composition of oligosaccarides by different values of m, n, o and p are present.

In a specific embodiment the present invention is directed to polysaccharide fractions or compositions comprising oligosaccharides according to the Formula 3, when the average degree of polymerisation (m+n+o+p) of the oligosaccharide mixture is more than 6, more preferably more than 9. In a preferred embodiment the average degree of polymerisation is more than 10 and less than 100.

In a specific embodiment the polysaccharide composition is a subfraction of a condensation reaction according to the present invention. The present invention is also directed to the preferred polysaccharide compositions produced according to the processes according to the present invention.

The present invention is specifically directed to isolation of oligosaccharide and polysaccharide fractions according to the present invention and Formulas 1-3.

The oligosaccharides and/or polysaccharides can be linked by divalent cross-linking agents such as at least divalent carboxylic acids. The present invention is also directed to polysaccharides and oligosaccharides according to the present invention when the polysaccharides or oligosaccharides are cross-linked with at least divalent carboxylic acids preferably citric acid.

Beside these aldohexuronic acids, for example galacuronic acid of glucuronic acid, can be also transferred on polysaccharides with in general lower reactivity than the monosaccharides, disaccharides or oligosaccharides listed above. Prior art has described use of various carboxylic acids in production of polydextrose substances. The present invention is specifically directed to optional use of hexuronic acids and as a separate embodiment other sugar preferably sugar derived dicarboxylic acids, especially hexoses derived dicarboxylic acids, for example glucaric acid and galactaric acid, in processes for producing larger polydextroses. The problem with the carboxylic acid described by the prior was the bitter taste of the esters formed, the sugar like carboxylic acids are aimed for lowering this effect.

Mass Spectra of Novel Carbohydrate Mixtures

The present invention is directed to novel oligosaccharide fractions or mixtures comprising monosaccharide residues according to the Formulas 1-3. The oligosaccharide mixtures can be analysed by mass spectrometry. The oligosaccharide mixtures or fractions described by the invention have specific mass spectrometric profiles which clearly indicates presence of composition according to the invention. The present invention is specifically directed to oligosaccharide compositions having the mass spectrum of the composition according to the invention. The mass spectra of the compositions comprise peaks exactly corresponding to monosaccharide composition according to the invention. The mass profiles of the compositions observable by mass spectrometry are fingerprint like presentations of the exact compositions of the carbohydrate mixtures according to the invention.

The position of each peak in a mass spectrum can be calculated by calculating sum of molecular masses of the specific monosaccharide residues of each oligosaccharide component and adding mass of a water molecule to get a mass of a reducing oligosaccharide or polysaccharide. The molecular masses are usually observed in so called positive ion mode as sodium adducts, so that mass of Na⁺ is added to the molecular weight of a specific component and the molecular mass of the specific component observable by mass spectrometre is obtained. Similarily molecular masses for components of a oligosaccharide derivatives such as reduced oligosaccharides or oligosaccharide alcohol conjugates can be obtained.

The present invention is specifically directed to oligosaccharide compositions that comprise monosaccharide units described by the invention and have mass spectrum of the specific oligosaccharide composition according to the present invention. The monosaccharide composition can be determined by hydrolysing the glycosididic linkages of the oligosaccharides and determining which monosaccharides are present by the methods known in the art. The methods for determining the monosaccharide compositions usually involve chromatographic separation and identification of the monosaccharide residues, more preferably the monosaccharide units are recognized by mass spectrometry and NMR-spectroscopy. The mass spectrum of an oligosaccharide composition is determined by mass spectrometer.

Mass Spectra of Specific Compositions of Two Monosaccharides

The individual molecular masses for major components of composition according to Formula 1
M1ₘM2ₙ
wherein monosaccharide units M1 and M2 are glycosidically linked and m and n are varying integers for different oligosaccharide components from 0 to 6, is obtained by calculating oligosaccharide molecular masses with each value of m and n
m*(M_{w}(M1))+n*(M_{w}(M2))+M_{w}(H₂O)
wherein M_{w}(M1) is molecular weight of monosaccharide residue M1 and wherein M_{w}(M2) is molecular weight of monosaccharide residue M2 and M_{w}(H₂O) is molecular weight of water when the oligosaccharides are in reducing form.

Major peaks of each component are obtained for sodium adducts in positive ion mode mass spectrometry by adding ionic mass of sodium ion A(Na⁺), the total formula for carculating peak positions for positive ion mode is then m*(M_{w}(M1))+n*(M_{w}(M2))+M_{w}(H₂O)+A(Na⁺,

Purity of a sample and reaction conditions determine which part of the composition are observable. The present invention is specifically directed to production of oligosaccharide compositions when values of m and n are 4 or less 3 or less or 2 or less.

Examples of mass spectra of binary, trinary and ternary oligosaccharide compositions according to present invention are shown in the Examples below. The mass spectra can be, for example, obtained by MALDI-TOF methods described in the Examples. The mass spectra used in the Examples were produced in positive ion mode, for negatively charged products mass spectra may also be produced in negative ion mode, a method well known in the art. In the negative ion mode the MALDI-mass spectra shows molecular ions of singly deprotonated substances. The mass spectra can also be produced in presence of different ions producing different adduct ions and shifting the mass fingerprint profile accordingly. Exact peak positions also depend on accuracy of calibration. Depending on the resolution the peaks in the mass spectrum may correspond to average molecular weights or monoisotopic masses. These can be easily determined by a person skilled in the art. Moreover, it is possible to change molecular masses of carbohydrates produced according to the invention by using isotopically enriched carbohydrates as starting materials. The present invention is directed to the compositions comprising monosaccharides and essentially the same mass spectrum of oligosaccharides or polysaccharides, or glycoconjugates as can determined by calculating the expected masses of the component carbohydrates of the expected products. The quantitative relations of the peaks depend on the amounts of substrates and other reaction conditions and the present invention is especially directed to the compositions giving mass spectrum which has essentially, or within the experimental error, the same peak positions as expected for the reaction products according to the invention.

The present invention is also directed to the use of the mass finger prints to mark different products. The carbohydrate compositions, preferably complex mixtures comprising at least three different monosaccharide units and more preferably at least four different monosaccharide unit described by the invention, may be added or attached to various products and the authenticity of the products can be determined by mass spectrometry. The compositions should be acceptable and are especially aimed at additives for valuable foods or especially drinks. In another embodiment the complex mixtures produced by the invention are mixed to material of a product or put in a sealed small contained attached to a product. In a more specific method a carbohydrate which can be recognized by a specific enzymatic treatment or binding molecule is mixed to the complex mixture. In another preferred method carbohydrates labelled with stable isotopes or modified by chemical groups such as protecting groups are added to the mixtures. Due to extreme complexity and quantitivity of the mass spectra, the reproduction of the composition having the same mass finger print is practically impossible without knowing exactly the production conditions and substrate carbohydrates. The invention is also aimed at labelling products batchwise with different finger prints, which is useful for quality control.

1. Analogs of Natural N-acetyllactosamines

The present invention is especially directed to combinations of galactose and N-acetylglucosamine to form analogs of animal poly-N-acetylactosamines. The present invention is directed to reactions to produce various analogs of N-acetyllactosamines and compositions or fractions according to the invention comprising or consisting of oligosaccharides comprising the preferred monosaccharide unit compositions. The structures mimicked comprise β3- and β4-linked galactoses and β3- or β6-linked N-acetylglucosamine, GlcNAc can also be linked to N-glycan core structures by β2- or β4-linkages, α4-linked GlcNAcs also exist in animal biology. The poly-N-acetylactosamine core structures comprise also a glucose residue in glycolipids, mannose, GlcNAc and optionally fucose residues in N-linked glycans and a GalNAc-residue in O-linked glycans. The N-acetyllactosamines can be further substituted by sialic acids, fucose, galactose or GalNAc and derivatizing structures such as sulphate.

Preferred combinations include monosaccharides Gal and GlcNAc. In a preferred embodiment these are combined with the core type monosaccharide residue including at least one monosaccharide selected from the group consisting of Fuc, SA (sialic acid), GalNAc, Man or Glc.

In another preferred embodiment the monosaccharides Gal and GlcNAc or oligosaccharides are reacted with at least one terminal monosaccharide selected from the group consisting of Fuc, SA (sialic acids) or GalNAc. In another embodiment Gal is reacted with monosaccharides selected from the group consisting of: Fuc, SA (sialic acids) or GalNAc. In a separate embodiment combinations Gal and Man, and Glc and Gal are also preferred. In another embodiment GlcNAc is reacted at least with one monosaccharide selected from the group consisting of: Fuc, SA (sialic acid), GalNAc, Man, and Glc. In a preferred embodiment Gal and GlcNAc are reacted with at least two monosaccharides selected from the group consisting of: Fuc, SA (sialic acid), GalNAc, Man, and Glc. In another embodiment GlcNAc is reacted at least with one monosaccharide selected from the group consisting of: Fuc, SA (sialic acid), GalNAc, Man, and Glc.

The preferred monosaccharide combinations for lactosamine analogs include, for example, binary combinations:
Gal and GlcNAc; Gal and GalNAc; Gal and sialic acic; Gal and Fuc; GlcNAc, and Man; GlcNAc and GalNAc; GlcNAc, sialic acic; GlcNAc and Fuc;
   Combinations of three monosaccharides
Gal, GlcNAc and Glc; Gal, GlcNAc, and Man; Gal, GlcNAc and GalNAc; Gal, GlcNAc, sialic acic and, Gal, GlcNAc and Fuc;
   Combinations of four monosaccharides:
Gal, GlcNAc, Man, and Fuc; Gal, GlcNAc, Man, and GalNAc; Gal, GlcNAc, Man, and sialic acid; Gal, GlcNAc, facose and sialic acid.

Preferred oligosaccharide libraries or mixtures include disaccharide structures according to the formula
GalaxGlcNAc
wherein a is anomeric structure alpha or beta and x is linkage position between the monosaccharides. The mixture comprises in a preferred embodiment structures GlcNAcα/βGlcNAc, preferably GlcNAcα/β6GlcNAc and GalaxGal disaccharide. The present invention is specifically directed to the isolation of disaccharide fraction comprising disaccharides Gal₁GlcNAc₁, wherein either Gal is glycosidically linked to GlcNAc or GlcNAc is glycosidically linked to Gal and the disaccharide fraction comprises at least four different disaccharides, more preferably at least six different disaccharides and most preferably at least 10 different disaccharides. In a preferred embodiment the disaccharide fraction also comprises at least one disaccharide wherein Gal is linked to GlcNAc and at least one disaccharide wherein GlcNAc is linked to Gal. In another preferred embodiment the defined disaccharide also comprises at least one alpha and one beta-glycosidic linkage, more preferably at least two alpha and beta glycosidic linkages.

In a specific embodiment the disaccharide fraction according to the invention consist of Gal₁GlcNAc₁, wherein either Gal is glycosidically linked to GlcNAc or GlcNAc is glycosidicaly linked to Gal and does not contain other monosaccharide residues in essential amounts.

In preferred embodiment the present invention is directed to oligosaccharide mixture comprising disaccharides according to the Formula 4:
GalₘGlcNACₙ
wherein the monosaccharide units are glycosidically linked to each other, m and n are integers from 0-2 so that m plus n is 2 and all types of monosaccharide compositions in disaccharides with different values of m and n are present.

In another preferred embodiment the present invention is directed to oligosaccharide mixtures comprising oligosaccharides according to the Formula 4:
GalₘGlcNAcₙ
wherein Gal or or Gal residues is are glycosidically linked to GlcNAc or GlcNAc residue and/or GlcNAc or GlcNAc residues is/are glycosidically linked to Gal or Gal residues and m and n are varying integers for different oligosaccharide components from 0 to 6 and more preferably 1 to 6, independently, with the provision that the mixture comprises every degree of oligomerization (which can be presented by m+n), number of isomers is at least according to the formula 4^{(m+n)}. In a preferred embodiment m and n are varying integers for different oligosaccharide component from 0 to 3 more preferably 1 to 3. In a specific embodiment the invention is directed to a trisaccharide mixtures according to Formula 4 so that m plus n is 3, and integers m and n are between 0 and 3 and all four types of monosaccharide compositions of trisaccharides with different values of m and n are present. In a specific embodiment the invention is directed to disaccharide and trisaccharide mixtures according to Formula 4 so that m plus n is 2 or m plus n is 3, and integers m and n are between 0 and 3 and all the types of monosaccharide compositions of saccharides with different values of m and n are present. In a more preferred embodiment m and n are integers so that that m is 2 and n is 1 and/or m is 1 and n is 2, most preferably mixture comprises trisaccharides so that that both m is 2 and n is 1 and m is 1 and n is 2.

In another specific embodiment the present invention is directed to oligosaccharide mixtures according to the Formula 4 when the mixtures comprise tetrasaccharides so that m plus n is 4 and m and n are integers from 0 to 4, preferably from 1 to 4, and all the types of monosaccharide compositions of saccharides with different values of m and n are present.

In a specific embodiment the invention is directed to disaccharide, trisaccharide and tetrasaccharide mixtures according to Formula 4 so that m plus n is 2 or m plus n is 3 or m plus n is 4, and integers m and n are between 0 and 4 and all the types of monosaccharide composiotions of saccharides with different values of m and n are present.

2. Analogs of Glycosaminoglycans

The natural glycosaminoglycans (heparin heparan sulphate, keratan sulphate, chondroitin and hyaluronic acid) to be mimicked by the libraries according to the invention include synthetic oligosaccharides produced from GlcNAc and GlcA, GalNAc and GlcA. Including the same core monosaccharides as with N-acetyllactosamines as well as GalNAc, Fuc, Man or Glc, and more preferred specific glycosaminoglycan core monosaccharides Xyl, and Gal. Galacturonic acid can be included as an analog monosaccharide residue.

Preferred binary mixtures or disaccharides according the invention include following binary combinations of GlcNAc and GlcA, GalNAc and GlcA, Gal and GlcA, and analogously: GalA and GlcNAc and/or GalNAc, Gal and GlcA, Gal and GalNAc or GlcNAc, Xyl and Gal, Man and Xyl, or Man and GlcA. Also preferred combination includes at least two monosaccharide units selected from the groups
1. GlcNAc, GalA, GalNAc and GlcA
2. GalNAc, Fuc, Man, Glc, Xyl, and Gal

Preferably two monosaccharide residues from group 1 or one from group 1 and a different one from group 2. In another embodiment at least three different monosaccharide units are selected from the groups 1 and 2, preferably so that at least one monosaccharide unit and, more preferably at least two monosaccharide unit is chosen from group 1.

3. Glycolipid Structure Analogs

Beside N-acetylactosamines mammalian glycoconjugates comprises for example globo- and ganglio series glycolipids and other rare glycolipids. The ganglio and globo-series glycolipid core structures contain lactosyl residue, N-acetylgalactosamine and galactose. They can be modified by additional Gal, GalNAc and/or a monosaccharide selected from the group consisting of GlcNAc, fucose, sialic acids. Preferred binary mixtures or disaccharides acoording to the invention include followig binary combinations of GalNAc and Gal, Sialic acid and GalNAc, GlcNAc and GalNAc.

4. Other Glycoconjugates

Analog mixture oligosaccharides can be produced for other natural glycoconjugates. Preferably analog mixtures are made for animal or mammalian glycoconjugates such as GPI-anchored structures. The GPI-anchor structures also comprise an inositol residue. In a preferred embodiment inositol residues are also used similarily as monosaccharides to synthesisze random glycoconjugates or inositol conjugates.

In a specific embodiment the novel methods aim for the production of polydextrose type products, especially derivatized polydextroses, related oligosaccharides and compositions. The present invention is especially directed to production of oligosaccharides without harmfull side products. The monosaccharide anhydride products such as possible levoglucosan produced from glucose substrate can only be removed by expensive extraction/purification methods. The production of glucose derivative side products lowers the yields of the oligosaccharides. The inventor noted that anhydro forms of a monosaccharide residue can be included in the oligosaccharide chains when the traditional methods are used. The inventors realised that the oligosaccharide anhydro forms cannot be effectively removed from the reaction mixtures.

For some applications normal reducing glucose residue could be preferred over a non-natural anhydroform. Natural ring structure could be preferred for biological uses. The reducing end can be also used for derivatization of the oligosaccharide or polysaccharide mixture. The reducing end of the oligosaccharide is in a preferred embodiment derivatized with an alcohol, preferably with a sugar derived alcohol. In a separate embodiment the reducing end aldehyde is coupled with an amine, for example by reductive amination, amidation of glycosylamine or reacting with an amino-oxysubstance or a hydrazine substance. The reducing end of the oligosaccharide or polysaccharide can be also derived to aminoglycoside, thioglycoside or carbon glycoside by methods well-known in the art.

The reducing end of the oligosaccharides or polysaccharides can be in a separate embodiment derived by an allyl chain, two or several fatty acid or alkyl chains like in natural ceramide or glycerol-fattyacids, other hydrophilic aglycons including aromatic structures such as phenols, phenyls, bicyclic aromatic molecules, naphthalene derivatives, alkylaromatic structures, steroids, cholesterol and derivatives, plant sterols or flavonoid molecules.

Novel Functional Saccharides and Glyconjugates Comprising Single Condensed Monosaccharide Residue

The present invention is specifically directed to the production of oligosaccharides and polysaccharides and glycoconjugates in which novel types monosaccharide residues are glycosidially randomly linked to form the synthetic random oligosaccharide, polysaccharide or glycoconjugate. Oligosaccharides, polysaccharides and glycoconjugates are collectively called here as saccharides. The present invention is in a separate embodiment also directed to production of oligomers from free non-derivatized monosaccharides of single molecular species under conditions described by the present invention. The present invention is also in another embodiment directed to condensation reactions of anomeric derivatives of single monosaccharide species. The invention is especially directed to reactions catalysed by small amount of inorganic acid such as HCl, or phosphoric acid, or in a separate embodiment organic acid, preferably citric acid, additionally catalysed by heat, the reactions are preferably performed under conditions preferred in the present invention.

This embodiment includes reactions of a monosaccharide residue from a group A-E or more preferably from groups B-E described by the invention. In another embodiment the invention is directed to selection of a monosaccharide from any preferred group of monosaccharides according to the present invention.

In a preferred embodiment the method includes isolation of an oligosaccharide fraction or oligosaccharide fractions by methods described by the present invention or otherwise known in the art. The production of oligosaccharides from single monosaccharide residue is especially directed to preferred oligosaccharides and polysaccharide sizes are described by the invention. Most preferably the present invention is directed to condensation reaction for the production of disaccharide, trisaccharide and tetrasaccharide comprising fractions.

In separate preferred embodiments the invention is directed to production of mixtures of oligosaccharides or polysaccharides comprising a single reducing end and in another preferred embodiment the oligosaccharide or polysaccharides comprising a single reducing end. More preferably an oligosaccharide mixture comprising a single monosaccharide is produced.

In a specific embodiment the invention is directed to the production of a preferred oligosaccharide fraction or oligosaccharide fractions according to the present invention, preferrably the average molecular weight of the fraction is under 1500, more preferably under 1200.

The present invention is also directed to the production of the oligosaccharides from monosaccharide when the preferred non-melting or low non-melting temperatures are used. In another embodiment preferred low melting temperatures are used. It is preferred to use partial solution of the saccharide and drying by vacuum or heating before the reaction starts. In a preferred embodiment the carbohydrate is dried to form a thin film on a large reactor surface. Techniques according to the invention are especially directed to use in non-melting temperatures. The preferred reaction conditions with lower temperature ranges produce effectively desired products according to the invention, avoiding side product under other conditions.

The reaction mixture contains optionally an alcohol substance, which is preferably a polyalcohol substance. In a preferred embodiment the reaction mixture also contains at least one alcohol substance, preferably a polyalcohol. Preferably a preferred alcohol substance according to the present invention is used.

The present invention is specifically directed to production of functional or potentially functional oligosaccharides or polysaccharides, preferably oligosaccharides from single monosaccharides preferably from monosaccharides selected from the group Glc, Gal, Man, Xyl, Ara, Fuc, Rha, GlcNAc, ManNAc, GalNAc, GlcA, GalA and sialic acid, more preferably selected from the group Fuc, Ara, GalA and sialic acid. The specific monosaccharides selected from the groups A-E according to the present invention, preferably Glc, Man, Xyl, Ara, Fuc, Gal, GalNAc, GlcNAc, ManNAc and sialic acid, and most preferably Man, Xyl, Fuc, Gal, GalNAc, GlcNAc and sialic acid containinig random-type homotypic oligosaccharides produced by the methods according to the present invention are preferred especially for screening uses for searching bioactive carbohydrates useful for nutritional and pharmaceutical applications and as libraries for sceening biological activities. For the screening uses the oligosaccharides are preferably labelled with detectable molecules or conjugated to a polymeric matrix or to a solid phase. Alternatively, oligosaccharides can be used as soluble enzyme substrates or inhibitors in various assay formats. The invention is preferably directed to the use of glycosides of the preferred oligosaccharides as soluble inhibitors.

Cost Effective Production of Functional Saccharides Especially for Human Gastrointestinal Health and for Research Tools of Glycobioogy

Human type glycoconjugates can be synthesised by organic synthesis which involves numerous steps and is currently not suitable for cost effective large scale production. Even enzymatic synthesis using modern fermentation methods is quite expensive. Moreover the use of recombinant gene technologies would possibly lead to problems about regulation about genetically modified organisms.

The invention aims to produce variety of carbohydrates which are needed for human gastrointestinal health, these carbohydrates are not well exploited as these are in general not available in bulk scale. The present methods also allows more effective synthesis of the type of products which are commercially available. The gastrointestinal health of human can be supported by two methods, supporting the normal flora and probiotic bacteria and reducing the amounts of pathogenic diarrhea causing bacteria.

There are several oligosaccharide products which are considered as prebiotics and supporting the normal flora of gut. These include: fructose oligosaccharides derived from natural inulin polysaccharide, xylose oligosaccharide which are derived from natural xylans and galactoseoligosaccharides derived from lactose by transglycosylating galactosidases.

Bioactive Galactose Oligosaccharides

The galactose oligosaccharides are especially directed to searching for novel functional oligosaccharides. Numerous galactose structures are present in mammalian glycobiology. The galactose epitopes are known as pathogen receptors. Galactoses are linked to other monosacharides for example by β3-, β4-, α3-, and α4-linkages and modified to all possible positions 2, 3, 4, and 6. The galactose comprising oligosaccharides according to the present invention including oligosaccharides comprising only galactose are useful for looking for functional bioactivities related to galactose. The present invention is especially directed to galactose comprising random oligosaccharide fraction produced by methods according to the present invention and comprising 1 to about 10 monosaccharide residues, more preferably the invention is directed to disaccharide fractions and tetrasaccharide fractions of Gal and most preferably to trisaccharide fractions.

Xylose and Arabinose Oligosaccharides

The xylooligosacharides can mimick different xylose epitopes present rarely on mammalian biology and more commonly in various plant materials. Natural xylose derived oligosaccharides have been reported to have prebiotic activity, being able to support certain beneficial bacteria. The arabinose oligosaccharide fractions are also expected to comprise special bioactive oligosaccharides especially related to plant glycoconjugates active in human gastrointestinal tract. The xylose and arabinose are pentoses comprising one hydroxyl less than hexoses, which leads to the structures less complex than with the corresponding hexoses glucose and galactose. The pentose oligomers could be used as analogs to similar hexose oligomers or polymers.

The present invention is especially directed to xylose or arabinose comprising random oligosaccharide fraction produced by methods according to the present invention and comprising 1 to about 10 monosaccharide residues, more preferably the invention is directed to disaccharide fractions and tetrasaccharide fractions of Xyl or Ara and most preferably to trisaccharide fractions.

Common Bioactive Mono- and Oligosaccharides

Pathogens such as Helicobacter pylori or intestinal pathogenic viruses and bacteria in gastrointestinal tract bind to glycoconjugates comprising terminal sialic acid, fucose, mannose galactose, N-acetylgalactosamine or N-acetylglucosamine. Rhamnose is a common bacterial cell surface component which has potential roles in probiotic or pathogenic interaction of bacteria. Common core of bacterium receptors and also bacterium receptors are N-acetyllactosamines Galβ3/4GlcNAc, other receptor saccharide sequences comprises sequences such as Galβ3GalNAc, Galα3Gal, Galα4Gal, GlcNAcβ3Gal, GalNAcβ3 Gal and it is likely that all types of human or animal glycosylations have function in these complex interactions. The present invention is directed to the production of the analogs of the human and animal glycomes (expressed glycosylations) by simple analog methods. The saccharide library and sublibraries thereof have use in therapeutics and in search of potential therapeutic carbohydrates and in functional studies of proteins and other molecules binding glycomes.

Saccharides from Mannose

Mannose is central bioactive monosaccharide in animal and human biology. Mannose is present in numerous human N-linked glycans. Mannose comprising oligosaccharide sequences are also present on yeast cell walls and yeast. Mannose is present in the glycomes both asp-linked such as β4-linked structures and α2-, α3-, and α6-linked structures, other monosaccharides are linked to all free positions of 1, 2, 3, 4, 6 of mannose monosaccharide.

The present invention is directed especially to mixtures of random oligomers of mannose and conjugates there of comprising at least 4 different oligosaccaharide chains including at least one type of β-mannosidic and one α-mannosidic linkage or at least one α4-mannosidic linkage structure between mannose monosaccharide residues. The type of mannosidic linkage indicates here that the mannose residue is linked to specific position of next mannose residue. Different α/β-mannosidic linkage types includes structures Manα/β1Manα/β, Manα/β2Man, Manα/β3Man, Manα/β4Man, and Manα/β6Man. Oligosaccharide chain according to the invention also includes disaccharides.

Preferred mixtures of random mannose saccharides comprises at least 6 different trisaccharide sequences, and more preferably at least 10 different trisaccharide sequences. In a preferred embodiment the mannose saccharide chains comprises at least four different mannosidic linkages one type of β-mannosidic and one α-mannosidic linkage.

In another preferred embodiment the mixture of random mannose oligosaccharides comprises at least 10 different trisaccharide sequences and at least two types of β-mannosidic and types of α-mannosidic linkages. In a preferred embodiment the mixture of random oligomers comprises at least 10 different oligosaccharide chains and at least 4 types of α-mannosidic linkages.

Saccharides from Deoxymonosaccharides Especially from Deoxyhexoses

The prior art stating that any sugar could be transferred by an acid catalysed reaction has obviously not considered all types of monosaccharides. For example, the present invention surprisingly disclose that 6-deoxyhexoses such as fucose and rhamnose react to produce novel oligosaccharides and polysaccharides. The prior art states that acid catalysed polymerisation should produce mainly 1-6-linked oligosacchrides, but 6-deoxymonosaccharides cannot form such linkages as they lack the 6-hydroxyl group. Under the preferred reaction conditions according to the invention the aldohexoses including mannose formed quite random mixtures of linkages, with no specific preference for 1-6-linkages.

The present invention shows that not all hydroxyl groups of a monosacharide are needed for production of oligomers or polymers under acid or salt catalysed conditions preferably under the reaction conditions according to the present invention. The effective reactions are possible with monosaccharides containing —HC₂— or CH₃-structures when deoxygroup is not replacing anomeric hydroxylgroup. The ring of monosaccharide can comprise —CH2— like for example in NeuNAc and sialic acid.

The present invention is specially directed to the reactions of 6-deoxymonosaccharides. The high reactivity of the 6-deoxyhexoses such as fucose and rhamnose was surprising as previously hexoses including glucose are thought to form preferentially 1-6-linkages between monosaccharide residues. 6-deoxymonosaccharides do not contain 6-hydroxyl which would be needed for the linkage.

The present invention is preferably directed to saccharide compositions formed from 6-deoxyhexohexoses. Natural 6-deoxy monosaccharide fucose is known to be present in α2, α3-, α4-, α6-linked forms on other monosaccharides on animal glycans, at least on certain parasites fucose can be derived other fucoses to 2 position. The fucosylated carbohydrates are important cell adhesion molecules in animals. Difucosylated epitope Lewis b is know as receptor for gastric pathogen H. pylori. Fucose especially in α2-linkages is also known as substrate for bacteria of normal flora. Natural fucose polysaccharides from algae called fucoidin or fucoidan are sulphated polymers of fucose, these comprise probably two or three different α-linkages between monosaccharide residues and sulphate residues. The fucoidan structures are very effective analogs of sulphated or acidic carbohydrate receptors active in numerous cellular interactions, for example fucoidan inhibits selectin mediated cell adhesion. The present invention allows effective chemical synthesis of analogs natural fucose oligosaccharides and polysaccharides. The present invention allows synthesis novel random compositions comprising more than ⅔-natural types of fucose-fucose linkages present in fucoidan. The random oligosaccharides comprises also much larger variation oligosaccharides of specific length.

The fucose saccharide compositions according to the present invention comprise at least 4 different linkage types between fucose monosaccharides. Alternatively the fucose saccharide compositions comprise at least 6 different trisaccharide sequences and more preferably at least 10 different trisaccharide sequences. The present invention is also directed to the use of sulphated forms of fucose saccharides.

The present invention is also directed to compositions of analogs of the fucose saccharides comprising other 6-deoxyhexoses. The 6-deoxyhexose saccharide compositions according to the present invention comprise at least 4 different linkage types between 6-deoxyhexose monosaccharides. Alternatively the 6-deoxyhexose saccharide compositions comprise at least 6 different trisaccharide sequences and more preferably at least 10 different trisaccharide sequences. The present invention is also directed to the use of sulphated forms of deoxyhexose saccharides. Preferred 6-deoxyhexoses in the compositions includes fucose and rhamnoses and other natural 6-deoxyhexoses.

The present invention is specifically directed to production of compositions comprising randomly linked fucose oligomers and or polymers for gastrointestinal use. The fucose saccharides according to the invention mimick the natural fucoidans or fucoidins. It is realized that the fucose saccharides and also sulphated derivatives according to the present invention are useful for gastrointestinal health. The fucose saccharides have anti-infective and/or prebiotic activities. The present invention is directed to use of the fucose saccharides according to the present invention in food compositions and in therapheutical or pharmaceutical compositions to support gastrointestinal health. The present invention is also directed to the use of natural fucose polymers, including natural fucoidins and fucoidans and oligosaccharides and desulfoderivatives thereof, as food additives.

Saccharides from Sialic Acids

Sialic acids are a major class of bioactive monosaccharide residues on human glycoconjugates. In mammalian natural conjugates the sialic acids are usually α3- or α6-linked to galactose or N-acetylgalactosamine, α6-linked sialic acids can be also linked to GlcNAc and in rare cases also to mannose. In mammalian polysialic acids linkages between the sialic acid residues are α8, in some pathogenic bacteria also α9-linked sialic acids occur. The bacteria, including bacteria pathogenic to humans and possibly some lower animal also contain other sialic acids or sialic acid type monosaccharides such as KDO and KDN. The sialic acid are known to be substituted in numerous ways such as by O-acetyl groups, sulphate groups or N-glycolyl groups. The present invention describes synthesis of random sialic acid conjugates mimicking the natural sialylated structures important for human and animal biology. The random sialic acid conjugates comprise natural sialic acid structures and novel mimetic structures.

Novel Functional Saccharides and Glyconjugates Comprising at Least Two Monosaccharides of the Same Type/Group

The present invention is also directed to production of mixed oligomers from free non-derivatized monosaccharides of single type under conditions described by the present invention. The invention is especially directed to reactions catalysed by small amount of inorganic acid such as HCl, or phosphoric acid, or in a separate embodiment organic acid, preferably citric acid, the reactions are performed under conditions preferred in the present invention.

In one embodiment the present invention is directed to production of mixed oligosaccharides from at least two non-protected monosaccharides of any types. This embodiment includes reactions of two monosaccharide residues from a single group A-E. Preferably, the two monosaccharides from same group are chosen from the groups A-D or more preferably from groups of more bioactive monosacharides. The invention provides a method to produce a saccharide or glycoconjugate from free non-protected reducing monosaccharide or oligosaccharide involving acid catalysed polymerisation or oligomerization of a monosaccharide selected from the groups:
A. simple aldomonosaccharides, preferably pentoses or hexoses
B. deoxymonosaccharides especially 6-deoxymonosaccharides such as fucose or rhamnose
C. N-acetylhexosamines, preferably regular N-acetylhexosamines such as GalNAc and GlcNAc
D. sialic acids, such as N-acetylneuraminic acids or ketodeoxyoctusulonic acids (KDO)
E. hexuronic acids, such as galacturonic and glucuronic acids
   when mixtures of at least two different monosaccharides from one of the groups A-B are used.

In a preferred embodiment the method includes isolation of an oligosaccharide fraction or oligosaccharide fractions comprising mixed type and homotypic oligosaccharides.

In separate preferred embodiments the invention is directed to production of mixtures of oligosaccharides or polysaccharides comprising a single reducing end and in another preferred embodiment the oligosacharide or polysaccharides comprise a single reducing end.

In a specific embodiment the invention is directed to the production of a preferred oligosaccharide fraction or oligosaccharide fractions according to the present invention, more preferrably the average molecular weight of the fraction is under 1500.

The present invention is also directed to the production of the oligosaccharides from monosaccharides of the same group when the preferred non-melting or low non-melting temperatures are used. In another embodiment preferred low melting temperatures are used. It is preferred to use premixing techniques according to the invention especially in non-melting temperatures. The preferred reaction conditions with lower temperature ranges produce effectively desired products according to the invention, avoiding side product under other conditions.

The reaction mixture contains optionally an alcohol substance, which is preferably a polyalcohol substance. In a preferred embodiment the reaction mixture also contains at least one alcohol substance preferably a polyalcohol. In a preferred embodiment at least three different monosacharides from one of the groups A-E are used.

Preferred combinations of two monosaccharides from the same group include combinations described below as pairs a) and pairs b).
Pairs a) Gal and Glc, Gal and Man, Gal and Xyl, Gal and Ara, Glc and Xyl, Glc and Man, Glc and Ara, Man and Xyl, Man and Ara, Xyl and Ara; more preferably at least one pentose pairs: Gal and Xyl, Gal and Ara, Glc and Xyl, Glc and Ara, Man and Xyl, Man and Ara, Xyl and Ara and even more preferably the arabinose containing pairs Gal and Ara, Glc and Ara, Man and Ara, Xyl and Ara
Pairs b) GalNAc and GlcNAc, GalNAc and ManNAc, ManNAc and GlcNAc, Fuc and Rha, glucuronic acid and galacturonic acid, sialic acid and KDO, more preferably GalNAc and GlcNAc

A preferred combination of three monosaccharides from the same group includes combinations of three monosaccharides selected from the group Gal, Glc, Man, Xyl and Ara, more preferably combinations comprising at least one pentose and even more preferably comprising arabinose, and group of GlcNAc, GalNAc and ManNAc.

The present invention is also directed to the composition of two and/or three monosaccharide units from a single group as defined above. The presence of different oligosaccharide compositions can be confirmed by NMR or mass spectrometry.

Production of Carbohydrates Under Condensing Conditions

The present invention is also specifically directed to reaction conditions for producing oligosaccharides. In general oligosaccharides are easier to produce at lower temperartures described by the invention. The present invention is also directed to restricting the reaction times, temperatures and/or catalysis conditions considering the properties and quantities of substrate saccharides so that preferably oligosaccharide products are formed. The present invention is specifically directed to conditions which produce disaccharides as major oligosaccharide product. In another preferred embodiments reaction conditions are optimised so that trisaccharides are major reaction products and in yet another conditions tetrasaccharides are preferred products. The present invention is as a preferred embodiment also directed to production of monosaccharide glycosides, disaccharides glycosides trisaccharide glycosides and tetrasccharide glycosides. In a more preferred embodiment alkylglycoside such as methylglycoside or ethylglycoside or polyol glycoside of a reducing monosaccharide is produced.

Catalysts

The novel reactions between various carbohydrates, especially to produce novel types of carbohydrate mixtures according to the present invention can be produced under various conditions including condensation reactions performed with catalyst such as organic or inorganic acids, Lewis acids, or heat or combinations thereof. In a separate embodiment the chemical catalysts includes salts, preferably non-alkaline salts, tionyl chloride, and acids or other catalysts used for production of polydextrose and similar products. Preferred acids includes hydrochloric acid, phosphoric acid, or organic acid such as citric acid or other acid used for production of polydextrose and similar products. In a preferred embodiment the acid is not highly toxic and corrosive or volatile acid gas such as hydrogen fluoride. In a separate embodiment of the invention aiming at isomerically limited oligosaccharides, hydrofen fluoride can be used. It is preferred to combine heat with acids preferably modest heating. In specific embodiment the reactions are carried out at room temperature and an acid catalyst is used.

Inorganic acid catalysts which are preferably used in the method of the invention are: hydrochloric acid, sulphuric acid, sulforoues acid, thiosulphuric acid, dithionic acid, pyrosulphuric acid, selenic acid, selenious acid, phosphorous acid, hypophosphoric acid, boric acid, perchloric acid, hypochlorous acid, hydrobromic acid, hydriodic acid and silicic acid, acidic alcalimetal or alkaline earth metal salts of above mentioned mineral acids, mixtures thereof and mixtures thereof with phosphoric acid. Also neutral metal salts especially alkaline or earth alcalinen metal salts are also applied for the production of oligosaccharide and/or polyaccharides according to the present invention.

Preferred Form is of Reaction Mixtures

In broadest embodiment novel oligosaccharide mixtures according to the present invention can be produced from starting materials in different solution forms as described for production of polydextrose and other condenced carbohydrates as described by earlier publications. In general methods using concentrated water and also suggesting other solvent comprising solutions and heating to remove water for example up to 110 degrees of Celsius or to higher temperatures have been described. Other methods use solid carbohydrate starting materials and mix these with low amounst of concentrated acid. Yet another possibility is to react the solid carbohydrate material with the gaseous acid.

The present invention is in a preferred embodiment directed to use of solid starting material, preferably in form of powder comprising small crystals. Methods to produce very fine powders of carbohydrates are known in the art. In another preferred embodiment present invention is directed to semisolid or hydrated starting materials. In a preferred method the carbohydrate starting material(s) is/are soluted preferably in water, or as a separate embodiment in other suitable solvent, and the liquid is dried. Soluting of the carbohydrate may also mean mixing the carbohydrate with low amount of suitable solvent preferably water so that the carbohydrate or carbohydrates are not completely dissolved but so that the solvent is mixed with at least most of the carbohydrate. Preferrably the drying is performed by reduced pressure for example by lyophilization or by a vacuum centrifuge. The drying is preferably performed so that part of the water or other sovent is not removed. In a preferred embodiment a glassy hydrated drying product is used. The glassy hydrated product mean non-powder semidry solid product with glass like or opasque appearance or in a separate embodiment thick liquid product having similar viscosity as syrup. The glassy hydrated product can be produced by evaporating water from soluted carbohydrate material. In a preferred embodiment the drying or partial drying is performed below 110 degree of Celsius, and in other preferred embodiment preferably the drying is performed under 60 degrees of Celsius and under 30 degrees of Celsius. In a separate embodiment the carbohydrate starting materials are administered to reaction vessel, chamber or reactor in solution phase or as semisolid mixture and the mixture is dried or partially as described by the invention dried by heating or vacuum or by other means.

Premixing of Starting Materials

It is preferred to mix the carbohydrate starting material by various effective methods as described by prior methods for production of polydextrose and similar condenced carbohydrates. In a preferred embodiment the carbohydrates are mixed in a solution and dryed to dry, or hydrated or semidry or glassy hydrated product as described above. The mixing of different carbohydrates in solution phase is preferred especially for methods producing oligosaccharides comprising different types of monosaccharide residues as described by the invention. The mixing in solution phase is especially preferred when non-melting temperatures are used, the method is especially preferred for reactions carried out under 140 degrees of Celsius and more preferred for reactions carried out under 90 degrees of Celsius.

In a preferred embodiment also the acid is mixed to the carbohydrate starting material or starting material in solution phase and the mixture is dryed to dry, or hydrated or semidry or glassy hydrated product as described above by the invention. In a preferred embodiment drying and optionally the solution phase mixing of the carbohydrates with acid is performed in the reaction chamber, vessel or reactor. In a preferred embodiment the drying of the carbohydrates is performed in low temperatures, preferably under 90 degrees of Celsius, in more preferred embodints under 60 degrees of Celsius and under under about 35 degrees of Celsius and most preferably under 20 degrees of Celsius using reduced pressure, preferably under 300 mg Hg. The acid is dried with the carbohydrate so that catalytic amount of the acid is included in the carbohydrate material. The method of drying the carbohydrate with the catalyst, preferably acid catalyst according to the invention, allow even distribution of the acid in the reaction and increases the effectivity of the polymerisation reaction and reduces the amounts of side products. It is also realised that numerous methods to mix solid or melted substrate materials are available for a skilled artisan.

Preferred Reaction Temperature Conditions for Production of Saccharides and Glycoconjugates According to the Present Invention

The present invention is directed to the use of acid or salt catalysis for production of saccharides and glyconjugates according to the present invention under reduced temperature in comparision to the prior art. The temperatures preferred according to the prior art start from about 140 degrees of Celsius having upper limit of about 1600 degrees for so called anhydrous melting conditions. Present invention is specifically directed to the use temperatures below 140 degrees of Celsius preferably about 80 degrees of Celsius and lower temperature. Benefits for the use of “lower non-melting temperatures” in preserving the structures of reducing end monosaccharides and preserving oligosaccharide and conjugate structures are described by the invention, moreover the lower temperature ranges allow more effective and precise synthesis of oligosaccharides preferred under specific embodiments of the present invention. The present invention is also directed to premixing methods to allow effective reaction in lower temperatures.

The Lower Melting Temperatures

In its specific embodiments the temperature conditions used in the method of the invention are of range 140-500 degrees of Celsius, preferably between 140 and 250 degrees of Celsius, more preferably between 140 and 200 degrees of Celsius, and most preferably between 140 and 180 degrees of Celsius. The lower reaction temperature range allows to control the synthesis of desired oligosaccharides and glyconjugates and reduces side products formed in higher temperatures. For an industrial process the use of lower temperatures is also saving energy.

In one preferred embodiment the temperature is above about 100 degrees Celsius but below 130 degrees Celsius and more preferably below 120 degrees of Celsius and most preferably below 110 degrees of Celsius. To reduce amount of undesired anhydroforms reaction times are controlled, since shorter reaction times reduce formation of anhydroproducts. Under specific embodiment the shorter reaction times are optimised for production of oligosaccharides, or disaccharides or monosaccharide conjugates according to the present invention. More preferably the reactions are performed below 100 degrees of Celsius but above about 40 degrees of Celsius, such processes may save heating energy and products chemically less dehydrated products, most preferably the reaction temperature is between about 45 degrees of Celsius and 85 degrees of Celsius. The reactions between temperatures from about 40 degrees of Celsius to 140 degrees of Celsius are carried out preferably with hydrochloric acid as catalyst. Other suitable preferred inorganic acids includes sulphuric and phosphoric acid. Preferably very low amounts of the acid is used similarity as described in the prior art. In a preferred embodiment reactions are performed in closed reaction vessels, more preferably under protection gas athmosphere, for example under nitrogen and/or under reduced air pressure. To reduce amount of undesired anhydroforms reaction times are controlled, shorter reaction times reduce formation of anhydroproducts. Under specific embodiment the shorter reaction times are optimised for production of oligosaccharides, or disaccharides or monosaccharide conjugates according to the present invention.

In a separate embodiment the reactions are performed in temperature range from about 1 degree of Celsius to 50 degrees of Celsius, more preferably in temperature range from 10 to 40 degrees of Celsius and most preferably in temperature range from about 20 degrees of Celsius to about 35 degrees of Celsius. In the temperature range below 50 degrees of Celsius reactions are obviously slower than under reaction conditions above. Under temperatures close to room temperature additional heating may not be necessary and energy is saved. The reaction products produced under 50 degrees Celsius and more effectively under 30 degrees Celsius contain only minor amount of anhydro-saccharides. Preferred acid for reactions in the temperature range is hydrochloric acid. Preferrably reactions are performed by contacting the carbohydrate material with gaseous HCl, in a preferred embodiment with fumes from concentrated aqueous HCl. In a preferred embodiment reactions are performed in closed reaction vessels, more preferably under protectiong gas athmosphere, for example under nitrogen or under reduced air pressure. To reduce amount of undesired anhydroforms reaction times are controlled, shorter reaction times reduce formation of anhydroproducts. Under specific embodiment the shorter reaction times are optimised for production of oligosaccharides, or disaccharides or monosaccharide conjugates according to the present invention.

Preferred General Carbohydrate Mixtures

The present invention shows that different monosaccharides and oligosaccharides have varying reactivities, and only certain monosaccharides are really useful to produce desired polymeric products. The present invention is specifically directed to use of monosaccharide residues preferred according to the invention and preferably considered not to be “simple” sugars. Also different reaction conditions affect the types of products formed, preferred reaction conditions are described for mixed reactions between different monosaccharides. The present invention is also directed to methods to produce mixtures or compositions comprising various mixtures of oligosaccharide and/polysaccharide reaction products according to the present invention. In a present invention is specifically directed to production of mixtures comprising oligosaccharides, which contain all combinations of the monosaccharides of the starting material. In another embodiment the invention aims for production mixture comprising at least mixed disaccharides or dimers of the starting materials and disaccharides or dimers comprising only single type of the starting materials, more preferably all dimers comprising single or mixed starting material carbohydrates are used. In a specific embodiment at least one of the starting materials is oligosaccharide or polysaccharide and the products comprise at least mixed disaccharides or of the monosaccharide residues of starting materials and disaccharides comprising only single type monosaccharide residues of the starting materials, more preferably all disaccharides comprising single or mixed starting material monosaccharides are used. In a specific embodiment the present invention is aimed to production of all possible linkage types and combintion between the monosaccharide residues in the oligosaccharides or glycoconjugates produced. The possible linkages types indicated that not all monosaccharides react randomly.

Production of Oligosaccharides

In a specific embodiment the reaction times are optimised to production of oligosaccharides so that about 80% of the oligosaccharides formed are in range from disaccharides to about decasaccharides, more preferably about 80% of the oligosaccharides formed are within the range from disaccharides to octasaccharides and most preferably about 80% of the oligosacharides formed are within the range from disaccharides to hexassaccharides, more preferably at least 95 mol procent of the oligosaccharides are within the desired range. In a separate embodiment the present invention is directed to the synthesis of disaccharides so that at least 40 mol % of the oligosaccharides formed are disaccharides or isolation of a disaccharide fraction from a reaction according to the present invention comprising at least 60% of disaccharides, more preferably at least 80% disaccharides and most preferably at least 95% of disaccharides. Furthermore the present invention is directed to formation of monosaccharide glycoconjugates, especially monosaccharides conjugated with polyalcohols including food acceptable low cost alcohols comprising three to six including hydroxyl groups such as sorbitol, xylitol, mannitol, galactitol, erythritol or glycerol. More preferably the polyalcohol is sorbitol or xylitol. The present invention is especially directed to limited size oligosaccharide conjugate fractions by using polyalcohols or polyols larger amounts as described by the invention. The invention is also directed to oligosaccharide fractions comprising a single reducing end and conditions for production thereof.

Other Preferred Oligosacchride Chain Lengths, Subfractions and Purified Components

The chain length of the oligosaccharide chain in mixtures according to the present invention is preferably in the range from two to about ten monosaccharide residues, and in more preferred embodiments between two to to about eight monosaccharide residues, and from two to about six monosacharide residues. In a preferred embodiment the length of the oligosaccharide chain is in the range two to four monosaccharide residues. The range indicates here that at least about 80% of the oligosaccharide mass is within the range. The invention is also directed to isolated subfractions and components of the mixtures of the random oligomers of the monosaccharides according to the present invention. Most preferred subfractions comprises oligosaccharide fraction with oligosaccharide chain length from two to four, two to three, and three to four monosaccharide residues, and essentially pure disaccharide mixtures, essentially pure trisaccharide mixtures, and essentially pure tetrasaccharide fractions. Essentially pure subfractions comprise at least 80 carbohydrate mass % of the desired oligosaccharide or oligosaccharides, more preferably the essentially pure fraction comprises at least 90% and most preferably at least 95% of the desired oligosaccharides.

Preferred subfractions also include all other possible oligosaccharide fractions with different subfraction oligosaccharide lengths in the ranges from two to ten monosaccharide residues, for example oligosaccharide length in range of from three to four; from three to five; from three to six, seven eight, nine or ten; from four to five; from four to six; from four to seven or eight or nine or ten; from five to six; from five to seven or eight or nine or ten; from six to seven or eight or nine or ten; from seven to eight, nine or ten; from eight to nine or ten; from nine to ten monosaccharide residues long.

The present invention is also directed to essentially pure subfractions comprising essentially pure pentasaccharide mixtures, essentially pure hexasaccharides, essentially pure heptasaccharide mixtures, essentially pure octasaccharide mixtures, essentially pure octasaccharide mixtures, essentially pure decasaccharide mixtures. The present invention is directed to subfractions of the oligosaccharide chain mixtures which are enriched based on a speficic linkage type, for example β6 and/or β6 linkages and production thereof from the oligosaccharide mixtures according to the present invention. The specifically enriched linkage types are especially preferred for disaccharide, trisaccharides and tetrasaccharides. The present invention is also directed to production of essentially pure oligosaccharides by isolating single oligosaccharides wih specific linkage structure, especially the present invention is directed to production of essentially pure disaccharides, trisaccharides, or tetrasacchrides, more preferably trisaccharides or tetrasaccharides and most preferably disaccharides. The present invention is further directed to mixtures of various subfractions of oligosaccharide mixtures according to the present invention comprising same or different monosaccharide.

Glucose Oligomers, Polydextrose Analogs

The present invention is in a preferred embodiment directed to the production of novel polydextrose type oligomers from monosaccharide glucose. The present invention is directed to novel starting materials to specific glucose oligomers. The present invention is especially directed to the use of starch and/or other glucose polysaccharides as starting material for hydrolysis and condensation of hydrolysis products to a specific glucose oligosaccharide or polysaccharide fractions.

The present invention is also directed to methods to react starch, or other glucose polysaccharides, with an alcohol substance, preferably a polyalcohol such as xylitol or sorbitol, or other preferred polyalcohol as described by the present invention, preferably under low melting temperatures and in presence of low amounts of acid catalyst. Furthermore, the present invention describes reactions of starch with various monosaccharides to produce oligosaccharides or polysaccharides comprising additional non-glucose monosaccharide units.

The present invention is also directed to reactions of glucose with polyols or polyalcohols, such as for example xylitol, sorbitol, or mannitol when larger amounts of polyol is used. The invention is directed to the use of larger amounts of polyol as starting from about over 20 mass % of polyol in the reactions and preferably using about 33% and more preferably at least 50% of the polyols or even more as described by the invention. The use of larger amounts of polyols helps to synthesize oligosaccharide fractions preferred by the invention. Moreover, increasing amount of polyol decreases the amount of reducing residues on the saccharides. The present invention allows to avoid the chemical reduction step aimed for deactivating the free reducing end in certain cyclodextrin preparations. The extra polyol can be isolated from non-reducing oligosaccharides produced or used as a mixture with the polyol. The present invention is especially directed to the production of mixture compositions of polyols and non-reducing oligosaccharides by condensation reactions described by the present invention. In a preferred embodiment the non-reducing oligosaccharide is produced from glucose and the polyol is one of the preferred polyols according to the invention preferably sorbitol, xylitol, or mannitol, most preferably sorbitol or xylitol. The non-reducing oligosaccharide can be produced from any monosaccharide from groups A-E or other preferred monosaccharide groups.

The present invention is also directed to the synthesis of structurally more defined glucose oligomers by transferring glucose monosaccharides on specific glucose structures including various glucose oligosaccharides such as maltose, maltotriose, and other maltooligosaccharides or starch oligosaccharides, cyclic glucose oligosaccharides including cyclodextrins, cellobiose, laminaribiose, gentiobiose, nigerose, trehalose. Other glucose oligosaccharides can be produced from glucans such as beta-linked glucans including cellulose, laminaran, plant beta-glucans and bacterial beta-glucans and alpha-linked glucans including dextrans, glycogens and other alpha-linked glucose polymers. The present invention also describes use of oligosaccharides or polysaccharides with glucose monosaccharides under conditions which allow preserving at least partially the original linkage structure of the oligosaccharide yielding more defined oligosaccharides.

In prior art method to transfer a ketomonosaccharide fructose to starch has been described, however, in such reaction unnatural dehydrated fructose is linked to starch under heating conditions. For biological and food uses such material may not be preferred, at least if more biocompatible materials are available. The present invention is directed to a specific embodiment of synthesis of natural type glycosides on polysaccharide materials. In this embodiment glucose comprising oligosaccharides and/or glucose is used together with a glucose polysaccharide. This method can be used to produce novel derivatized starches, the branching of the starch polymer reduces its degradability and makes it polydextrose-like material to be used for example as a low calory bulking agent. Soluble polymers can also be produced from cellulose and cellulose oligosaccharides by reacting these with oligosaccharides and/or a monosaccharide. Glucose derivatized polysaccharides are especially preferred for food uses.

Beside these aldohexuronic acids, for example galacuronic acid of glucuronic acid, can also be transferred on polysaccharides, however, with lower reactivity compared to the monosaccharides, disaccharides or oligosaccharides listed above. The hexuronic acid transferred to an oligosaccharide or polysaccharide allows intrachain or interchain cross-linking of oligosaccharides or polysaccharides. Prior art has described the use of various simple carboxylic acids, such as citric acid in the production of polydextrose substances. The present invention is specifically directed to the optional use of hexuronic acids. As a separate embodiment other sugar derived acids, preferably gluconic or other monosaccharide acids, comprising carboxylic acid group at the reducing end position or sugar derived dicarboxylic acids, especially hexose derived dicarboxylic acids, for example glucaric acid and galactaric acid, can be used in processes for producing larger polydextroses. The problem with the carboxylic acid described by the prior was the bitter taste of the esters formed, the sugar-like carboxylic acids are aimed for lowering this effect. The present invention is directed to the use of sugar derived acid as additional components in polymerisation and oligomerization reactions according to the present invention. When a preferred composition is formed in the presence of acid, the amount of acid residues linked to different oligosaccharides can be determined by mass spectrometry as described for other oligosaccharide compositions.

The present invention is also directed to the oligomerization of fructose under conditions described by the invention. Preferably fructose is oligomerized under low non-melting conditions. The fructose oligosaccharides comprise 1-1 linkages and dehydrated double bond comprising forms. The present invention is also directed to novel condensation reaction between fructose and polyols according to the invention, preferably xylitol, sorbitol, or mannitol. The present invention is directed to novel “polyol fructosan” structures comprising several polyols linked to single dehydrated fructose residue. The invention is directed to polyol-fructose conjugates produced as described by the invention. The invention is also directed to reactions between sucrose with itself, with polyols and monosaccharides under conditions according to the invention. The present invention is separately directed to an insoluble fructose derived polymer which is synthesized in higher non-melting temperatures or under lower melting temperatures under conditions according to the invention.

Methods and Compositions Involving Aglycons, Alcohols and Polyalcohols and Protecting Groups

Reactions with Alcohols

The present invention is specifically directed to production of novel oligosaccharides, polysaccharides conjugated with alcohol substances, in a preferred embodiment with polyalcohols preferably derived from or analogous to monosaccharides. Polyalcohols can be produced by reducing aldehyde or ketogroup of carbohydrates to alcohol group.

Some Preferred Alcohols

The present invention is in a specific embodiment directed to production derivatives from “monoalcohol substances”. The monoalcohol substance means in the present invention alcohols comprising a single hydroxyl group, most preferably a single primary alcohol group. In a preferred embodiment the group of monoalcohol substances comprises alcohols, preferably alkyl alcohols, comprising 1-16 carbon, more preferably 1-8 carbon atoms atoms, more preferably that monoalcohol substance is ethanol, methanol, propanol, butanol, pentanol or hexanol and most preferably methanol or ethanol. In another preferred embodiment the monoalcohol substance is a cycloalkane, preferably a cyclopentanol or cyclohecanol. The cycloalcohols are useful as mimetics of carbohydrate type ring structures.

The monoalcohol substances comprising one primary alcohol also include substances comprising one primary alcohol group and several secondary alcohol groups such as reduced 6-deoxyhexoses, preferably Fuc-ol or rhamnitol. The monoalcohol substances comprising one primary alcohol also include substances comprising one primary alcohol group and one carbocylic acid group and optionally secondary hydroxyl groups, preferred monoalcohol substances with a single carboxylic acid group includes glycerate (glyceric acid HOCH₂CH₂COOH) and hexuronic acid derivatives when aldehyde groups are reduced to alcohols, preferably GalA-ol and GlcA-ol or reducing monosaccharides which aldehyde group is oxidized to carboxylix acid, such as gluconic acid. The present invention is also directed to compositions comprising oligosaccharide alcohols and monoalcohol substances comprising preferably rhamnitol or Fuc-ol or GalA-ol or GlcA-ol or 1-carboxylic acid derivatives of Gal, Glc, Man, or Xyl. The monoalcohol substances are useful for production of reducing end derivatives of mono- and oligosaccharides according to the present invention so that more defined structures are formed. The monoalcohol substances comprising three hydroxyl groups can be also classified as polyacohol substances described below.

The present invention is also directed to use of “dialcohol substances”, which in the present invention means substances comprising two hydroxyl groups, most preferably two primary hydroxyl groups. In a preferred embodiment the group of monoalcohol substances comprises alcohols, preferably alkyl alcohols, comprising 1-16 carbon, more preferably 1-8 carbon atoms. In preferred embodiment the dialcohol substance is a alkyl dialcohol such as ethylene glycol, 1,3-propanediol, 1,4-butanediol. In a preferred embodiment the present invention is directed to the use of oligoethylene glycol or polyethyleneglycol substances comprising primary hydroxyl groups as alcohols in the coupling reaction. In another preferred embodiment the dialcohol substance is a cycloalkane, preferably a cyclopentanediol or cyclohexanediol. The cycloalcohols are useful as mimetics of carbohydrate type ring structures. The dialcohol substance are useful for making specific dimeric carbohydrates.

A preferred group of alcohol substances according to the present invention is polyalcohol or with another name polyol substances this group preferably includes substances comprising at least three hydroxylic acid groups and preferably 3-9 carbon atoms, more preferably 3-6 carbon atoms and most preferably 5-6 carbon atoms. The polyalcohols include aldehyde reduced monosaccharides of the groups A-D and ketone reduced monosaccharides from group E. More preferably polyol is a aldehyde-reduced monosaccharide selected from the group consisting of Glc, Gal, Man, Xyl, Ara, Fuc, Rha, GlcNAc, ManNAc and GalNAc. The more preferred polyols are reduced hexoses such as sorbitol, galactitol, and mannitol, and pentoses such as arabinitol or xylitol, most preferred polyols for uses and compositions according to the present invention are xylitol, and sorbitol.

Present invention is especially directed to reaction between at least two carbohydrates from at least two groups as described by the invention in the presence of alcohohol substance in a more preferred embodiment a polyalcohol. In a preferred embodiment the present invention is directed to alcohol derivatives of the reactions using single carbohydrate substrate or reactions using two monosaccharides from a single group.

Preferred reaction conditions for condensation of solid alcohol substances such as most polyols with carbohydrates include preferably lower melting temperatures and conditions. For production of oligosaccharide conjugates from polysaccharides the lower melting temperatures are especially preferred. In another embodiment lower non-melting temperatures are used. It is especially preferred to use premixing techniques according to the invention in non-melting temperatures. The preferred reaction conditions with lower temperature ranges produce effectively desired products according to the invention, especially with polyol and dialcohol substances while the high temperature condition in the prior art have tendency to give different products.

The present invention is also directed to reducing end alcohol derivatives of the oligosaccharides mixtures and substances produced according to the present invention. The alcohol derivatives can be produced by the condensation methods described by the invention. The present invention is alternatively directed to derivatization of the carbohydrates according to the present invention by chemical reduction of the free reducing end aldehyde group by a chemical reducing chemicals including sodium borohydride or by catalytic hydrogenation using metal catalysts as well-known in the art.

Preferred Oligosaccharides and Polysaccharides Comprising Single Reducing End in Reducing Reduced or Derivatized Forms

The present invention also shows that in the oligosaccharides produced by condensation of two different carbohydrates according to the present invention under specific conditions, the carbohydrate products have only one reducing end. Preferably when acid catalyst is used, it is not divalent or polyvalent acid which can cross-link carbohydrates (such as citric acid have been considered to form ester cross-links under certain conditions) and also preferably the carbohydrates or reaction conditions are chosen so that cross-links by another reactant than aldehyde or keto group will not be formed. The other reactive groups includes groups in the saccharide chain like for example by carboxylic acid group on monosaccharides of the groups. Extreme heat conditions described by prior art can also cause undesired cross-linked carbohydrate chains. The non cross-linked oligosaccharides or polysaccharides are preferably produced under low temperature ranges described by the invention. A preferred catalyst for the production of oligosaccharides comprising single reducing end is hydrochloric acid or phosphoric acid especially in the preferred temperatures.

The saccharides, preferably oligosaccharides, substances or mixtures described above comprise in a preferred embodiment only a single reducing end. The single reducing end comprising molecules are preferred for, e.g., following reasons:

1. These are in general more natural structures than the structures of the present invention. Saccharide which comprises two or more reducing ends are certainly more unnatural as at least in mammals conjugates from other parts of carbohydrates than the reducing end are quite rare or non existing.

2. Single reducing end allows exact derivatization by detectable group or an affinity tag molecule. When each oligosaccharide comprises only one reducing end the mixtures of labelled oligosaccharides are more useful for quantitative experiments. Also presence of two tag molecules in linkage to single oligosaccharide or polysaccharide would complicate or prevent quantitative purification of single reducing end oligosaccharides.

3. Localisation of the derivatisation point exactly to reducing end allows to control the effect of the derivatization to the activity of the molecules in various assay systems, especially biological assay systems.

The present invention is especially directed to methods, substances and compositions when the products or isolated products comprises only single reducing end.

The single reducing-end oligosaccharides or polysaccharides are preferably produced from monosaccharides of groups A, B, and C or from oligosaccharide or polysaccharides not comprising hexuronic acids or sialic acids. Alternatively, all carbohydrates according to the present invention are used and process includes an additional step of removing of potential carboxylic acid mediated cross links. Methods to remove carboxylic acid derivatives have described in patents about polydextrose.

Production of Alcohol Derived Monosaccharides, Oligosaccharides and Polysaccharides

The present invention is in specific embodiment directed to the novel method to produce non-reducing monosaccharides, and/or oligosaccharides and/or polysaccharides using acid catalysis according to the Scheme 3:
SAC+polyol→SAC-polyol
wherein SAC is a non-protected reducing monosaccharide, oligosaccharide or polysaccharide or mixtures thereof. As a specific embodiment the present invention is directed to reactions of alcohols preferably polyalcohols with single carbohydrate, preferably the carbohydrate is selected from groups A-E, more preferably the carbohydrate is selected from the group of more bioactive monosaccharides or from other preferred carbohydrate groups described by the invention, more preferably the carbohydrate is an oligosaccharide or a polysaccharide.

The alcohol substance or substances such as polyol or monoalcohol substance or dialcohol substance, preferably polyalcohol substance and carbohydrate or carbohydrates are in a preferred embodiments used in relative amounts so that there is at least 20 mass procent and more preferably at least about 33 mass procent of the alcohol substance(s) from the total mass of alcohol substance(s) and carbohydrate(s) together. In more preferred embodiment the carbohydrate(s) and alcohol substance(s) are used in about same amounts of mass, and in even more preferably the alcohol substance, preferably polyacohol substance is used in about 20% excess, about 2 fold excess and about four fold excess in mass in comparision to the carbohydrates. In another embodiment alcohol substance(s) is used in molar excess compared to to the molar amount of reducing end monosaccharide residues of the carbohydrate used in the reaction. Polyalcohol substance can be used in about 20% molar excess, about 2-fold molar excess and about four-nine fold excess compared to the amount of carbohydrates. In a preferred embodiment most of or practically all of the products are in nonreducing SAC-polyol form. It is realized that under reaction conditions with high temperatures oligosaccharides and polysaccharides to be used may be degraded and rearranged.

The present invention is also directed to isolation of polyol linked oligosaccharide mixtures from reactions according to the invention. Preferably the polyol linked oligosaccharide in the mixtures comprise more than 50% in mass of oligosaccharides comprising an polyol at the reducing end and thus are non-reducing oligosaccharides. More preferably the polyol linked oligosaccharides in the mixtures comprise more than about 60% or 70% in mass of oligosaccharides comprising an polyol at the reducing end and in most preferred embodiments the polyol linked oligosaccharides in the mixtures comprise more than about 80% and even more preferably more than 95% of the mass of oligosaccharides. The present invention is also directed to isolation of the non-reducing oligosaccharides from the reducing oligosaccharides preferrably by the methods described by the invention.

Preferred Carbohydrates to be Used with Alcohol Substances

In preferred embodiments the present invention is directed to production of various alcohol conjugates, preferably polyalcohol conjugates of specific subclasses of carbohydrates described by the present invention.

Reactions of Monosaccharides with Alcohols

The present invention is directed to reactions of various monosaccharides, preferably from the groups A-E or from any other preferred monosaccharide groups described above, with alcohols. The present invention is specifically directed to production of oligosaccharide(s) or oligosaccharide fractions, preferably of preferred chain length(s) from single monosaccharides. In a specific embodiment the invention is directed to production of mixture of α-, and β-anomeric monosaccharide(s) linked to alcohol or alcohols. The present invention is also directed to isolation of the α- and β-anomeric monosaccharide alcohol conjugates and oligosaccharide conjugates derived from single monosaccharide type or at least two monosaccharides from the same group A-E or from a preferred subgroup of any of the groups A-E.

In a preferred embodiment of the present invention alcohol is conjugated with monosaccharide mixtures comprising both α- and β-anaomers of Glc, Gal, Man, Fuc, Rha, Ara, Xyl, GlcNAc, GalNAc, GlcA or GalA or NeuNAc more preferably conjugates of the specially bioactive monosaccharides Man, Fuc, Ara, GalNAc, GlcA or GalA or NeuNAc. In a preferred embodiment the alcohol in a monoalcohol substance comprising several secondary hydroxyl groups, another embodiment of the invention is directed to the production of mixtures of dialcohol(s) or polyalcohol(s) reacted with the monosaccharides. Most preferably the alcohol substance is xylitol, sorbitol, or mannitol. In a specific embodiment the alcohol conjugates are produced under the preferred conditions described in the invention and conjugates to primary hydroxyls are mainly formed and present in the products or isolated product fractions.

The present invention is specifically directed to mixtures and production of or production and isolation of mixtures comprising all non-reducing monosaccharide conjugates according to the Formula 5:
Mα/β1-1/xAlcohol,
wherein M is a monosaccharide residue selected from the group consisting of Gle, Gal, Man, Xyl, Fuc, Rha, GlcNAc, GalNAc and sialic acid, more preferred composition Gal, Man, Xyl, Fuc, Rha, GlcNAc, GalNAc and sialic acid and most preferably Fuc, GlcNAc, or GalNAc. With the provision that M is α- or β-linked to an alcohol substance comprising primary hydroxyl at carbon 1 and potentially another primary hydroxyl at carbon x, and with the provision that M is linked x or 1 when the alcohol comprises two primary hydroxyls and to 1 when the alcohol comprises one primary hydroxyl.

The present invention is especially directed to an essentially pure monosaccharide conjugate mixture consisting of all non-reducing monosaccharide conjugates according to the Formula 8
Mα/β1-1/xAlcohol
wherein M is a monosaccharide residue selected from the group consisting of Glc, Gal, Man, Xyl, Fuc, Rha, GlcNAc with the provision that M is α- or β-linked to position 1 or another hydroxyl (marked by x) of a polyalcohol substance preferrably xylitol, sorbitol, galactitol, or mannitol. The conjugate mixture optionally comprises also the polyalcohol in free form. The position x is preferably a primary hydroxyl of the polyalcohol substance.

The invention is also directed to a method to produce essentially pure composition according to formula 8 when the mixture is produced under condensing conditions according to the present invention and using an excess of polyalcohol and optionally isolating the monosaccharide conjugate from the polyalcohol excess after the reaction.

The alcohol substance is preferably selected from the preferred dialcohol or polyalcohol substances described above, more preferrably xylitol, sorbitol or mannitol, and most preferably xylitol or sorbitol.

The present invention is also specifically directed to separate substances according to Formula A1 of the invention when the monosaccharide residue is selected from the group consisting of: Gal, Man, Xyl, Ara, Fuc, Rha, GlcNAc, GalNAc and sialic acid, more preferably Fuc, Rha, GlcNAc, GalNAc and and sialic acid and most preferably when monosaccharide is selected from the group consisting of Fuc, GlcNAc, and GalNAc.

And the polyol is selected from the group comprising reduced monosaccharide derivatives of Gal, Man, Xyl, Ara, Fuc, Rha, GlcNAc, or GalNAc or is alcohol selected from the group glycerol or erythritol, more preferably the polyol is selected from the group comprising xylitol, sorbitol, galactitol or mannitol, and most preferably xylitol or sorbitol.

In a specific embodiment the present invention directed to the production of mixture comprising at least 50 mass % of isomaltose/trehalose type structures Glcβ1-6Glc-ol, Glcβ1-6Glc-ol, Glcα1-1Glc-ol, Glcβ1-1Glc-ol. More preferentially the mixture comprises at least 80% of the said structures and most preferably at least 90 mass % of the said structures. In a preferred embodiment the mixture of the four structures is essentially pure.

Alkyl Glycosides of Monosaccharides and Oligosaccharides

The present invention is also directed to the production of alkyl glycosides from reducing monosaccharides and alcohols, preferably monoalcohol substances, according to the present invention. Preferred reactions include reactions of monosaccharides A-E or preferred monosaccharides according to the present invention with alkyl alcohols selected from the group consisting of methanol, ethanol, propanol and butanol, more preferably with methanol or ethanol. The reaction conditions are preferrebly anhydrous or close anhydrous and hydrochloric acid is a preferred as catalysts. The present invention is especially directed to novel monosaccharides and anomeric mixtures of certain monosaccharide units according to the formula 6
(HexNAc)ᵣα/βO—R.
wherein r is an integer indicating number HexNAx residues in an oligosaccharide, prerably r is 1-10, more preferably 1-6 and most preferably 1-3. HexNAc is N-acetyl hexosamine, preferably GlcNAc, ManNAc or GalNAc. In preferred embodiments the present invention is directed to an isolated mixture of saccharides when r is 2, and when R is 3 and when r is 4.
Reactions of Oligosaccharides with Alcohols

The present invention is also directed to reactions of disaccharides and oligosaccharides with preferred alcohol substances according to the present invention.

Reactions of Polysaccharides with Alcohols

The present invention is also specifically directed to reactions of single polysaccharides with alcohol substances especially polyol substances. In a preferred embodiment a polysaccharide preferred by the invention is reacted with a preferred alcohol substance. More preferably the polysaccharide is selected from the group consisting of cellulose, glucan, starch, chitin, GalNAc-polysaccharide, fucan, galactan, or mannan, more preferably from the group starch and chitin. The polyol is selected from the group comprising reduced monosaccharide derivatives of Gal, Man, Xyl, Ara, Fuc, Rha, GlcNAc, or GalNAc or is alcohol selected from the group of glycerol or erythritol, more preferably the polyol is selected from the group comprising xylitol, sorbitol or mannitol, and most preferably xylitol or sorbitol.

In a specific embodiment the invention is directed for production of monosaccharide and oligosaccharide alcohol derivatives chosen from substartes chitin and/or starch reacted with xylitol, sorbitol and/or mannitol.

In a preferred embodiment the present invention is directed to reactions of starch with polyol, preferably xylitol, sorbitol or mannitol and more preferably xylitol or sorbitol and most preferably sorbitol. The present invention is especially directed to reactions at lower melting temperatures in the presence of an acid calyst, preferably hydrochloric acid. The reactions between starch and polyol can be directed to produce mainly monosaccharide conjugates such as Glcα/β1-6Glc-ol, and Glcα/β1-1Glc-ol, or in preferred embodiment oligosaccharide glycosides or even polysaccharide glycosides. The degree of oligomerization can be adjusted by the amount of polyol according to the present invention.

The present invention is also directed to production of alcohol glycosides from carbohydrates according to the invention when the alcohol is a primary alcohol. The present invention is especially directed to α- and β-glycoside mixtures produced from preferred monosaccharides by reversed hydrolysis. In a preferred embodiment, the method according to invention is for production any of the mixtures comprising Galα/β1-6Glc-ol, and Galα/β1-1Glc-ol; Manα/β1-6Glc-ol, and Manα/β/1-1Glc-ol; Xylα/β1-6Glc-ol, and Xylα/β1-1Glc-ol; GlcNAcα/β1-6Glc-ol, and GlcNAcα/β1-1 Glc-ol; GalNAcα/β1-6Glc-ol, and GalNAcα/β1-1Glc-ol and Galα/β1-5Xyl-ol, and Galcα/β1-1Xyl-ol; Manα/β1-5Xyl-ol, and Manα/β1-1Xyl-ol; Xylα/β1-5Xyl-ol, and Xylα/1-1Glc-ol; GlcNAcα/β1-5Xyl-ol and GlcNAcα/β1-1Xyl-ol; GalNAcα/β1-5Xyl-ol, and GalNAcα/β1-1Xyl-ol. The monosaccharides to be reacted are preferably seleced to one of the group of Gal, Man, Xyl, Ara, Fuc, Rha, GlcNAc, and GalNAc. The present invention is further directed to separated individual substances GlcNAcα/β1-6Glc-ol, and GlcNAcα/β1-1Glc-ol; GalNAcα/β1-6Glc-ol, and GalNAcα/β1-1Glc-ol; Galα/β1-5Xyl-ol, and Galα/β1-1Xyl-ol; Manα/β1-5Xyl-ol, and Manα/β/1-1Xyl-ol; Xylα/β1-5Xyl-ol, and Xylα/β1-1Glc-ol; GlcNAcα/β1-5Xyl-ol and GlcNAcα/β1-1Xyl-ol; GalNAcα/β1-5Xyl-ol, and GalNAcα/β1-1Xyl-ol.

As described by the present invention it is possible to produce oligosaccharides and glycocojugates and achieve potentially more bioactive carbohydrate structures. For example, the monosaccharide conjugates are useful monosacharide analog for various microbiological and other therapheutic applications. When a polyol is used its hydroxyl groups may mimick neighboring carbohydrate in the natural chain. Moreover in comparison to reducing monosaccharides which are in solution mixtures of alpha- and beta anomers and open chain form, the stabilily alpha and/or beta anomeric saccharide glycosides are more closely natural structures and thus more useful. The reducing monosaccharides also tend to form glycation products such as Schiff bases with proteins which are considered potentially harmfull. The present invention is further directed to isolation or enrichment of corresponding alpha- and beta anomeric glycosides.

Special Methods

Reactions of Protected, Partially Protected and/or Activated Saccharides

As a separate embodiment the present invention is also directed to the use of at least one protected or partially protected or activated monosaccharides or oligossaccharide under conditions described by the invention.

Reactions of Methyl Glyosides

The present invention is directed to reaction mixtures comprising at least one methylglycoside, preferably at least one monosacharide for the methylglycoside is selected from the groups A-E or any other subgroup according to the present invention. When methyl glycosides are reacted with each other, lower melting temperatures are preferred for release of methyls and creating glycosidic linkages.

In separate embodiment the present invention is directed to reaction between a methyl protected monosaccharide and a reducing monosacharide residue(s), In separate embodiment the present invention is directed to the use of an excess of the reducing monosaccharide in comparison to the methyl glycoside. The present invention is specifically directed to the reaction conditions under which most of the methyl glycoside preserves its structure, preferably the reaction are incubated at temperature of about 50 degree of Celsius or at temperatures between about 45-55 degrees of Celsius, other temperatures at ranges of lower non-melting temperatures are also preferred. It is preferred to use methyl glycoside under conditions in which it is not hydrolysed when production of less random oligosaccharides are aimed. The methyl glycoside forms a precursor to which the reducing monosaccharide or donor monosaccharide is attached. The methyl glycoside is located to reducing end of the saccharides formed. Preferred combinations of any two or more monosaccharide according to the present invention are preferred for monosaccharide glycoside conjugates.

Reactions of Protected, Partially Protected and/or Activated Saccharides

As a separate embodiment the present invention is also directed to the use of at least one protected or partially protected or activated monosaccharides or oligosaccharides under conditions described in the invention. It is realized that the condensation reaction conditions can be used for synthesis of more specific carbohydrate structures. The synthesis of more specific structures or mixtures/fractions or libraries comprising more specific kind of oligosaccharides can be achieved by introducing protecting groups to reactions. Preferably, the protecting groups are partially or totally stable under the conditions described. Under another embodiment the specific isomer conjugates are formed early in a reaction and at least part of the protecting groups are removed by heat and catalyst. Preferred more stable protecting groups include ether groups preferably methyl ether, other ether can be used as well, benzyl ethers are also preferred as these can be removed by specific reduction methods known in the art. The present invention is also directed to the use of acetyl groups for directing reactions according to the present invention, partially or peracetylated carbohydrates may be used in reactions described by the present invention. The present invention is also directed to the use of even less stable groups for partial direction of reactions and/or for directing the more stable protecting groups to desired positions.

Reactions of Ether Glycosides Including Methyl Glycosides

The present invention is directed to the use of at least one ether protected carbohydrate, preferably a monosaccharide or an oligosaccharide in condensation reactions according to the present invention. More preferably the ether protecting group is located on the reducing end of the carbohydrate and it forms a glycoside with the carbohydrate to be used in condensation reactions according to the present invention. The invention is also directed to the use of an ether glycoside as the only protecting group in the reactions described by the invention. More preferably the ether protecting group is a methyl ether of the carbohydrate, other preferred ethers include other alkyl ethers containing 2-8, more preferably 24 carbon atoms, and aromatic ethers, especially benzyl ethers are preferred. The present invention is specifically directed to the condensation reactions of at least one ether glycoside carbohydrate, preferably a monosaccharide ether glycoside, with at least one carbohydrate, preferably a monosaccharide, comprising free non-modified reducing end position (the other carbohydrate is not a glycoside). More preferably at least one ether glycoside is reacted with one reducing non-protected carbohydrate which is preferably a monosaccharide. As a separate embodiment the present invention is directed to the use of other reducing end protecting groups partially or totally stable under the conditions described by the invention, another preferred group of other reducing end protecting groups is glycosyl amides.

The present invention is directed to reaction mixtures corn prising at least one methylglycoside, preferably at least one monosaccharide for the methylglycoside is selected from the groups A-E or any other monosaccharide subgroup according to the present invention. When methyl glycosides are reacted with each other, lower melting temperatures are preferred for partial release of methyls and creating glycosidic linkages.

In a separate embodiment the present invention is directed to the reaction between a methyl protected monosaccharide, preferably a methyl glycoside and at least one reducing monosaccharide residue. The reducing monosaccharide is preferably selected from the groups A-E or any other preferred subgroup of monosaccharides according to the present invention. More preferably the invention is directed to the use of an excess of the reducing monosaccharide compared to the methyl glycoside. The present invention is specifically directed to the reaction conditions under which most of the methyl glycoside preserves its structure, preferably the reaction are incubated at temperature of about 50 degree of Celsius or at temperatures between about 45-55 degrees of Celsius, and under temperatures from room temperature to about 45 degrees of Celsius, other temperatures at ranges of lower non-melting temperatures are also preferred. It is preferred to use methyl glycoside under conditions in which it is not hydrolysed when production of less random oligosaccharides are aimed at. The methyl glycoside forms a precursor to which the reducing monosaccharide or donor monosaccharide is attached. The methyl glycoside is located to reducing end of the saccharides formed. Combinations of any two or more monosaccharides according to the present invention are preferred for monosaccharide glycoside conjugates.

General reaction between monosaccharide glycoside M1, which can be either α- or β-linked (or mixture of both) to ether protecting group with reducing monosaccharide M2, under conditions preserving M1-glycoside:
M1α/β1-OR+M2→(M2)ₙ(M1α/β1-OR)ₘ
wherein n is an integer, for oligosaccharides from 1 to 10 and for polysaccharides n>10, integer m is either 0 or 1. Preferably, mostly oligosaccharides from disaccharides to hexasaccharides and more preferably from disaccharides to tetrasaccharides are formed and the product saccharide mixture comprises monosaccharide residues M2 which are glycosidically linked to each M2 residue and monosaccharide residues M2 which are glycosidically linked to M1α/β1-OR, wherein —OR is an ether glycosidically linked to M1, preferably OR is a methyl ether.

The present invention is also directed to reactions in which part of the glycoside M1 is hydrolysed and M2-oligomers are also formed. Such reactions occur more effectively at about 80 degrees of Celsius and higher temperatures with methyl glycosides of hexoses, it is noted that stabilities of glycosides vary, and reactions preserving glycosides of sialic acids and 6-deoxyhexoses are difficult.

The present invention is also directed to the oligosaccharide composition and subfractions thereof produced in reactions between a reducing end protected monosaccharide, preferably a methyl glycoside, and a reducing non-protected monosaccharide according to Formula 7
(M2)ₙ(M1α/β1-OR)ₘ
wherein n is an integer from 1 to 10, preferably 1-6 and more preferably from 2 to 4 and m is either an integer having values 0 and 1, and the saccharide mixture comprises monosaccharide residues M2 which are glycosidically linked to M2 residue and monosaccharide residues M2 which are glycosidically linked to M1α/β1-OR, wherein OR is an ether glycosidically linked to M1, preferably OR is a methyl ether. More preferably invention is directed to the subfractions comprising trisaccharides, tetra saccharides or pentasaccharides.

The present invention is also directed to the compositions according to the Formula 7, when the compositions have the mass spectrum of the composition according to the present invention. More preferably the composition shows NMR spectrum of α- and α-anomeric glycosides of M2, most preferably multiple α- and β-anomeric glycosides of M2.

Reactions of Partially Protected Carbohydrates

As a specific embodiment the present invention is directed to the reaction of partially protected monosaccharides under condensation conditions as described by the present invention. The partially protected monosaccharide indicates here a monosacharide derivative comprising protecting groups on part of the hydroxyl groups. The alcohol glycosides described above can be considered as carbohydrates protected to the reducing end. The present invention is specifically directed to the several combinations of protecting groups on a partially protected monosaccharide residue, primary hydroxyl applies only to monosaccharides containing a primary alcohol group:
1. the secondary hydroxyl groups groups are protected, but the primary hydroxyl group and anomeric hydroxyl group is non-protected.
2. only the primary hydroxyl goup and anomeric hydroxyl group of a monosaccharide residue are protected.
3. only the primary hydroxyl goup of a monosaccharide residue is protected
4. All non-anomeric hydroxyl groups are protected and anomeric hydroxyl group is non-protected
5. only the anomeric hydroxyl group of a monosaccharide residue is protected

Monosaccharides here can be selected from groups A-E according to the present invention, more preferably from groups B-E or A-D or other preferred monosaccharide groups according to the invention.

Present invention is especially directed to the self condensations of a partially protected monosaccharides. In a preferred embodiment a hexose monosaccharide derivative comprising protected secondary, non-anomeric (on carbon 1) hydroxyl groups and a non-protected 6 hydroxyl group is condensed with non-protected anomeric position of similar monosaccharide to form a polysaccharide or more preferably an oligosaccharide. Preferably the reaction is performed under acid and/or metal catalysis as described by the present invention. The present invention is especially directed to reactions of at least one partially protected monosaccharide with at least one non-protected monosaccharide. The present invention is especially directed to the condensation of an aldohexose protected to secondary hydroxyl groups and/or to anomeric position with a monosaccharide selected from groups A-E, more preferably from groups B-E. More preferably galactose or mannose or glucose or a N-acetyl hexosamine, preferably GlcNAc, GalNAc or ManNAc protected to 2-,3-, and 4-hydroxyl positions is reacted with a reducing non-protected monosaccharide. The invention is specifically directed to the use of an excess of the reducing non-protected monosaccharide.

In the prior art aiming at specific glycosidation the donor monosaccharide is usually activated by chemical derivatives. According to the present invention, it is possible to achieve glycosidation reactions with non-protected or partially protected monosaccharides with a non-modified C1-position. In a preferred embodiment the C2 position of a reducing partially protected monosaccharide to be reacted according to the presend invention is acetylated or acylated or comprises an ester linked residue which activates glycosidation reactions according to the present invention. The present invention is also directed to the production of specific oligosaccharides or mixtures of few oligosaccharides useful for biological studies and applications by using less reaction steps as described by the prior art. The present invention is also directed to the effective separation of the carbohydrates produced.

Reactions of Protected and Activated Carbohydrates Under Specific Conditions

Furthermore, the present invention is directed to the condensation reactions by heat and chemical catalyst according to the present invention when monosaccharide or oligosaccharide halides, preferably protected monosaccharide or oligosaccharide halides, are self-condensed, more preferably the protected monosaccharide halides are peracetylated monosaccharide fluorides. In another embodiment non-protected reducing monosaccharides or other non-protected carbohydrates are reacted with peracetylated monosaccharide halogenides, preferably fluorides or bromides, or peracetylated oligosaccharide halides, preferably fluorides or bromides. A preferred oligosaccharide halogenide is peracetylated lactosylhalide, preferably lactosylfluoride.

Self-Condensation of Activated Monosaccharides and Oligosaccharides

As a specific embodiment the present invention is directed to the production of oligomers of monosaccharides and oligosaccharides, preferably galactose and lactose, using specific protection strategies and specific reaction conditions. The present invention is especially directed to the synthesis of oligo- and polymeric lactose glycosides. The self-condensation methods described below use preferably traditional or aqueous solvents used in organic chemistry, the temperatures of the reactions depend on the useful temperatures for various activating groups.

Under the specific self-condensation reaction carbohydrate molecules are activated at their anomeric positions, preferably as halogenides or imidates, other activating groups include groups such as oxazolines attached to C-1 of the saccharide molecule. These activating groups form a reactive intermediate under acidic conditions e.g. when they are susceptible to Lewis acids, thus allowing glycosidation reactions to proceed. Other functional groups of the molecule are fully protected or inactive under the acidic conditions, except the acceptor hydroxyl group that is protected with a silyl ether protective group. The silyl ether group can be replaced with other acid labile protective group, e.g. tricloroacetyl group. The protection pattern of the molecule can be altered in order to obtain different reactive sites. The stable protective groups useful for protecting hydroxyl groups aimed to be not glycosylated can be protected by regular protecting groups stable under the glycosidation and and leaving group releasing conditions, numerous of such groups for the reaction conditions have been published, a preferred example of protecting group is an acetyl group.

Several Lewis acid catalysts known in the art can be used. The present invention is especially directed to the use of scandium-ions, preferably as scandium triflate as catalyst of glycosidation reactions. The scandium catalyst is especially preferred for reactions according to the present invention.

Stereochemical outcome of the reaction can be affected by selecting an appropriate substituent next to the activating group. Thus, e.g. ester protective groups in C-2 favor β-glycoside formation via participitating protective group mechanism. Self-condensation occurs together with the acceptor site deprotection, allowing one pot reactions to produce different condensated chemoselective products.

Alternatively, the saccharide molecule can be activated at its anomeric position by a halogenide and all other hydroxyl groups are unprotected. Self-condensation of this type occurs under acidic conditions e.g., by a Lewis acid activation of the anomeric position followed by self-condensation. When there are several free hydroxyl groups in the molecule, reactivity order follows the ones presented in the literature, thus primary hydroxyl groups are substantially more reactive than other hydroxyl groups. The reactivity order is, however, case-dependent. The invention is especially directed to the oligomerization or polymerization of monosaccharides according to the invention and any preferred monosaccharides according to the invention and disaccharide lactose and lactose derivatives in random manner. Preferred halogenides include iodides, fluorides and bromides, more preferably fluorides and bromides.

The principle of self-condensation is demonstrated with small and simple carbohydrate derivatives. This invention, however can be applied to all suitable activated saccharides, e.g. lactosamine derivatives. By the choice of protective group strategies it is possible to obtain linear branched or cyclic oligosaccharides. Condensation rate depends, however, on various factors e.g. the size of the molecules.

Unnatural glycosidic bonds can be formed by means described in the literature. Thus, e.g. thiooligosaccharides can be obtained under appropriate thioglycosidation conditions. End-products can be de-protected by standard means. Activating groups are in the case of halogenides and imidates converted to hydroxyl groups via aqueos or alkaline treatment. If products with specific degree of polymerization are wanted, specific oligosaccharide fractions can be isolated from the product mixture by chromatography and other means known for oligosaccharide purification or isolation. This methods is useful for production of various carbohydrates containing products including medicaments, cosmetic ingredients, food additives or functional food ingredients.

The present invention is specifically directed to the following methods: A method for self-condensation of fully or partially deprotected saccharides comprising at least one hydroxyl group which is protected by an acid labile leaving group and an activating group at anomeric position which is a common saccharide activating group and the saccharide is polymerised by reacting the anomeric position with the O-atom protected by the leaving group. The activating group at the anomeric position is a common saccharide activating group, preferably a halogenide or imidate, more preferably a halogenide. Also other suitable activating groups can be used. The leaving group is preferably an acid labile leaving group, more preferably a silyl group or a tricloroacetyl group, and most preferably a silyl group. The reactions are preferably catalysed by a lewis acid which activates the activating group, more preferably the catalyst used also releases the leaving group. The present invention is also directed to the one pot condensation methods in which the leaving group is first removed by suitable deprotecting agent such as an acid and then the activating anomeric position is reacted with the free hydroxyl group. The acid and leaving group are selected so that these do not prevent the self-condensing glycosidation reaction.

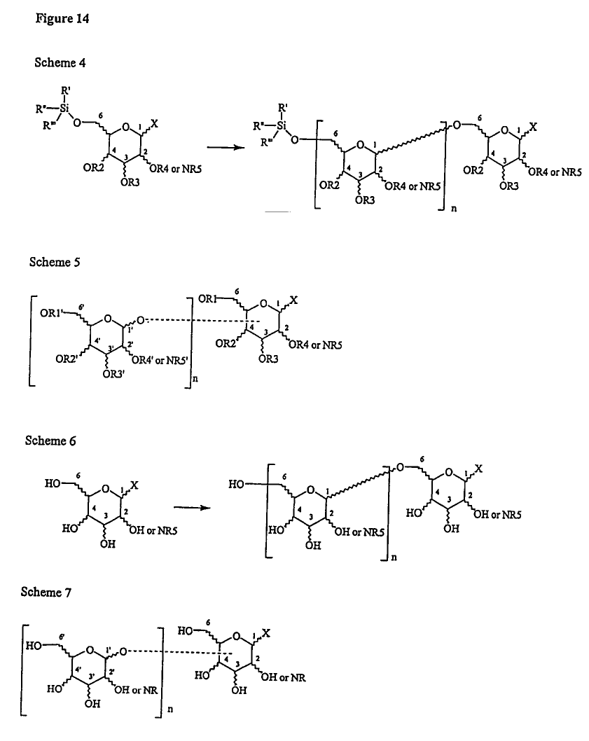

The invention is specifically directed to the reactions indicated by Schemes 4-7 in FIG. 14. Oligosaccharides indicated by the Schemes can be produced from protected and activated carbohydrates or the same products preferably in protected form can be obtained by other methods described by the present invention. Schemes 4 and 5 indicate the reactions of protected and activated monosaccharides and Schemes 6 and 7 indicate reactions of non-protected saccharides. When the general methods according to the invention are used the C1-position of the saccharides are not protected (not X but —OH).

The present invention and the method using protected and activated carbohydrates is specifically directed to the production of polymeric or oligomeric saccharides of groups A-E, more preferably oligomers. In a preferred embodiment 1-6linked oligomers of hexoses and 1-5-linked oligomers of pentoses are synthesised. A preferred product is β1-6linked galactoside.

The present invention is also directed to oligomeric and polymeric lactosides. In a specific embodiment the lactoside oligomer may comprise glucose and/or galactose residues released during the synthesis. The invention is preferably directed to oligomeric separate lactoside substances comprising 2-10 lactoside residues linked to each other, more preferred lactosides comprise 3, 4, 5, 6, or 7 lactoside residues linked to each other. The invention is directed to the production of randomly linked lactosides and lactose structures linked to specific positions in forming polymers or oligomers.

In a specific embodiment the present invention is directed to lactosides linked to each other by specific linkages such as β1-3′ and β1-6′ forming linear substances Galβ1-4Glcβ1-3Galβ-4Glc or oligomers or polymers Galβ1-4Glc[β1-3Galβ1-4Glc]ₙ and Gal, 1-4Glcβ1-6Galβ-4Glc or oligomers or polymers Galβ1-4Glc[β1-6Galβ-4Glc]ₙ, and an oligomeric lactoside substance comprising at least 2 lactosyl residues. The invention is further directed to branched or linear substances comprising both β1-3′ and β1-6′-linkages. The branched substance comprises epitope Galβ1-4Glcβ1-3(Galβ1-4Glcβ1-6)Galβ-4Glc which may be elongated from reducing end or non-reducing end residues. Specific protection schemes for producing 3′- and/or 6′-non-protected lactosides are known in the art. It is realized that the preferred lactosides can also be synthesized as specific oligomers using regular srategies known for oligosaccharides and for polylactosamine-type structures especially.

The present invention is also directed to a specific disaccharide lactoside wherein the glucose residues are 1-1-inked. Preferably, the 1-1-dilactosidese is linked by two β-linkages forming Galβ1-4[Galβ1-4Glcβ]Glcβ. In another preferred embodiment the dilactoside substance comprises mixtures of α- and β-linkages between the glucose residues. In another preferred embodiment the dilactoside has two alpha linkages between the glucose residues.

The present invention is also directed to the one pot synthesis of 1-1-linked oligosaccharides from peracetylated or totally protected oligosaccharides activated to reducing end C1-positions, preferably activated as halogenides. The method is directed to the use of water in reaction mixtures in amount enough to hydrolyse about half of the activating group to hydroxyl groups and allowing the halogenide activated disaccharide to react with the C1-hydroxyl lactoses.

The present invention is preferably directed to the polymerisation of linear and branched lactosides and isolating desired sized fractions of the products, if needed. The products resemble natural polylactosaminens which have reported to be exellent in representation of bioactive oligosaccharide epitopes. In a preferred embodiment the lactosides are used as acceptors for glycosyltransferase modifying lactose and/lactosamines. Preferred derivatives of the lactosides include α3-sialylated; α6-sialylated, disialylated, suphated, sialylated and/or sulphated and α3-fucosylated; α3-fucosylated, α2-fucosylated, Lexis y-derivatives, blood group A and B-derivatives, GalNAcβ3Galα4-derivatives, Galα4-derivatives, GalNAcβ4-derivatives, Galβ3GalNAcβ4-derivatives, GlcNAcβ3-derivatives, Galβ3GlcNAcβ3 and/or 6-derivatives, and Galβ4GlcNAcβ3 and/or 6-derivatives.

The present invention is directed to methods to produce reducing end alcohol derivatives from single or more carbohydrates by the preferred methods according to the invention. The present invention is preferentially directed for the production of carbohydrates from different preferred groups of alcohols or alcohol substances according to the present invention.

The prior art has already described production of polydextroses comprising minor amounts of polyalcohols such as sorbitol. The polydextroses produced by such methods were reducing and specific patent has been filed for reduction of the reducing end of polydextroses. The present invention is directed to uses of larger amounts of alcohols especially polyalcohols such as sorbitol, xylitol, erythritol or glycerol, preferably sorbitol or xylitol. Preferably the polyalcohol (or polyol by another name) is used in so large amounts that all the oligosaccharides formed comprise a polyol at the reducing end. In the prior art the polyols may have been used wiyhout clear idea about their reactivities. The structural characterization work of the present invention indicated that the polyols function as acceptors substrates of glycosidation reactions. It is realized that the primary hydroxyls of a polyol-chain are most reactive, therefore under the preferred conditions according to the present invention one or two saccharides or monosaccharides can be glycosidically linked to a single polyol molecule. Present invention is especially directed to three methods for production non-reducing saccharide and monosaccharide conjugates.

1. Single step production of saccharide polyol or monosaccharide polyol: Reducing monosaccharide or oligosaccharide is incubated with catalyst, preferably with acid under preferred conditions according to the invention, with molar excess of polyol.

The present invention is especially directed to substances SACα1polyol, SACβ1 polyol, SACα6 polyol, SACβ6 polyol wherein SAC is monosaccharide or oligosaccharide. Preferrably monosaccharide is selected from the group:
A. aldomonosaccharides, preferably pentoses or hexoses;
B. deoxymonosaccharides especially 6-deoxymonosaccharides such as fucose or rhamnose;
C. N-acetylhexosamines, preferably regular N-acetylhexosamines such as GalNAc and GlcNAc;
D. sialic acids, such as N-acetylneuraminic acids; or
E. hexuronic acids, such as galacturonic and glucuronic acids

In a preferred embodiment reducing monosaccharide is used as substrate and SAC-polyol product comprises about 80% of monosaccharide and more preferably 90% of monosaccharide conjugate. Preferred products also includes SACα/β6polyol1α/βSAC such product is more effectively formed under conditions 3 below. The present invention is specifically directed to production analogs of reduced disaccharides such as isomaltitol, reduced nigerose Glcβ6Glcol, maltitol, lactitol, and Glcβ4Glcol. Preferred reduced disaccharides includes Hexα/β1/6sorbitol and Hexα/β1/5xylitol, wherein Hex is hexos. Preferred products according to the present invention include: Glcβ6sorbitol, Glcα6sorbitol, Glcβ1sorbitol, Glcα1sorbitol; Galβ6sorbitol, Galα6sorbitol, Galβ1sorbitol, Galα1sorbitol; Manβ6sorbitol, Manα6sorbitol, Manβ1sorbitol, Manα1sorbitol, and Glcβ5xylitol, Glcα1xylitol, Glcβ1xylitol, Glcα1xylitol; Galα5xylitol, Galα5xylitol, Galβ1xylitol, Galα1xylitol; Manβ5xylitol, Manα5xylitol, Manβ1xylitol, Manα1xylitol.

Above products are preferred as isolated reaction products from reactions according to the present invention. The products are also preferred as compositions of four different monosaccharide units comprising glycosides.

2. Producing Saccharide and Adding Polyol in Excess.

Present invention is also directed to two step acid catalysed oligomerization or polymerisation of a reducing monosaccharide or oligosaccharide, preferably under reactions conditions according to the invention. In the first step the monosaccharide and/or oligosaccharide is polymerised and/or oligomerized, then poly is added in excess to amount of free reducing end of the oligosaccharide and/or polysaccharide. The method may be continious so that in the oligomerization and/or polymerisation is performed in first part of the reaction chamber or vessel which mixes the reducing monosaccharide with catalyst, preferably acid catalyst according to the present invention, and adding mixing the product with the polyol occurs in the second part of the reactions vessels. The reaction chamber may comprise conveyor for transport of the molecules in the reaction chamber or vessel.

3. Purifying oligosaccharide or monosaccharide polyol from reaction 1 and adding reducing monosaccharide. This method is especially aimed for production branched di or oligosacharides of the type SACα/β6polyol1α/βSAC form products comprising only one SAC/polyol describe above in 1. Single step production of saccharide polyol or monosaccharide polyol. In a preferred embodiment the polyol-SAC conjugate is first isolated or purified and the reacted with reducing monosacharide. In another embodiment the process is continuous so that the polyol-SAC is produced in the first part of reaction chamber/vessel and then the product is transported to the second part of the reaction chamber or vessel in which the reducing monosaccharide is produced. This process produces branched divalent monosaccharide conjugates and elongated monovalent polyol-conjugates which can be separated by chromatography if needed. In a separate embodiment the added reducing monosaccharide or oligosaccharide is different from the first monosaccharide or oligosaccharide linked to the polyol.

Reducing End Derivatives of Reducing Oligosaccharide Mixtures

The present invention is also directed to a further derivatization reaction of polydextrose type reducing oligosaccharide mixtures with lipids to form novel types of lipid compositions.
OS+Y→OS—X—Y
wherein OS is the reducing oligosaccharide mixture of polydextrose type or novel carbohydrate produced by the present invention. X is linkage or optionally spacer between the OS and the Y group, the linkage atom may be oxygen, nitrogen, sulphur, or carbon (O-linkage, N-linkage, S-linkage or C-linkage). The linkage may be formed by reductive amination so that the reducing end monosaccharide forms an open chain spacer between Y and rest of OS. Y is a group functionalising oligosaccharide including lipids, solid phases such as resins; soluble polyvalent carrier molecules for example including polysaccharides, peptides, and polyaminoacids, or a label molecule including UV-absorbing label molecules and more preferably fluorecent label.

In a preferred embodiment an UV-absorbing aminooxy-substance is linked to the reducing end of the OS. A preferred aminooxy substance is aminooxy acetic acid.

Special Glycolipid/Detergents Produced by Coupling Reducing Oligosaccharide to Lipids

Prior includes numerous single molecule detergents comprising glucose, for example octyl-glucoside detergent. In a preferred embodiment an oligosaccharide mixture, preferably produced by the method according to the present invention, is coupled to a hydrophobic molecule. Preferably the hydrophobic molecyle comprises an alkyl chain at leas 4 carbon atoms long, in more preferred embodiment the hydrocarbon chain is at least 6 and 8 carbon long and in most preferred embodiment the alkyl chain is at least 12 carbon atoms long. In a preferred embodiment the fatty acid chain is belongs to or is derived from common fatty acids for example palmitate, stearate or oleate. In a separate embodiment the oligosaccharide mixture, preferably produced according to the present invention, is coupled to a mixture of aglycons preferably to mixture of alkyl chain comprising substances. In a specific embodiment the a glycon is a two alkyl chain comprising hydrophobic molecule such as a ceramide or a glycerol or glycerate esterified with two fatty acids or a plamallogen molecule comprising ether bond between alkyl chain and glycerol or an anlog of these for example an lipopeptide analog of these. Glucose derived detergents such as octylglycoside are know. The present invention is directed to a mixture detergent which comprises variation of the size of the hydrophilic group and optionally also in the hydrophobic groups. Detergent is useful for solubilizing complex dirt or stain from a surface to be cleaned by using the detergent. Such detergent is useful for solubilizing effectively complex biological materials such as membranes. The detergent is therefore also useful for solubilization of samples used in biochemical or cell biological studies, especially for studies of membrane proteins. The biological and/or biochemical and/or cell biological uses also include uses in studies and modification of cellular membranes.

For production of anionic detergent or lipid like molecule, or other oligosaccharide or polysaccharide conjugates with aniocnic group the oligosaccharide mixture according to the present invention the oligosaccharide chaim may be chemically sulphated. The sulphation may performed to level to obtain 1-2 sulphate residues per oligosaccharide chain or more more depending on the application. Specific sulphation to 6-hydroxyl group to one monosaccharide, which is most probably non-reducing terminal monosaccharide residue, can be performed. Alternatively the saccharide chain can be N-sulphated, if it contains a free amine group which can be produced for example from N-acetyl-group of an N-acetyl hexosamine. Anionic saccharides can be also produced by oxidation of free 6-carbon groups of monosaccharides to carboxylic acid groups, for example by TEMPO-catalysed reactions. To produce a cationic group the amine monosaccharide may be included, alternatively Acetamido-groups of monosaccharide residues in saccharide can be derived to amines by deacetylation reactions.

The mixture detergents according to the present invention have for example following benefits: the varying size of the hydrophilic part allows effective interactions with varying sizes hydrophilic regions on a biomolecule and the varying bonds between the monosaccharide residues creates also varying shapes of hydrophilic surfaces for effective interaction with various forms of hydrophilic surfaces. These effects could be fortified by varying sizes of hydrophobic groups.

It is realized that such detergent could be produced from numerous biological or synthetic material comprising a mixture of hydrophilic molecules with one or more hydrophilic molecules as described above. The oligosaccharide based materials according to the present invention It is also realized that such detergent could be produced from natural oligosaccharide mixtures such as starch oligosaccharides, chitin oligosaccharides, pectin oligosaccharides, chondroitin oligosaccharides. The hydrophilic molecules can be also coupled to other functional groups of an oligosaccharide chain such amine groups of hexosamine monosaccharide residuess which can be produced from N-acetylhexosamine monosaccharide residues.

Similar Uses of Reduced Cello-Oligosaccharides

As a separate embodiment the present invention is also directed to use of reduced cellulose oligosaccharides such as reduced cellobiose (cellobiotol) Glcβ4Glcol, reduced cellotriose Glcβ4Glcβ4Glcol, reduced cellotetraose GlcGlcβ4Glcβ4Glcol, reduced cellopentaose Glcβ4GlcGlcβ4Glcβ4Glcol and reduced cellohexaose Glcβ4Glcβ4GlcGlcβ4Glcβ4Glcol as food additives, bulking agents and parts of pharmaceutical, food or beverage compositions. Cellulose is the most common carbohydrate on earth. The oligosaccharides can be produced by chemical and/or enzymatic hydrolysis by methods known in the art. In a preferred embodiment cellobiose is produced by cellobiose releasing enzyme. The reduction of the reducing end glucose residue can be performed by chemical reducing agents or by using H₂-gas and a catalyst. The specific embodiment is especially directed to compositions comprising mictures of reduced cellulose oligosaccharides for use as food additives, bulking agents and parts of food compositions. The present invention is especially directed to compositions comprising more than 80 mass % of carbohydrates as reduced cellobiose, reduced cellotriose and reduced cellotetraose, more preferably more than 80 mass % of reduced cellobiose, and reduced cellotriose. Most preferably the substance to be used as food additive, bulking agent and part of pharmaceutical, food or beverage compositions is reduced cellobiose or composition comprising at least 80% reduced cellobiose.

About Preferred Saccharides and Saccharide Sets

Oligosaccharides according to the invention are oligomers of monosaccharide residues or monosaccharide units from disaccharides to decasaccharides unless otherwise defined for a preferred embodiment. Polysaccharides are larger than decasaccharides. An oligosaccharide composition may further comprise some polymers or monosaccharides as defined for the purity of the compositions or fractions. A polysaccharide composition may further comprise some oligomers or monosaccharides as defined for the purity of the compositions or fractions. The present invention is further directed to “saccharide” compositions which comprise both oligosaccharides and polysaccharides and which may further comprise monosacharides as defined for the purity of the compositions or fractions. In a preferred embodiment the present invention is further directed to “saccharide” compositions which contain both oligosaccharides and polysaccharides. In a preferred embodiment the present invention is further directed to compositions which contain both oligosaccharides and low molecular weight polysaccharides. The oligosaccharides and low molecular weight polysaccharides are preferred for biological studies including various methods of screening saccharide libraries because of their generally good solubility in aqueous solutions and usefulness for screening for bioactive epitopes of about oligosaccharide size or for small oligomers of such epitopes as low molecular weight polysaccharides. The present invention is further directed to the use of oligosaccharides and low molecular weight polysaccharides in combination to determine the effective length of saccharide in biological studies including various methods of screening saccharide libraries.

The combined use of oligosaccharides and low molecular weight polysaccharides is further directed to the use of “saccharide sets” meaning use of at least two, more preferably at least three and even more preferably at least four or at least five saccharide fractions with similar compositions, preferably the fractions in the set are from similar synthesis reactions or in other embodiment from the same synthesis reaction after fractionating the reaction products preferably according to size or solubility. Preferably, the invention is further directed to the use of sets comprising 2-30 saccharide fractions, in separate embodiments 5-20 saccharide fractions and about 10 saccharide fractions.

In a preferred embodiment one or several saccharide fractions in a set is/are pure or essentially pure fraction(s) of single degree of polymerisation including oligomerization for oligomer containing fraction(s). In a preferred embodiment the set comprises, or more preferably contains, only fractions containing pure or essentially pure fraction(s) of single degree of polymerisation. The saccharides at specific degree of polymerisation are also referred as saccharide length component. The similar composition of the fractions in sets is useful for determining the biological or other activities or useful properties of the fractions. In a preferred embodiment the fractions in set are used in similar mass or more preferably molar amounts of total saccharides for the determining of biolological or other activities or useful properties.

In a preferred embodiment the fractions in a set are present, or are used, in similar mass or more preferably molar amounts, more preferably the fractions in set are used in similar mass or more preferably molar amounts of saccharide length components, preferably for the determining of biolological or other activities or useful properties. The similar amounts of saccharide fractions or length components preferably means that the difference of amounts is less than 10-fold, more preferably less than 5-fold, more preferably within 30%, even more preferably within 20% and most preferably within 10%. The invention is further directed to precise sets with the differences of amounts within 5% and more preferably within 3% and most preferably within 1%. Preferably fractionating of the oligosaccharides may occur according to size using size exclusion chromatography or according to solubility by precipitating oligosaccharides by the methods known in the art. The saccharide sets include preferably one or several preferred oligosaccharide fractions according to the invention, preferably with different sizes and one or several preferred low molecular weight polysaccharide fractions according to the invention, preferably with different sizes of the major saccharide length components in fractions covering the degree of polymerisation from disaccharides to about 35-meric low molecular weight polysaccharide, in preferred embodiments from disaccharides to about 15-meric low molecular weight polysaccharide and more preferably to about 20-meric low molecular weight polysaccharide or to about 25-meric.

The invention is further directed to the saccharide sets as preferred combinations of compositions. The invention is directed in a preferred embodiment to sets comprising mixtures of fractions as compositions called here “mixture sets”. In a preferred embodiment the mixture set covers by major saccharide length components a range of different oligosaccharides and/or low molecular weight polysaccharides. The mixture sets are useful as these cover by major components wider molecular weight range than the fractions or compositions from single synthesis. In a preferred embodiment the present invention is directed to mixture sets containing fractions of pure or essentially pure single length components. In a preferred embodiment the mixture sets of single length components covers all oligosaccharide lengths from disaccharides to decasaccharides and/or all preferred oligosaccharide lengths (also referred as sizes) according to the invention and/or all low molecular weight polysaccharide lengths from 11-mer to 35 and/or the preferred length ranges (degrees of polymerisation) of low molecular weight polysaccharides according to the invention.

The major saccharide length component means saccharides at specific degree of polymerisation comprising at least 5%, more preferably 10%, even more preferably at least about 15% and most preferably at least 20% of the all saccharides in the specific saccharide fraction. Preferred saccharide fractions or mixtures or compositions also include fractions containing both oligosaccharides and low molecular weight polysaccharides, in a preferred embodiment of the invention the average degree of polymerisation in fractions is from 6 monosaccharide unit containing saccharides to 14-meric saccharides, more preferably from about 7-meric to 13-meric or from 8-meric to 12-meric and most preferably from 9-11-meric saccharides or saccharides of average degree of polymerisation of about 10 (more precisely from 9.5 to 10.5). When average degrees of polymerisation are given by integers this preferably includes similar average chain lenght which can be rounded to the integer, like degrees of polymerisation from half monomer more or less.

Saccharide Set from Similar and Different Synthesis

For testing of biological activities, for example, the saccharide fractions in a set or mixture set from similar synthesis are most useful. A saccharide set comprising similar saccharide fractions is called here a homogenous saccharide set. Homogenous saccharide sets and saccharide mixture sets are used according to the invention similarity as the oligosaccharude libraries, fractions or compositions described by the invention. The following method to produce similar fractions with different saccharide lengths are preferred. Similar fractions with different average degree of polymerisation (or saccharide length) are preferably obtained by varying reaction time so that to produce shorter chain length fractions shorter reaction times are used, in a preferred embodiments aliquots from the same reaction mixtures are taken at different time points. When an alcohol or polyol containing composition is preferred, the alcohol or polyol may be used to varyingly to limit the degree of polymerisation in specific fractions to obtain similar fractions of different degrees of polymerisation, the larger concentrations of alcohol or polyol yield lower degrees of polymerisation or saccharide length as the these block the reactive reducing ends of saccharides. Alternatively, in reactions involving solutions lower concentrations of reagents may be used. The saccharide length may also be affected by changing reaction temperatures, the faster reactions at higher temperatures produces longer polymers in general, when the conditions do not degrade effectively the product or starting materials.

For use requiring similar saccharide fractions it is further preferred to use several different sets from different reaction conditions and/or produced from different carbohydrate raw materials to find out effects of different raw matrials.

Heterogenous Saccharide Set

A saccharide set comprising different saccharide fractions is called here a heterogenous saccharide set. When an active saccharide length for affecting a biological system is known the heterogeous sets with similar molecular size can be used. Heterogenous sets may comprise saccharide fractions produced by different methods according to the invention. The heterogenous set comprise oligosaccharide or polysaccharide or preferred oligosaccharide or polysaccharide fractions according to the invention. For the structural comparative uses saccharide sets, in a preferred embodiment oligosaccharide sets, with a specific saccharide lengths, are preferably used. In a specific embodiment heterogenous saccharide sets are produced from single monosaccharides or mixtures of monosaccharides belonging to the same saccharide type A-G according to the invention.

The heterogenous saccharide mixture sets especially containing saccharides of having same molecular weights are especially preferred for use in mass finger prints according to the invention to mark different products. The saccharide fractions especially ones containing several different monosaccharide species or types linked with each other in saccharides are extremely difficult to analyze and synthesize. When several such fractions are combined in mixture set the exact analysis by a potential competing person/entity aiming to produce an unauthorized copy of the mass finger print is even more difficult or practically impossible. Reproduction of mass finger print comprising overlapping molecular weights from heterogenous saccharide mixture sets without knowing the original raw materials and synthesis conditions of the fraction and relations in which fractions are mixed is practically impossible. The present invention is especially directed to mixed heterogenous saccharide sets when the fractions are selected so that there is much multiple overlapping peaks and the fractions are used so that there is “similar amounts of saccharide fractions or length components” as described above. The present invention is further directed to heterogenous mixtures of fractions with similar length components, when the peaks observable by mass spectrometry are not overlapping or in another embodiment the peaks are completely or almost completely overlapping, almost completely overlapping meaning at least 50% overlapping, more preferably at least 60% even more preferably 70% overlapping and most preferably at least 90% overlapping. The present invention is further directed to mixtures of heterogenous and homogenous mixture sets, for especially complicated mass finger prints and for production thereof. The present invention is preferably directed to mass spectrometric finger prints and production thereof of by mixing saccharide fractions according to the present invention, preferably when the mixture set comprises, preferably contains, at least two saccharide fractions according to the invention, more preferably at least three saccharide fractions, even more preferably at least four saccharide fractions and most preferably at least five saccharide fractions. The present invention is further directed to mixture set of 2-1000 sacccharide fractions, more preferably 5-100 saccharide fractions and most preferably 5-20 sacccharide fractions.

Preferred Low Molecular Weight Polysaccharides

The present invention is also preferably directed to mixture of low molecular weight polysaccharidesaccharides with average chain lenght from about 11 to about 35 monosaccharide units, and more preferably to low molecular weight polysaccharidesaccharides containing on average from about 11 to about 25 monosaccahride units. The preferred low molecular weight polysaccharidesaccharides includes the polymers with average chain length of from about 11 to about 15, more preferably the low molecular weight having average chain length of about 11 to about 12, from about 13 to about 15, and most preferably each specific fraction containing molecules with average chain length of about 11, 12, 13, 14, and 15. The preferred low molecular weight polysaccharidesaccharides further includes the polymers with average chain length of from about 16 to about 22. The more preferred low molecular weight polysaccharidesaccharides include more preferably the low molecular weight polysaccharidesaccharides having average chain length of about 16 to about 17, from about 18 to about 20 and from about 21 to about 22. Most preferably the present invention is separately directed to each fraction of low molecular weight polysaccharidesaccharides having more precise average chain length of 16, 17, 18, 19, 20, 21, or 22 monosacccharide units.

Glycolipid and carbohydrate nomenclature is according to recommendations by the IUPAC-IUB Commission on Biochemical Nomenclature (Carbohydrate Res. 1998, 312, 167; Carbohydrate Res. 1997, 297, 1; Eur. J. Biochem. 1998, 257, 29).

The present invention is further illustrated by the examples below, which in no way are intended to limit the scope of the invention.

Materials and Methods

List of Abbreviations.

Acetonitrile, ACN; N-acetylgalactosamine, GalNAc; N-acetylglucosamine, GlcNAc or GN; N-acetylneuraminic acid, NeuNAc or NA; Arabinose, Ara; β-cyclodextrin, βCD; Degree of polymerization, DP; Fructose, Fru; Fucose, Fuc or F; Galactose, Gal or G; Galacturonic acid, GalA; Glucose, Glc; Hexose, Hex; Mannose, Man; Rhamnose, Rha; Sorbitol, Glc-ol; Xylose, Xyl or X; Xylitol, Xyl-ol.

Carbohydrates.

Arabinose, fucose, mannose, rhamnose and xylose were from Danisco. Fructose, sorbitol and xylitol were purchased from a local pharmacy. N-acetylglucosamine, N-acetylneuraminic acid, α-methylmannoside, maltose, maltotriose and chitin were from Sigma. Galactose, galacturonic acid and β-cyclodextrin were from Calbiochem.

Glucosamine and starch were from Fluka. Glucose was from Merck and sucrose was from BDH. N-acetylgalactosamine was from CMS Chemicals Ltd. The synthesis of α-fluoroglycosides and 3,4-O-isopropylidine-2-O-acetylgalactose will be described elsewhere.

Other Chemicals.

Ammonium hydrogen carbonate was from BDH. Concentrated hydrogen chloride, methanol and acetonitrile were from Merck. 2 M anhydrous methanolic hydrogen chloride was prepared by adding appropriate amount of acetyl chloride (Aldrich) into dry methanol.

Chromatography.

Gel permeation chromatography was performed on a Superdex Peptide HR 10/30 column, using 50 mM ammonium bicarbonate as eluent and the effluent was monitored at 214 nm. Reversed phase chromatography on graphitized carbon was performed using a 4.6×250 mm column of HyperCarb (Thermo HyperSil, U.K.). The column was equilibrated in 10 mM aqueous ammonia, and a gradient of 0%-40% ACN over 100 min was applied. Absorbance at 214 nm was monitored.

Profiling Reversion Reactions by HPLC.

The degree of reaction in acid reversions of reducing carbohydrates can be monitored as follows: An aliquot of the neutralized reversion reaction is reacted with two to five fold molar excess of aminooxyacetic acid in 50 mM sodium acetate buffer, pH 4.0. An aliquot of the reaction mixture is analyzed by gel permeation chromatography, and monitored at 214 nm where the oxime bond formed absorbs.

Mass Spectrometry.

All reaction products were analyzed by MALDI-TOF mass spectrometry in 2,5-dihydroxybenzoic acid matrix using an Applied Biosystems Voyager STR mass spectrometer. All signals presented represent [M+Na]⁺ ions unless otherwise stated.

Acid catalysed condensation reactions are called here as acid reversion. Acid reversion reactions were performed with four different methods:

Method A.

Sugar samples as dry powder were allowed to react with hydrogen chloride gas in a closed vessel for indicated periods of time at room temperature. Reactions were terminated by addition of water and neutralization with ammonium hydrogen carbonate.

Method B.

Sugar samples were transferred into test tubes, 3 microliters of concentrated hydrogen chloride was added, and the reaction was allowed to proceed at 80° C. When a mixture of carbohydrates were reacted, the sugars were mixed thoroughly in water and dried in vacuum prior to reversion. Reactions were terminated as above.

Method C.

Sugar samples were transferred into test tubes, 3 microliters of concentrated hydrogen chloride was added, and reactions were allowed to proceed at 150-160° C. Reactions were terminated as above.

Method D.

Sugar samples as dry powder were allowed to react with 2 M anhydrous methanolic hydrogen chloride gas in a closed vessel. Reactions were terminated as above.

Method E.

Sugar samples were transferred into test tubes, 3 microliters of concentrated hydrogen chloride was added, and the reaction was allowed to proceed at 50° C. When a mixture of carbohydrates were reacted, the sugars were mixed thoroughly in water and dried in vacuum prior to reversion. Reactions were terminated as above.

Method F.

Sugar samples were dissolved in 50 mM ortho-phosphoric acid, dried under vacuum, and incubated at 80° C. for 6 hours. Reactions were terminated as above.

### EXAMPLES

### Example 1

Single Component Reversions.

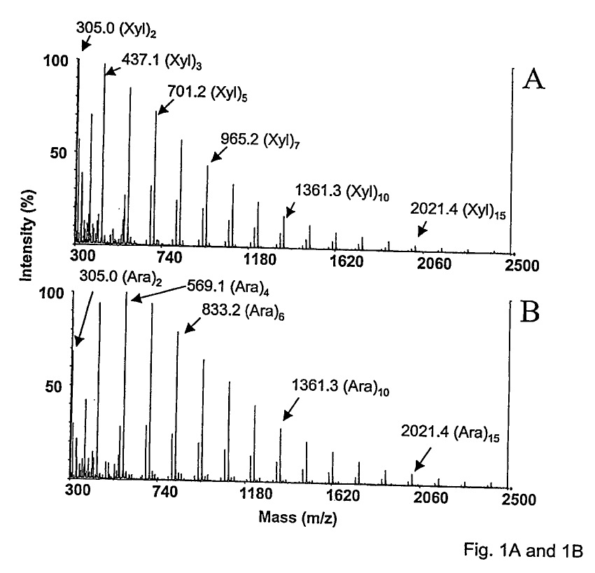

Two pentoses, xylose and arabinose, were subjected to acid reversion with method A. The MALDI-TOF mass spectra of the reaction products reveal in both cases polymers containing up to 18 monosaccharides (FIG. 1). In both cases, dehydration products are observed for each polymeric component (−18 Da).

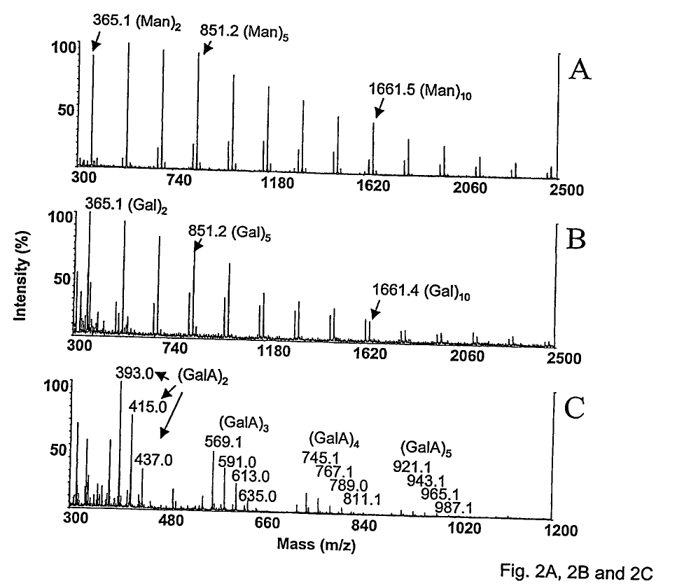

Mannose was subjected to reversion for 10 days with method A. The mass spectrum (FIG. 2A) shows polymers exceeding degree-of-polymerization (DP) of 15. Dehydration product is observed for each component. Galactose was reacted for 3 days with method A. Polymers with DP 15 are observed by mass spectrometric analysis (FIG. 2B). It may be noticable that the dehydration products are more pronounced in the galactose reaction than those seen in mannose reversion.

Galacturonic acid was reacted for 27 days with method A. The lower reactivity of GalA compared to neutral hexoses is obvious as pentamers are the largest polymers obtained (FIG. 2C). The complicated nature of the GalA reaction product mass spectrum is ascribed to the carboxylic acid function, producing sodium salt adducts separated by 22 Da.

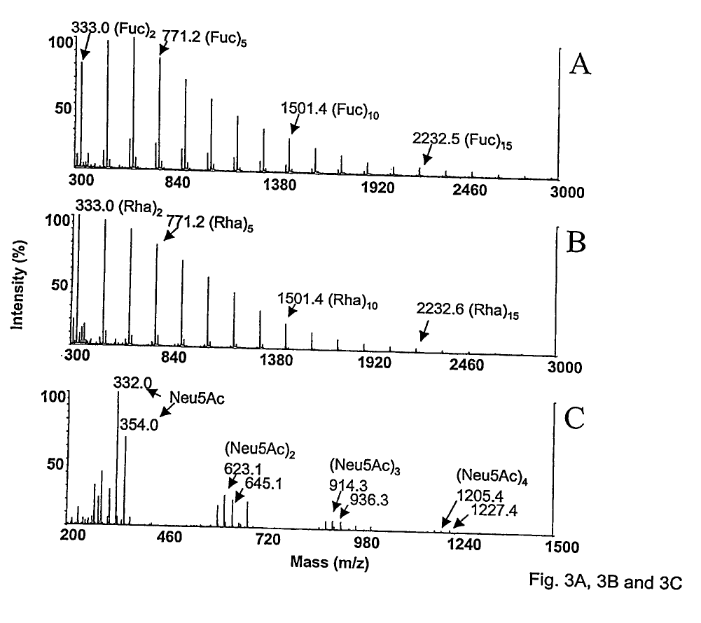

The 6-deoxyhexoses, fucose and rhamnose, were subjected to reversion for 3 days using method A. Both produced polymers with DP exceeding 15 (FIG. 3A, B). It is again noticeable that rhamnose, expressing manno-configuration, reveals little dehydration products.

N-acetylneuraminic acid was reacted for 75 minutes with method B. Tetramers were the largest species observed (FIG. 3C). The carboxyl group sodiation leads to multiple signals for each component in the mass spectrum.

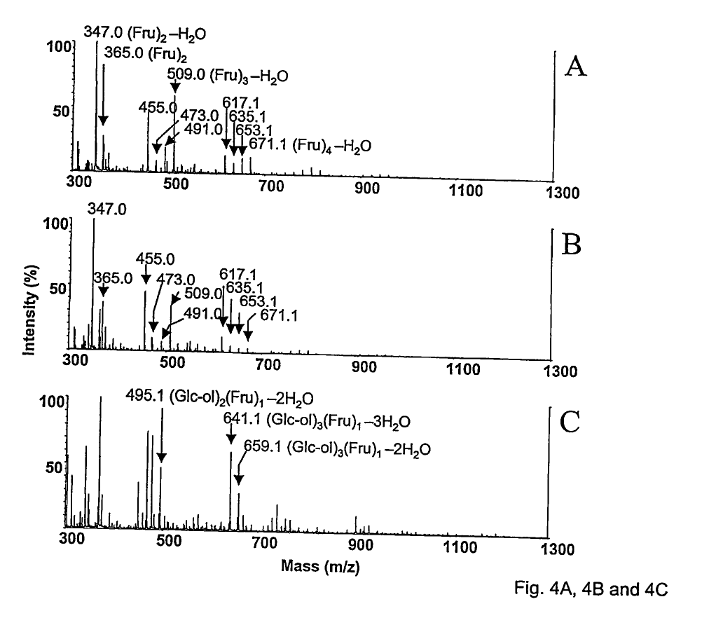

Fructose, a ketose, was subjected to reversion with methods A and B. Reacting fructose with method A produces approximately the same products as a 45 min reaction with method B (FIG. 4A, B). Multiply dehydrated products are observed with both methods, but are more pronounced when using method B.

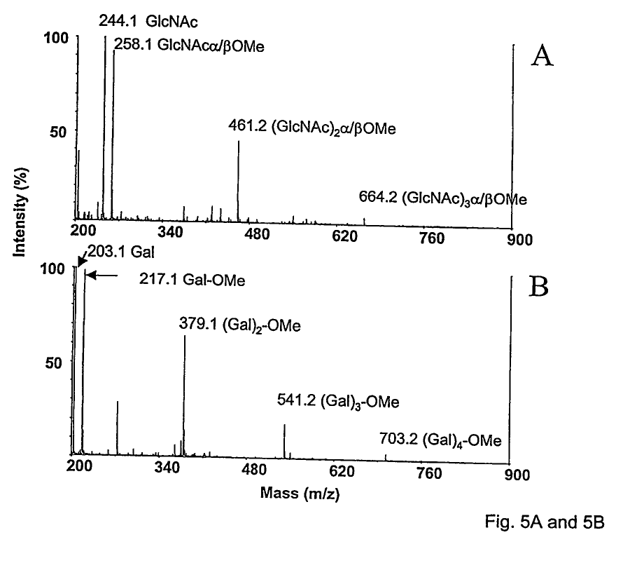

N-acetylglucosamme was subjected to reversion with method D. The methanolic solution leads to polymerization of the monosaccharides as well as to production of methyl glycosides. A 12 day reaction with N-acetylglucosamine yields GlcNAc-methyl glycosides, GlcNAc dimer methyl glycosides as well as GlcNAc trimer methyl glycosides (FIG. 5A). The monomer methyl glycosides were isolated by reversed phase chromatography, and analyzed by NMR. Both α- and β-methyl glycosides were present (data not shown). A 24 day reversion with galactose produces methyl glycosides with DP up to 4 (FIG. 5B).

Lactose (Galβ1-4Glc), maltose (Glcα1-4Glc) and maltotriose (Glcα1-4Glcα1-4Glc), too, were subjected to reactions with method D. Oligomer methyl glycosides with DP 2-5 were produced in each case, showing that glycosidic bonds are cleaved in the reaction (data not shown).

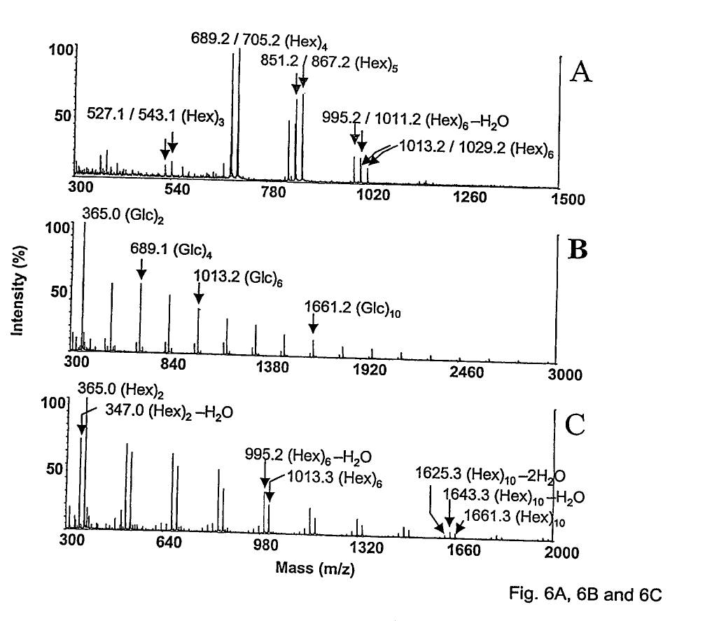

The disaccharides lactose, maltose and sucrose were subjected to 3 day reversions with method A. All reactions produced higher oligomers (FIG. 6). The original disaccharides undergo hydrolysis during the reactions, as oligomers with odd number of hexose units are produced as well. Sucrose, consisting of a fructose and a glucose moiety, produced noticeably higher amounts of dehydrated species.

Lactose was also subjected to reversion with method F. This reaction yielded hexose oligomer products containing up to seven hexose units (not shown).

Three α-fluoroglycosides were subjected to reversion with method B for 16 h. The products of α-fluorolactoside reversion are mostly of type (Hex)ₙ where n=2-11 (data not shown). No fluorine was observed in the products. 2,3,4,6-tetraacetyl-α-fluorogalactoside yielded hexose polymers up to decamer, with heterogenous acetylation (not shown). Similarly, peracetylated α-fluorolactoside yielded hexose polymers up to DP7, with one to four acetyl groups remaining (not shown).

Reversion of 3,4-O-isopropylidine-2-O-acetylgalactose with method B for 16 h yielded mostly galactose polymers (up to DP 9) (not shown). Most (Gal)ₙ species were found as monoacetylated species as well.

### Example 2

Reversions of Two Component Mixtures

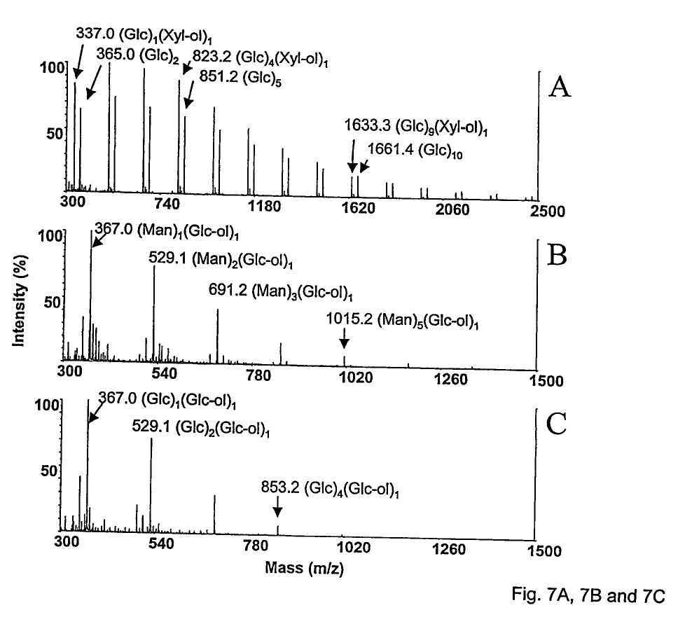

2 mmol of glucose was reversed in a mixture with 0.25 mmol of xylitol with method A for three days. The mass spectrum of the reaction mixture shows both pure glucose polymers as well as species carrying one (but not more) xylitol unit (FIG. 7A). Reacting 1 mmol of glucose with 0.25 mmol of xylitol yielded similar product mass spectrum, but the relative amount of polymers carrying xylitol was higher (not shown).

Mannose and sorbitol (1:3 molar ratio) were subjected to reversion with method B for 24 h. Under these conditions, all oligomeric species contained sorbitol at the reducing end (FIG. 7B). This was verified by sodium borohydride reduction, which had no effect on the oligomeric species (data not shown). Mannose was reacted with xylitol as well (1:1 molar ratio), using method C. Species containing one xylitol were in great majority (not shown).

Glucose and sorbitol in 1:1 molar ratio were reacted with method C in nitrogen atmosphere for 15 min (FIG. 7C). Even these conditions produced mostly species with sorbitol at the reducing end.

It was noted above that fructose undergo easily dehydration when subjected to more severe reversion reactions. An interesting product profile was seen when fructose and sorbitol were subjected to 20 h reversion with method B (FIG. 4C). The major signals in the mass spectrum can be ascribed to sorbitol dimers and sorbitol trimers carrying dehydrated fructose.

Maltotriose, a glucose α1,4 trisaccharide, was reversed with an equimolar amount of xylitol with method B for 16.5 hours. The major species produced are hexose oligomers carrying one xylitol unit (not shown).

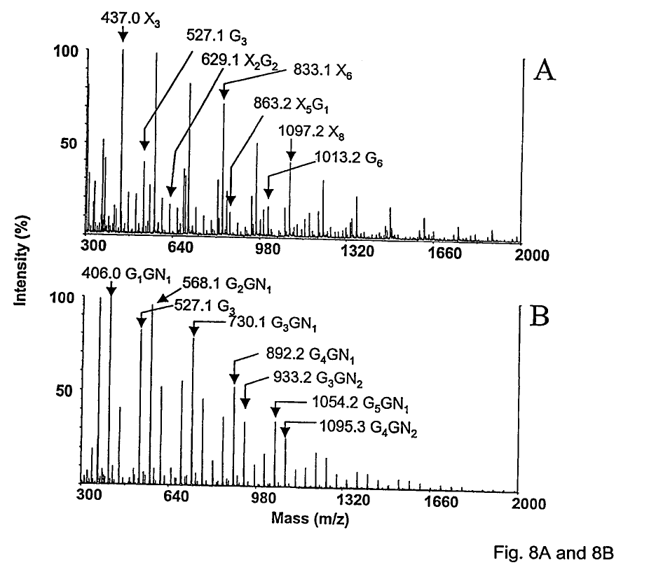

Two component reversions with alditol as the second reactant produce polymeric substances where the alditol resides in the reducing end, as described in the previous examples. Two reducing sugars, however, are able to produce more complex polymers: each reacting sugar may enter at any position in the growing chain. This feature is exemplified in FIG. 8, where the products of xylose+galactose (panel A) and galactose+N-acetylglucosamine (panel B) reversions are shown. Both reversions were conducted for equimolar mixtures. Xylose and galactose were mixed as powder prior to reversion for 3 days with method A. The majority of signals represent either xylose polymers or galactose polymers, but small amounts of heteropolymers were produced as well. In marked contrast, galactose plus N-acetylglucosamine reversion conducted by method B after mixing in water yielded mostly products carrying both monosaccharides. The number of a given monosaccharide in the polymeric products can obviously be controlled by the ratio of reacting sugars. When reacting twofold molar excess of galactose with N-acetylglucosamine, polymeric products were observed to carry larger proportion of galactose (data not shown).

An equimolar mixture of galactose and mannose was subjected to reversion with method B for 16 h. Hexose polemers up to DP 16 were observed (not shown). Similarly, an equimolar mixture of N-acetylglucosamine and N-acetylgalactosamine was subjected to reversion with method B for 16 h, yielding a series of N-acetylhexosamine polymers was formed, up to DP10 (not shown). Some deacetylation was evident in the product.

An equimolar mixture of galacturonic acid and glucosamine was subjected to reversion with method A for 11 days. The product shows only galacturonic acid oligomers, indicating that hexosamines are relatively resistant to reversion (data not shown).

Fucose and α-methylmannoside (1:2 molar ratio) were subjected to reversion with method B for 16 h. The heterooligomers produced comprise species carrying the α-methylmannoside unit as well as (Fuc)ₙ(Man)ₙ oligomers that have lost the α-methyl group (not shown). It is interesting to note that by conducting the reversion with method E the relative amount of α-methylmannoside units in the product oligomers is substantially higher (not shown).

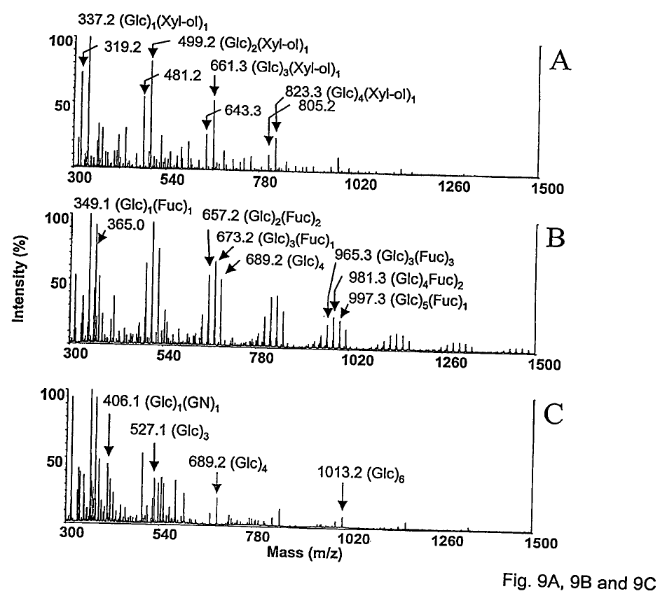

Starch, a polymer of glucose units linked by α1,4-linkages, can be subjected to reversion with another component. FIG. 9A shows the reversion products of starch with xylitol with method C. Starch is at least partially cleaved to smaller units, which then react with xylitol to form (Glc)ₙXyl-ol type species. Similarly, when reacting starch with a reducing carbohydrate, mixed polymers are produced as exemplified by starch plus fucose reaction conducted with method C (FIG. 9B). Subjecting a mixture of starch and chitin to reversion with method C yieds a mixture of glucose polymers, and also a signal corresponding to disaccharide species of type (Glc)₁(GlcNAc)₁ is observed (FIG. 9C).

Starch was also subjected to reversion (method C, 15 min) with a mixture of fucose, galactose and N-acetylglucosamine. Mass spectrometry of the product shows a large array of oligosaccharides, mostly hexose oligomers carrying additional fucose and N-acetylglucosamine units (not shown).

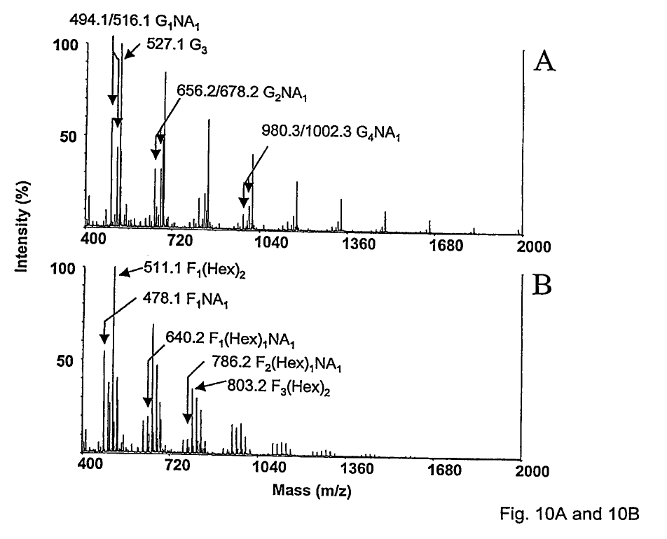

The reversion (method B for 45 min) of N-acetylneuraminic acid and galactose (10 mg and 15 mg, respectively) yields a number of interesting heteropolymers (FIG. 10A). A series of galactose oligomers bearing one N-acetylneuraminic acid residue are produced. Very similar product pattern was obtained when reacting N-acetylneuraminic acid with lactose (not shown).

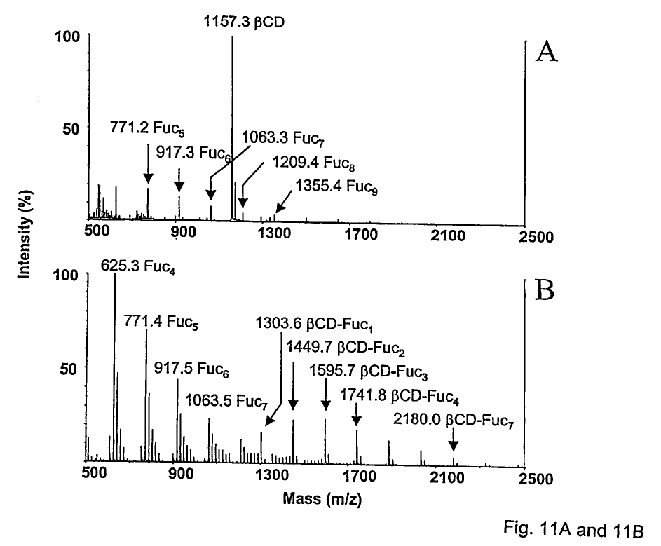

β-Cyclodextrin (a circular a 1,4-lied glucose heptamer) and fucose (100 μmol and 500 μmol, respectively) were subjected to 24 h reversion with method A. The product mass spectrum shows intact β-cyclodextrin and a series of fucose polymers up to DP12 (FIG. 11A). A four day reaction with method A produced, in addition to the products above, mixed polymers of fucose and hexose, the latter arising from the degradation of β-cyclodextrin (not shown). A five week reversion showed only fucose/hexose polymers (not shown). In marked contrast, a series of fucosylated β-cyclodextrin species were obtained by a 16 h reversion with method B (20 mg O-cyclodextrin and 100 mg fucose, FIG. 11B).

Reversion of a mixture of 3,4-O-isopropylidine-2-O-acetylgalactose and fucose with method E for 16 h yielded mostly fucose oligomers and heterooligomers carrying fucose and galactose. Interestingly, heterooligosaccharides carrying one monoacetylated galactose were also detected in the reaction, implying that site-directed reversion reactions are possible.

### Example 3

Reversions of Multicomponent Mixtures

Subjecting several reducing sugars simultaneously to acid reversion offers a possibility to produce a large array of oligosaccharides. The reversion (method B, 45 min) of equimolar mixture of fucose, lactose and N-acetylneuraminic acid shows e.g. trisaccharide species containing one of each reacting monosaccharides (FIG. 10B). In these conditions, only one N-acetylneuraminic acid unit is observed in the products, but it is expected that this ratio can be raised by increasing the molar proportion of N-acetylneuraminic acid in the reaction.

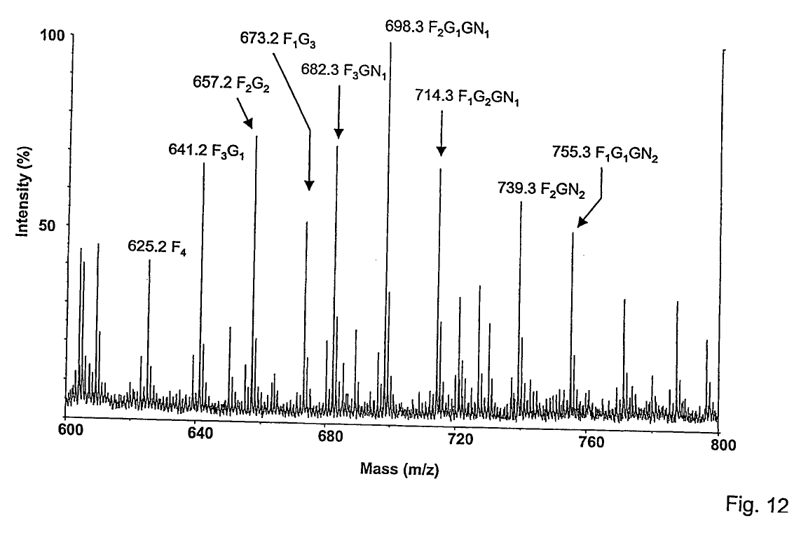

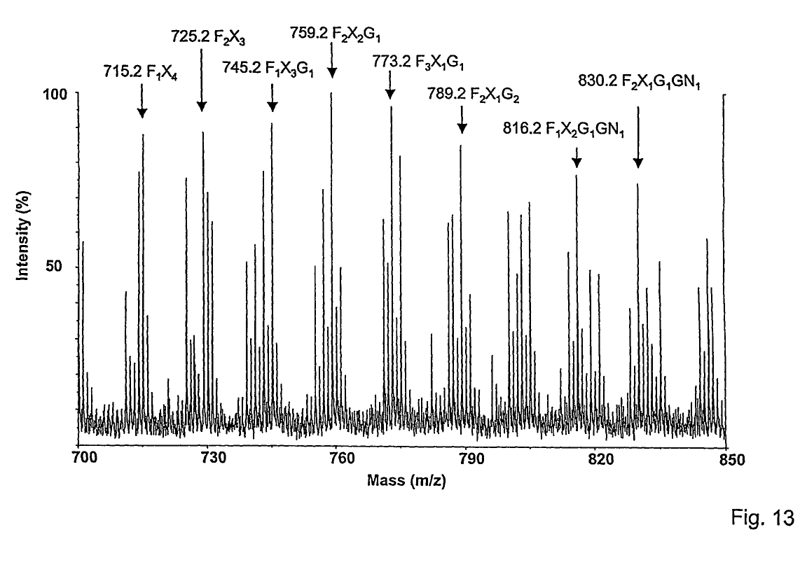

Reacting an equimolar mixture of fucose, galactose and N-acetylglucosamine with method C yields a large number of products. Part of the tetrasaccharides produced in this reversion are shown as an example in FIG. 12. These species include oligosaccharides carrying all reacting monosaccharides. Production of even more complex products is readily feasible, as exemplified by the reversion of equimolar mixture of xylose, facose, galactose and N-acetylglucosamine (FIG. 13). Even these products contain species that carry all four monosaccharides.

### Example 4

### Preparation of 2,3,4-tri-O-acetyl-α-D-galactosyl bromide (2)

2,3,4-Tri-O-acetyl-6-o-(tert-butyldimethylsilyl)-galactopyranoside (1) (226 mg, 0.537 mmol) was dissolved in 20 mL of dry CH₂Cl₂ under Ar. Temperature (T) of the reaction mixture was lowered to 0° C. with an ice bath. Br in AcOH (205 μL, 1.2 mmol) was added to the reaction mixture in one portion. After 4 h 42 min, the reaction mixture was washed once with water (50 mL). The water fraction was washed with CH₂Cl₂ (50 mL) and the combined CH₂Cl₂ fractions were washed once with water (50 mL). CH₂Cl₂ fraction was filtered through a filter paper and dried over Na₂SO₄. According to ¹H and ¹³C NMR spectroscopy, some silyl impurities e.g. tert-butyldimethylsilylhydroxide remained in the product mixture. (2) was used in following reactions without further purification.

¹H NMR (250 MHz, CDCl₃): δ=6.19 (d, J_{1,2} 3,6 Hz), internal reference: CDCl₃ 7.27 ppm

¹³C NMR (62.9 MHz, CDCl₃): δ=95.45 (C-1), internal reference: CDCl₃ 77.27 ppm

### Example 5

### Preparation of 2,3,4-tri-O-acetyl-6-O-(tert-butyldimethylsilyl)-α-D-galactosyl trichloroacetimidate (7)

2,3,4-Tri-O-acetyl-6-O-(tert-butyldimethylsilyl)-galactopyranoside (1) (179 mg, 0.426 mmol) was dissolved in 20 mL of dry CH₂Cl₂ under Ar. T of the reaction mixture was lowered to 0° C. with an ice bath. CCl₃CN (0.5 mL, 42,6 mmol) and 1,8-diazabicyclo[5.4.0]undec-7-ene (1,5-5) (DBU) (0.1 mL, 0.639 mmol) were added to the reaction mixture. Ice bath was allowed to melt away. After 14 h, solvents were evaporated in vacuo to give 549 mg of dark brown substance. H¹ and C¹³ NMR spectroscopy indicated that the product mixture contained a large amount of α- and β-imidate saccharide products together with some non-saccharide side products. (7) was used in following reactions without further purification.

¹H NMR (250 MHz, CDCl₃): 8=6.52 (d, J_{1,2} 3,4 Hz, H-1), 8.58 (s, NH), internal reference: CDCl₃ 7.27 ppm

¹³C NMR (62.9 MHz, CDCl₃): δ=93.79 (C-1), internal reference: CDCl₃ 77.25 ppm

### Example 6

2,3,4-tri-O-acetyl-α-D-galactosyl bromide (2)(146 mg, 0.395 mmol) was dissolved in dry CH₂Cl₂ (10 mL) and dry toluene (5 mL) under Ar. 4 Å MS (half tea spoon) and 2,2,6,6-tetramethylpiperidine (0.1 mL) were added to the reaction mixture. T was lowered to −57° C. and silver triflate (AgOTf, 170 mg, 0.66 mmol) was added to the reaction mixture. T was allowed to rise slowly to rt over a period of 3 hours. During this time the reaction mixture turned black. After 46 h, the reaction mixture was filtered through celite with CH₂Cl₂. The CH₂Cl₂ fraction was dried over Na₂SO₄. Silica gel 60 was added to the product mixture and the solvents were evaporated. The product was purified by flash chromatography (CH₂Cl₂/MeOH, gradient elution). TLC (eluent 1/1 toluene/ethyl acetate, visualized with ¼H₂SO₄/MeOH with orcinol 1 g/100 mL) indicated that the product mixture contained three main products. According to MALDI-TOF The product mixture contained partly deacetylated mono-, di,- and trisaccharides (compounds 3,4 and 5).

### Example 7

2,3,4-tri-O-acetyl-6-O-(tert-Butyldimethylsilyl)-α-D-galactosyl trichloroacetimidate (7) (in a crude product mixture [549 mg], theoretical amount of the imidate 0.426 mmol) was dissolved in 20 mL of dry CH₂Cl₂. T was lowered to −78° C. and trimethylsulfonyltriflate (TMSOTf, 154 μL, 0.852 mmol) was added to the reaction mixture. T was allowed to rise to 0° C. in 3 h. T was lowered to −14° C. and 0.3 mL additional TMSOTf was added to the reaction mixture. After 5 h T of the cold bath had risen to −2° C. T of the cooling bath was lowered to −18° C. Triethylamine in CH₂Cl₂ (10 mL, app. 1/10) was added to the reaction mixture over a period of 20 min. The product mixture was concentrated with a rotavapor. CH₂Cl₂ (50 mL) was added to the mixture and it was washed with water (50 mL). The water fraction was washed once with CH₂Cl₂ (50 mL). The combined CH₂Cl₂ fractions were concentrated with a rotavapor. The product mixture was filtered through celite. A dark brown solid was obrained after evaporation of the solvents. The product mixture was dissolved in CH₂Cl₂, silica gel 60 was added and the solvents were evaporated. The product was purified by flash chromatography over silica gel (CH₂Cl₂/MeOH, gradien elution). 159 mg of dark brown solid was obtained. This was re-purified by flash chromatography in a similar fashion to give 94 mg of brown solid. According to MALDI-TOF, the product mixture contained mono-di- and tetrasaccharide products (compounds 3,4,5 and 6, together with some partly deacetylated products).

### Example 8

α-D-Lactosyl fluoride (7)(130 mg, 0.38 mmol) was dissolved in H₂O (10 mL). ScTf₃ (17 mg 0.03 mmol) was added to the reaction mixture. The reaction mixture was stirred in rt for 1 h 10 min. Dowex 1×2 (Cl-form) was added to the reaction mixture. The reaction mixture was filtered through filter paper. Na₂CO₃ was added to the reaction mixture until bubbling ceased. Dowex H+ was added to the reaction mixture until the reaction mixture turned acidic. The reaction mixture was filtered through filter paper. Solvents were removed in vacuo giving 134 mg of slightly yellow oil resembling product. According to MALDI-TOF the product mixture contained oligomerized products containing up to 28 monosaccharide units (DP=1-14). The products mixture contained in considerable amount products with an uneven number of hexose rings, thus indicating that reverse hydrolysis of the products had also occurred during the reaction.

### Example 9

α-D-Lactosyl fluoride (7)(50 mg, 0.15 mmol) was dissolved in anhydrous DMF (15 mL). ScTf₃ (10 mg 0.02 mmol) was added to the reaction mixture. The reaction mixture was stirred in rt under Ar for 22 h. T of the reaction mixture was raised to 80° C. and stirring was continued for further 22 h. H₂O (1 mL) was added to the reaction mixture and it was stirred further 2 h 30 min. T was lowered to rt and 1 mL of pyridine was added to the reaction mixture. According to MALDI-TOF the product mixture contained unreacted starting material and dimeric products.

### Example 10

α-D-Lactosyl fluoride (7)(39 mg, 0.15 mmol) was dissolved in anhydrous TMF (15 mL). ScTf₃ (10 mg 0.02 mmol) was added to the reaction mixture. The reaction was carried out as described for Example D. According to MALDI-TOF the product mixture contained unreacted starting material and dimeric products.

### Example 11

### 1,1-Dilactoctoside synthesis

Acetobromo-alpha-D-lactose (peracetylated alpha-lactosylbromide, AcLacBr) (5.6 g, 8.0 mmol) is reacted with water (about 5 mmol) in presence of molecular sieves (4A, 2 g), 2,2,6,6-tetramethyl piperidin (0.6 ml), dry dichlormethane (30 ml) and toluene (60 ml). The reaction mixture was kept under inert athmosphere(argon). The temperature was lowered to −50 degree of Celsius and TMSOTf (3.0 g, 11.67 mmol) was added. The temperature was raised to room temperature for 10 hours. The solution was neutralized by addition of triethyl amine and mixture was filtered through a plug of Celite. Solvents were evaporated and gave crude product. Tetrasaccharide dilactoside is observed by MALDI-TOF mass spectrometry.

### LITERATURE

Blumberg, K, Liniere, F, Pustilnik, L., and Bush, C. A. Anal Biochem. (1982) 119:407-412
Defaye and Gadelle, Carbohydrate Res (1980s)
Foster and Horton, J. Chem. Soc. (1958) pages 1890-1894
Pacsu, E. and Mora, P. T. J. Am Chem. Soc. (February 1950), page 1045
Mora P. T., Wood, J. W., and MacFarland, V. W. J. Am. Chem. Soc. (1960) pages 3418-21

1-93. (canceled)

94. A method for the preparation of glycoconjugates comprising reacting under condensing conditions involving acid or metal catalysis at least two non-protected saccharides selected from the group consisting of:
A. aldomonosaccharides
B. deoxyhexoses
C. N-acetylaldoses
D. sialic acids
E. hexuronic acids
F. oligosaccharides containing a saccharide from any one of groups A-E
G. polysaccharides containing a saccharide from any one of groups A-E
so that said saccharides are selected from at least two of groups A-G;
in order to form a glycosidic bond between said saccharides through any free hydroxyl group position in said saccharides.

95. The method according to claim 94, wherein
group A consists of pentoses and hexoses;
group B consists of fucose and rhamnose;
group C consists of N-acetylglucosamine and N-acetylgalactosamine;
group D consists of N-acetyl neuraminic acid;
group E consists of galactouronic acid and glucuronic acid; and
group F consists of lactose, maltose, maltooligosaccharides, isomaltose, isomaltooligosaccharides, sucrose, fucose oligosaccharides, xylooligosaccharides, mannose oligosaccharides, GlcNAc oligosaccharides, GalNAc oligosaccharides and cyclic oligosaccharides.

96. The method according to claim 95, wherein group A consists of ribose, xylose and arabinose.

97. The method according to claim 94, wherein said condensing conditions involve acid or metal catalysis.

98. The method according to claim 94, wherein the reaction is conducted at a temperature under 180 degrees of Celsius.

99. The method according to claim 94, wherein the reaction further comprises an alcohol, preferably a polyol.

100. The method according to the claim 94, wherein the chain length of reaction products obtained is two to ten monosaccharide residues and the specific reaction products are isolated.

101. The method according to claim 94, wherein at least one of the saccharides are selected from group F or G, and the linkage structure of the saccharide of group F or G remains intact in the reaction.

102. The method according to claim 94, wherein the reaction products do not contain or contain minimum amounts of anhydro products.

103. The method according to claim 94, wherein the reaction products form an oligosaccharide library.

104. The method according to claim 94, wherein the products of the reaction comprise a mixture or library of oligosaccharides or polysaccharides including carbohydrates comprising different substrate carbohydrates glycosidically linked to each other
and/or, when substrate carbohydrate(s) is/are oligosaccharide(s) or polysaccharide(s), monosaccharide residues from the different substrates glycosidically linked to each other.

105. The method according to claim 94, wherein products of the reaction comprise a mixture or library of oligosaccharides or polysaccharides including carbohydrates comprising: different substrate carbohydrates glycosidically linked to each other
and/or, when substrate carbohydrate(s) is/are oligosaccharide(s) or polysaccharide(s), monosaccharide residues from the different substrates glycosidically linked to each other and/or homotypic glycosidically linked oligomer or polymers of one or several of the substrate carbohydrates and/or glycosidically linked oligomers or polymers of the monosaccharides from the substrate carbohydrates.

106. An oligosaccharide library or mixture comprising saccharides according to formula
(M2)ₙ(M1α/β1-OR)ₘ
wherein n is an integer from 1 to 4, and integer m is either 0 or 1 and
M1 monosaccharide units are selected from the groups A, B, D as defined in claim 94 and M2 is selected from groups A-E as defined in claim 94; OR is is a methyl glycoside or ethyl glycoside.

107. A neoglycolipid composition comprising a non-natural oligosaccharide mixture comprising randomly linked oligomers of monosaccharides from at least two of groups A-E as defined in claim 94, when said oligomers are linked to a hydrophobic aglycon.

108. A method of use wherein the reaction products obtained by a method of claim 94 or compositions containing said products are used as mass finger prints, the method comprising the step of marking food, beverage or other products with said products.

109. An oligosaccharide mixture or fraction comprising oligosaccharides according to the Formula 1:
M1ₘM2ₙ
wherein monosaccharide units M1 and M2 selected from at least two of groups A-E as defined in claim 94, are glycosidically linked in any order and m and n are varying integers for different oligosaccharide components from 0 to 6 with the provision that the isomers are present in the mixture so that each oligosaccharide has at least two possible isomerically linkaged forms between every linkage between monosaccharide residues.

110. An oligosaccharide mixture or fraction comprising oligosaccharides according to Formula 2:
M1ₘM2ₙM3ₒ
wherein M1 and M2 and M3 are monosaccharide units from at least two of groups A-E as defined in claim 94 with the provision that M1, M2 and M3 are glycosidically linked to each other in any order in linear or branched sequence and m and n and o are varying integers for different oligosaccharide components from 0 to 6, and with the provision that the isomers are present in the mixture so that each oligosaccharide has at least two possible isomerically linkaged forms between every linkage between monosaccharide residues.

111. An oligosaccharide mixture or fraction comprising oligosaccharides according to the Formula 3:
M1ₘM2ₙM3ₒM4ₚ
wherein M1, M2, M3, and M4 are monosaccharide units from at least two of groups A-E as defined in claim 94 with the provision that M1, M2, M3, and M4 are glycosidically linked to each other in any order in linear or branched sequence and m, n, o, and p are varying integers for different oligosaccharide components from 0 to 6 with the provision that the isomers are present in the mixture so that each oligosaccharide has at least two possible isomerically linkaged forms between every linkage between monosaccharide residues.

112. A method for the preparation of non-reducing monosaccharides, oligosaccharides or polysaccharides comprising reacting under condensing conditions involving acid catalysis a non-protected reducing monosaccharides, oligosaccharides or polysaccharide, i.e. SAC, or mixtures thereof with a polyalcohol substance, i.e. polyol, the reaction being according to the Scheme 3:
SAC+polyol→SAC-polyol
wherein SAC is a non-protected reducing carbohydrate selected from the group consisting of:
A. aldomonosaccharides
C. deoxyhexoses
C. N-acetylaldoses
D. sialic acids
E. hexuronic acids.
F. oligosaccharides containing a saccharide from any one of groups A-E
G. polysaccharides containing a saccharide from any one of groups A-E;
with the provision that polyalcohol substance and carbohydrate are in a used in relative amounts so that there is at least 20 mass % of polyol in the reaction.

113. The method according to claim 112, wherein glucose is reacted with polyols or polyalcohols, such as xylitol, sorbitol, or mannitol.

114. The method according to claim 112, wherein the product mixture comprising at least 50 mass % of structures Glcβ1-6Glc-ol, Glcβ1-6Glc-ol, Glcα1-1Glc-ol, and Glcβ1-1Glc-ol.

115. A composition comprising at least 50 mass % of structures Glcβ1-6Glc-ol, Glcβ1-6Glc-ol, Glcα1-1Glc-ol and Glcβ1-1Glc-ol.

116. An essentially pure monosaccharide conjugate mixture consisting of all non-reducing monosaccharide conjugates according to the formula
Mα/β1-1/xAlcohol,
wherein M is a monosaccharide residue selected from the group consisting of Glc, Gal, Man, Xyl, Fuc, GlcNAc with the provision that M is α- or α-linked to position 1 or another hydroxyl marked by x of a polyalcohol substance preferably xylitol, sorbitol, galactitol, or mannitol, when the conjugate mixture optionally comprises also the polyalcohol in free form.
